(19) United States
(12) Patent Application Publication
(10) Pub. No.: US 2008/0291369 A1
(43) Pub. Date: Nov. 27, 2008

(54) Optical Film, Optical Compensation Film, Polarizing Plate, and Liquid-Crystal Display Device

(75) Inventors: Michio Nagai, Minami-ashigara-shi (JP); Yoshiaki Hisakado, Minami-ashigara-shi (JP); Kazuhiro Nakamura, Minami-ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Minato-ku (JP)

(21) Appl. No.: 12/120,905

(22) Filed: May 15, 2008

(30) Foreign Application Priority Data
May 23, 2007 (JP) 2007-136605
Sep. 27, 2007 (JP) 2007-251750

(51) Int. Cl. G02F 1/1347; C09K 19/02; G02B 5/30

(52) U.S. Cl. 349/76; 430/20; 349/194

(57) ABSTRACT

An optical film comprising a transparent support and an optically-anisotropic layer formed of a composition comprising at least one liquid-crystal compound, wherein the transparent support comprises at least one selected from cycloolefin-base homopolymers and copolymers, and the optically-anisotropic layer satisfies the following relation (1): Re(450)/Re(650)<1.25, is disclosed. An optical compensation film comprising a transparent support, and an optically-anisotropic layer formed of a composition comprising a liquid-crystal compound, wherein the transparent support comprises a polymer having at least either of lactone ring unit or glutaric anhydride unit, is also disclosed.

### CROSS-REFERENCE TO RELATED APPLICATIONS

This application claims benefit of priority under 35 U.S.C. 119 to Japanese Patent Application Nos. 2007-136605 filed on May 23, 2007, and 2007-251750 filed on Sep. 27, 2007; and the entire contents of the applications are incorporated herein by reference.

### BACKGROUND OF THE INVENTION

1. Field of the Invention

The present invention relates to an optical film, an optical compensation film, a polarizing plate and a liquid-crystal display device.

2. Related Art

Heretofore, various types of optical compensation films have been proposed for liquid-crystal display devices, comprising a transparent support of a polymer film and having, on the support, an optically-anisotropic layer of a liquid-crystal composition (for example, Japanese Patent 2587398).

The optical compensation film of the type has heretofore been used for optical compensation for TN-mode liquid-crystal display devices, but its use in liquid-crystal display devices of other modes has been proposed. For example, bend alignment-mode liquid-crystal devices comprising an optically-anisotropic layer of a liquid-crystal composition and having improved viewing angle characteristics are disclosed variously in JPA No. 2006-194924; and vertical alignment-mode liquid-crystal devices similarly comprising the optically-anisotropic layer and having improved viewing angle characteristics are in JPA Nos. 2006-337676, 2006-337675, 2006-251050, 2005-37784, 2006-85128, 2006-323069, 2006-313214, 2006-227360 and 2006-220682.

On the other hand, various types of polymer materials useful for producing optical films have been proposed, and for example, optical films comprising a lactone ring-containing polymer have been proposed (JPA No. 2006-171464, and WO2006/025445A1).

To satisfy the market's needs, further improvement of display characteristics is necessary, and for example, it is necessary to reduce the coloration of panels in oblique directions. In addition, liquid-crystal display devices are used in various environments, and therefore their display characteristics are desired not to depend on environments, especially on humidity.

Further, even more improvement of display contrast in the front direction, or in the normal direction, and in oblique directions is needed.

### SUMMARY OF THE INVENTION

An object of the first invention is to provide a novel optical film that can contribute to optical compensation for liquid-crystal display devices. In particular, the object of the first invention is to provide a novel optical film that can contribute to reducing the coloration in oblique directions of liquid-crystal display devices and of which the optical compensatory capability does not fluctuate or fluctuates little, depending on the environmental humidity.

Another object of the first invention is to provide a liquid-crystal display device which has been so improved that its coloration in oblique directions is reduced and its display characteristics do not fluctuate or fluctuate little, depending on the environmental humidity.

An object of the second invention is to provide an optical compensation film that has a small degree of extinction and can contribute to improving contrast, and a polarizing plate comprising it.

Another object of the second invention is to provide a liquid-crystal display device improved in the contrast in the front direction and in oblique directions.

The first invention relates to an optical film comprising a transparent support and an optically-anisotropic layer formed of a composition comprising at least one liquid-crystal compound, wherein the transparent support comprises at least one selected from cycloolefin-base homopolymers and copolymers, and the optically-anisotropic layer satisfies the following relation (1):

Re(450)/Re(650)<1.25 (1)

wherein Re(λ) is in-plane retardation (unit: nm) of the layer at a wavelength λ (nm).

As embodiments of the first invention, the optical film wherein said at least one liquid-crystal compound is a rod-like liquid-crystal compound, and in the optically-anisotropic layer, the molecules of the rod-like liquid-crystal compound are fixed in a hybrid alignment state, and the mean refractive index of the optically-anisotropic layer satisfies the following relation (2):

nx≧nz>ny (2)

wherein nx and ny each are in-plane refractive indexes of the layer, and nz is a refractive index in the thickness direction of the layer; the optical film wherein said at least one liquid-crystal compound is a discotic liquid-crystal compound; and the optical film wherein the transparent support satisfies the following relation (3) or (4):

0.5<Rth(550)/Re(550)<1.5 (3)

4<Rth(550)/Re(550)<12 (4)

wherein Rth(λ) is thickness-direction retardation (unit: nm) of the layer at a wavelength λ (nm); are provided.

In another aspect, the first invention provides a polarizing plate comprising at least one optical film of the first invention and a polarizing film; and a liquid-crystal display device comprising a liquid-crystal cell, a polarizing film, and an optical film of the first invention. The liquid crystal display device may employ a TN-mode or an ECB-mode.

The second invention relates to an optical compensation film comprising a transparent support, and an optically-anisotropic layer formed of a composition comprising a liquid-crystal compound, wherein the transparent support comprises a polymer having at least either of lactone ring unit or glutaric anhydride unit.

As embodiments of the second invention, the optical compensation film wherein the polymer has at least one unit of the following formula (1):

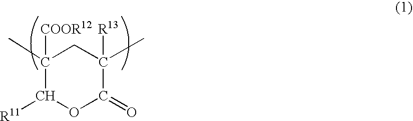

wherein R¹¹, R¹² and R¹³ each independently represent a hydrogen atom, or an organic residue having from 1 to 20 carbon atoms, and the organic residue may contain an oxygen atom; the optical compensation film wherein the polymer has at least one unit of the following formula (3):

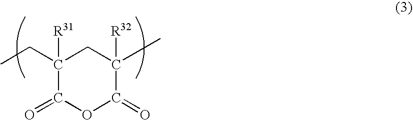

wherein R³¹ and R³² each independently represent a hydrogen atom or an organic residue having from 1 to 20 carbon atoms, and the organic residue may contain an oxygen atom; the optical compensation film wherein the transparent support further comprises a copolymer having a vinyl cyanide monomer unit and an aromatic vinyl monomer unit; the optical compensation film wherein the transparent support further comprises a retardation enhancer having at least two aromatic rings in one molecule; and the optical compensation film which has an alignment film disposed between the transparent support and the optically-anisotropic layer, are provided.

In another aspect, the second invention provides a polarizing plate comprising a polarizing element and an optical compensation film of the second invention; and a liquid-crystal display device comprising at least one polarizing plate of the second invention.

### PREFERRED EMBODIMENT OF THE INVENTION

The invention will be described in detail below. The expression “from a lower value to an upper value” referred herein means that the range intended by the expression includes both the lower value and the upper value.

In the description, Re(λ) and Rth(λ) each indicate the in-plane retardation (unit:nm) and the thickness direction retardation (unit:nm) of the film at a wavelength λ. Re(λ) is measured by applying a light having a wavelength of λ nm in the normal direction of the film, using KOBRA-21ADH or WR (by Oji Scientific Instruments). The selectivity of the measurement wavelength λ nm may be conducted by a manual exchange of a wavelength-filter, a program conversion of a measurement wavelength value or the like.

When the film tested is represented by an uniaxial or biaxial refractive index ellipsoid, then its Rth (X) is calculate according to the method mentioned below.

With the in-plane slow axis (determined by KOBRA 21ADH or WR) taken as the inclination axis (rotation axis) of the film (in case where the film has no slow axis, the rotation axis of the film may be in any in-plane direction of the film), Re(λ) of the film is measured at 6 points in all thereof, up to +50° relative to the normal direction of the film at intervals of 100, by applying a light having a wavelength of λ nm from the inclined direction of the film.

With the in-plane slow axis from the normal direction taken as the rotation axis thereof, when the film has a zero retardation value at a certain inclination angle, then the symbol of the retardation value of the film at an inclination angle larger than that inclination angle is changed to a negative one, and then applied to KOBRA 21ADH or WR for computation.

With the slow axis taken as the inclination axis (rotation axis) (in case where the film has no slow axis, the rotation axis of the film may be in any in-plane direction of the film), the retardation values of the film are measured in any inclined two directions; and based on the data and the mean refractive index and the inputted film thickness, Rth may be calculated according to the following formulae (1) and (2):

$$\begin{matrix}Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( θ )}{nx} ) \}} & ( 1 ) \\ Rth = \{ ( nx + ny ) / 2 - nz \} \times d & ( 2 )\end{matrix}$$

wherein Re(θ) means the retardation value of the film in the direction inclined by an angle θ from the normal direction; nx means the in-plane refractive index of the film in the slow axis direction; ny means the in-plane refractive index of the film in the direction vertical to nx; nz means the refractive index of the film vertical to nx and ny; and d is a thickness of the film.

When the film to be tested can not be represented by a monoaxial or biaxial index ellipsoid, or that is, when the film does not have an optical axis, then its Rth(X) may be calculated according to the method mentioned below.

With the in-plane slow axis (determined by KOBRA 21ADH or WR) taken as the inclination axis (rotation axis) of the film, Re(λ) of the film is measured at 11 points in all thereof, from −50° to +50° relative to the normal direction of the film at intervals of 100, by applying a light having a wavelength of λ nm from the inclined direction of the film. Based on the thus-determined retardation data of Re(X), the mean refractive index and the inputted film thickness, Rth(X) of the film is calculated with KOBRA 21ADH or WR.

The mean refractive index may be used values described in catalogs for various types of optical films. When the mean refractive index has not known, it may be measured with Abbe refractometer. The mean refractive index for major optical film is described below: cellulose acetate (1.48), cycloolefin polymer (1.52), polycarbonate (1.59), polymethylmethacrylate (1.49), polystyrene (1.59).

The mean refractive index and the film thickness are inputted in KOBRA 21ADH or WR, nx, ny and nz are calculated therewith. From the thus-calculated data of nx, ny and nz, Nz=(nx−nz)/(nx−ny) is further calculated.

In the description, when there is no notation regarding the measurement wavelength, the measurement wavelength for Re or Rth is 550 nm.

### 1. First Invention:

### 1.-1 Optical Film:

A first invention relates to an optical film comprising a transparent support, and an optically-anisotropic layer formed of a composition comprising at least one liquid-crystal compound, wherein the transparent support comprises at least one selected from cycloolefin-base homopolymers and copolymers. The optical film of the first invention may further comprise any other optically-anisotropic layer and/or optically-isotropic layer. One embodiment of the optical film of the first invention is an optical film comprising an alignment film disposed between the optically-anisotropic layer and the transparent support.

The optically-anisotropic layer, the transparent support and the optional alignment film are described in detail hereinunder.

### 1.-1-1 Optically-Anisotropic Layer:

The optically-anisotropic layer satisfies the following numerical relation (1):

Re(450)/Re(650)<1.25. (1)

Preferably, it satisfies the following numerical relation (1)′, more preferably the following numerical relation (1)″:

1.05≦Re(450)/Re(650)≦1.23, (1)′

1.1≦Re(450)/Re(650)≦1.21. (1)″

When the optically-anisotropic layer satisfies the above relation (1) and when it is used in liquid-crystal display devices, it may reduce the coloration in oblique directions.

The optically-anisotropic layer is formed of a composition containing at least one liquid-crystal compound. The composition is preferably a liquid-crystal composition capable of forming a nematic phase and a smectic phase. Liquid-crystal compounds are generally grouped into rod-like and discotic liquid-crystal compounds, based on the shape of their molecules. In the first invention, usable are any types of such liquid-crystal compounds. For satisfying the above-mentioned numerical relation (1), the liquid-crystal compounds to be used are preferably such that, when they exhibits birefringence induced to the alignment of the molecules thereof, the wavelength dispersion characteristics of the birefringence thereof are small.

Two or more types of rod-like liquid crystal compounds may be used for satisfying the relational expression (1). Preferred examples of the combination include any combinations of at least one rod-like liquid crystal represented by formula (I) and at least one rod-like liquid crystal represented by formula (II).

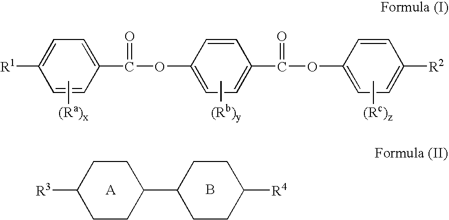

In the formulas, “A” and “B” each represent an aromatic hydrocarbon ring residue, an aliphatic hydrocarbon ring residue or a heterocyclic group; R¹ to R⁴ each represent a substituted or non-substituted, C₁₋₁₂ (preferably C₃₋₇) alkyl group or an alkoxy, acyloxy, alkoxycarbonyl or alkoxycarbonyloxy having a C₁₋₁₂ (preferably C₃₋₇) alkylene chain therein; R^{a}, R^{b} and R^{c} each represent a substituent; x, y and z each represent an integer from 1 to 4.

The alkylene chain contained in each of R¹ to R⁴ may be a linear or branched alkylene chain, and linear alkylene chains are preferred. For curing the composition, R¹ to R⁴ each may have a polymerizable group at the terminal. Examples of the polymerizable group include acryloyl, methacryloyl and epoxy.

In the formula (I), preferably, x and z are 0 and y is 1; and in such examples, preferably, the position of one R^{b} is the meta or ortho position with respect to the position of the oxycarbonyl or the acyloxy group. Preferably, R^{b} represents a C₁₋₁₂ alkyl group such as methyl or a halogen atom such as fluorine atom.

In the formula (II), preferably, “A” and “B” each represent a phenylene or cyclohexylene group; and, more preferably, both of “A” and “B” are phenylene or one of them is phenylene and another is cyclohexylene.

Examples of the compound represented by formula (I) or formula (II) include, but are not limited to, those shown below.

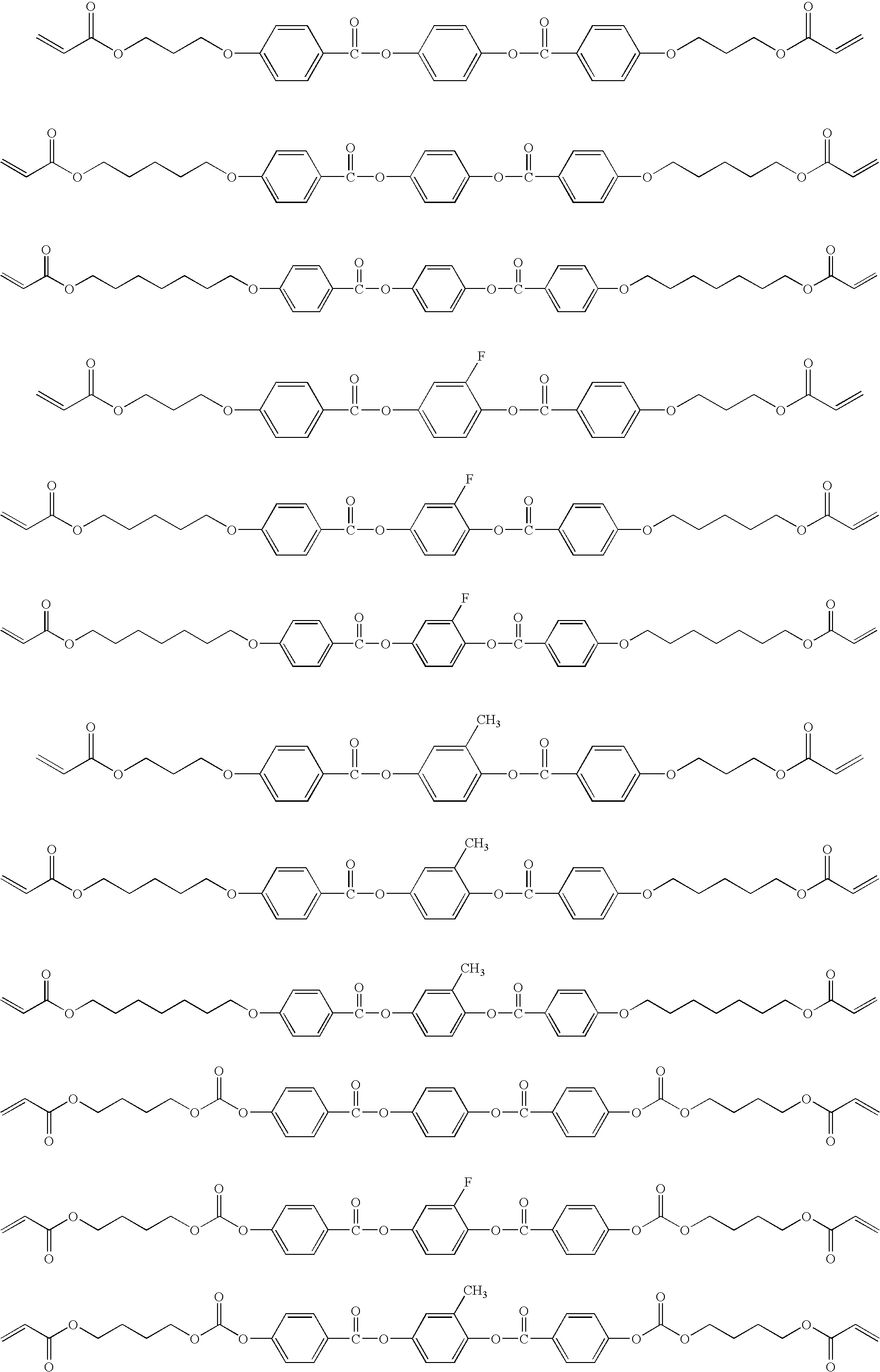

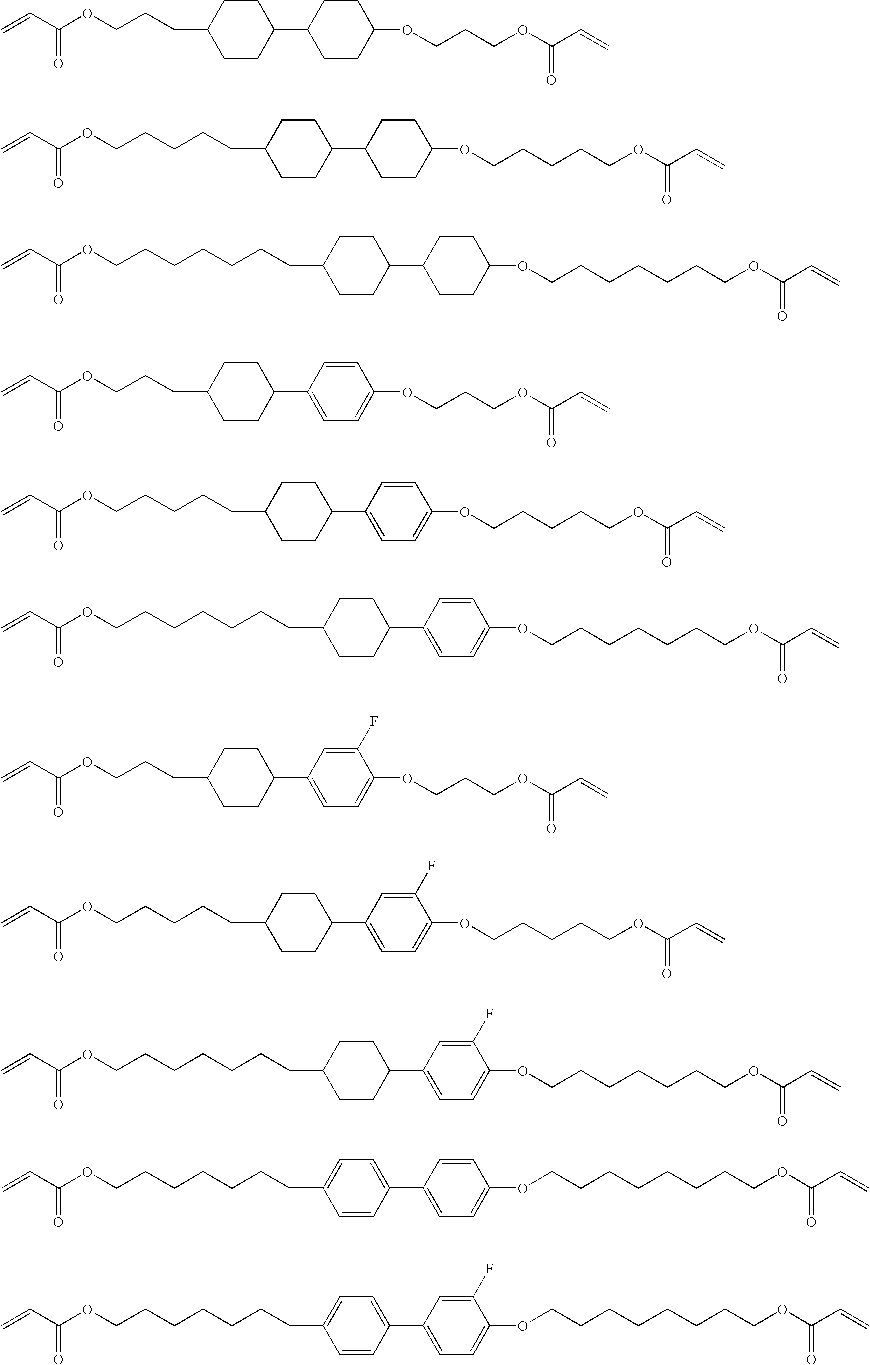

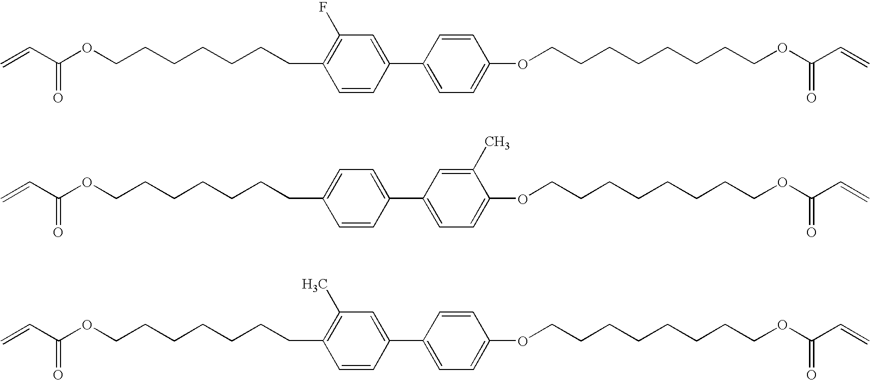

The ratio between the compounds represented by the formula (I) and (II) is not limited to the specific range so far as the numerical relation (1) is satisfied. The compounds may be employed in the manner that their amounts are equal or in the manner that one is a major ingredient and another is a minor ingredient.

Examples of the discotic compound to be employed include the compounds represented by formula (DI). Among those, the compounds exhibiting discotic liquid crystallinity are preferred, and those exhibiting discotic nematic phase are more preferred.

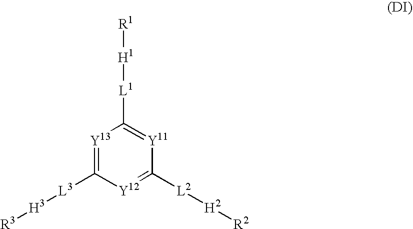

In formula (DI), Y¹¹, Y¹² and Y¹³ each independently represent a methine group or a nitrogen atom. L¹, L² and L³ each independently represent a single bond or a bivalent linking group. H¹, H² and H³ each independently represent the following formula (DI-A) or (DI-B). R¹, R² and R³ each independently represent the following formula (DI-R).

In formula (DI), Y¹¹, Y¹² and Y¹³ each independently represent a methine group or a nitrogen atom. When each of Y¹¹, Y¹² and Y¹³ each is a methine group, the hydrogen atom of the methine group may be substituted with a substituent. Examples of the substituent of the methine group include an alkyl group, an alkoxy group, an aryloxy group, an acyl group, an alkoxycarbonyl group, an acyloxy group, an acylamino group, an alkoxycarbonylamino group, an alkylthio group, an arylthio group, a halogen atom, and a cyano group. Of those, preferred are an alkyl group, an alkoxy group, an alkoxycarbonyl group, an acyloxy group, a halogen atom and a cyano group; more preferred are an alkyl group having from 1 to 12 carbon atoms (the term “carbon atoms” means hydrocarbons in a substituent, and the terms appearing in the description of the substituent of the discotic liquid crystal compound have the same meaning), an alkoxy group having from 1 to 12 carbon atoms, an alkoxycarbonyl group having from 2 to 12 carbon atoms, an acyloxy group having from 2 to 12 carbon atoms, a halogen atom and a cyano group.

Preferably, Y¹¹, Y¹² and Y¹³ are all methine groups, more preferably non-substituted methine groups.

In formula (DI), L¹, L² and L³ each independently represent a single bond or a bivalent linking group. The bivalent linking group is preferably selected from —O—, —S—, —C(═O)—, —NR⁷—, —CH═CH—, —C≡C—, a bivalent cyclic group, and their combinations. R⁷ represents an alkyl group having from 1 to 7 carbon atoms, or a hydrogen atom, preferably an alkyl group having from 1 to 4 carbon atoms, or a hydrogen atom, more preferably a methyl, an ethyl or a hydrogen atom, even more preferably a hydrogen atom.

The bivalent cyclic group for L¹, L² and L³ is preferably a 5-membered, 6-membered or 7-membered group, more preferably a 5-membered or 6-membered group, even more preferably a 6-membered group. The ring in the cyclic group may be a condensed ring. However, a monocyclic ring is preferred to a condensed ring for it. The ring in the cyclic ring may be any of an aromatic ring, an aliphatic ring, or a hetero ring. Examples of the aromatic ring are a benzene ring and a naphthalene ring. An example of the aliphatic ring is a cyclohexane ring. Examples of the hetero ring are a pyridine ring and a pyrimidine ring. Preferably, the cyclic group contains an aromatic ring and a hetero ring.

Of the bivalent cyclic group, the benzene ring-having cyclic group is preferably a 1,4-phenylene group. The naphthalene ring-having cyclic group is preferably a naphthalene-1,5-diyl group or a naphthalene-2,6-diyl group. The pyridine ring-having cyclic group is preferably a pyridine-2,5-diyl group. The pyrimidine ring-having cyclic group is preferably a pyrimidin-2,5-diyl group.

The bivalent cyclic group for L¹, L² and L³ may have a substituent. Examples of the substituent are a halogen atom, a cyano group, a nitro group, an alkyl group having from 1 to 16 carbon atoms, an alkenyl group having from 2 to 16 carbon atoms, an alkynyl group having from 2 to 16 carbon atoms, a halogen atom-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, an alkyl group-substituted carbamoyl group having from 2 to 16 carbon atoms, and an acylamino group having from 2 to 16 carbon atoms.

In the formula, L¹, L² and L³ are preferably a single bond, *—O—CO—, *—CO—O—, *—CH═CH—, *—C≡C—, *-“bivalent cyclic group”-, *—O—CO— “bivalent cyclic group”-, *—CO—O— “bivalent cyclic group”-, *—CH═CH-“bivalent cyclic group”-, *—C≡C-“bivalent cyclic group”-, *-“bivalent cyclic group”-O—CO—, *-“bivalent cyclic group”-CO—O—, *-“bivalent cyclic group”-CH═CH—, or *-“bivalent cyclic group” —C═C—. More preferably, they are a single bond, *—CH═CH—, *—C═C—, *—CH═CH— “bivalent cyclic group”- or *—C═C— “bivalent cyclic group”-, even more preferably a single bond. In the examples, “*” indicates the position at which the group bonds to the 6-membered ring of formula (DI) that contains Y¹¹, Y¹² and Y¹³.

In formula (DI), H¹, H² and H³ each independently represent the following formula (DI-A) or (DI-B):

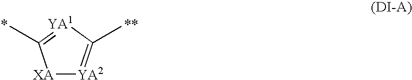

In formula (DI-A), YA¹ and YA² each independently represent a methine group or a nitrogen atom. Preferably, at least either of YA¹ or YA² is a nitrogen atom, more preferably they are both nitrogen atoms. XA represents an oxygen atom, a sulfur atom, a methylene group or an imino group. XA is preferably an oxygen atom. * indicates the position at which the formula bonds to any of L¹ to L³; and ** indicates the position at which the formula bonds to any of R¹ to R³.

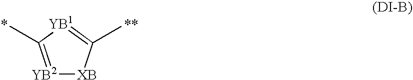

In formula (DI-B), YB¹ and YB² each independently represent a methine group or a nitrogen atom. Preferably, at least either of YB¹ or YB² is a nitrogen atom, more preferably they are both nitrogen atoms. XB represents an oxygen atom, a sulfur atom, a methylene group or an imino group. XB is preferably an oxygen atom. * indicates the position at which the formula bonds to any of L¹ to L³; and ** indicates the position at which the formula bonds to any of R¹ to R³.

In the formula, R¹, R² and R³ each independently represent the following formula (DI-R):

*-(-L²¹-F¹)ₙ₁-L²²-L²³-Q¹ (DI-R)

In formula (DI-R), * indicates the position at which the formula bonds to H¹, H² or H³ in formula (DI). F¹ represents a bivalent linking group having at least one cyclic structure. L²¹ represents a single bond or a bivalent linking group. When L²¹ is a bivalent linking group, it is preferably selected from a group consisting of —O—, —S—, —C(═O)—, —NR⁷—, —CH═CH—, —C═C—, and their combination. R⁷ represents an alkyl group having from 1 to 7 carbon atoms, or a hydrogen atom, preferably an alkyl group having from 1 to 4 carbon atoms, or a hydrogen atom, more preferably a methyl group, an ethyl group or a hydrogen atom, even more preferably a hydrogen atom.

In the formula, L²¹ is preferably a single bond, **—O—CO—, **—CO—O—, **—CH═CH— or **—C≡C— (in which ** indicates the left side of L²¹ in formula (DI-R)). More preferably it is a single bond.

In formula (DI-R), F¹ represents a bivalent cyclic linking group having at least one cyclic structure. The cyclic structure is preferably a 5-membered ring, a 6-membered ring, or a 7-membered ring, more preferably a 5-membered ring or a 6-membered ring, even more preferably a 6-membered ring. The cyclic structure may be a condensed ring. However, a monocyclic ring is preferred to a condensed ring for it. The ring in the cyclic ring may be any of an aromatic ring, an aliphatic ring, or a hetero ring. Examples of the aromatic ring are a benzene ring, a naphthalene ring, an anthracene ring, a phenanthrene ring. An example of the aliphatic ring is a cyclohexane ring. Examples of the hetero ring are a pyridine ring and a pyrimidine ring.

The benzene ring-having group for F¹ is preferably a 1,4-phenylene group or a 1,3-phenylene group. The naphthalene ring-having group is preferably a naphthalene-1,4-diyl group, a naphthalene-1,5-diyl group, a naphthalene-1,6-diyl group, a naphthalene-2,5-diyl group, a naphthalene-2,6-diyl group, or a naphthalene-2,7-diyl group. The cyclohexane ring-having group is preferably a 1,4-cyclohexylene group. The pyridine ring-having group is preferably a pyridine-2,5-diyl group. The pyrimidine ring-having group is preferably a pyrimidin-2,5-diyl group. More preferably, F¹ is a 1,4-phenylene group, a 1,3-phenylene group, a naphthalene-2,6-diyl group, or a 1,4-cyclohexylene group.

In the formula, F1 may have a substituent. Examples of the substituent are a halogen atom (e.g., fluorine atom, chlorine atom, bromine atom, iodine atom), a cyano group, a nitro group, an alkyl group having from 1 to 16 carbon atoms, an alkenyl group having from 1 to 16 carbon atoms, an alkynyl group having from 2 to 16 carbon atoms, a halogen atom-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, an alkyl group-substituted carbamoyl group having from 2 to 16 carbon atoms, and an acylamino group having from 2 to 16 carbon atoms. The substituent is preferably a halogen atom, a cyano group, an alkyl group having from 1 to 6 carbon atoms, a halogen atom-substituted alkyl group having from 1 to 6 carbon atoms, more preferably a halogen atom, an alkyl group having from 1 to 4 carbon atoms, a halogen atom-substituted alkyl group having from 1 to 4 carbon atoms, even more preferably a halogen atom, an alkyl group having from 1 to 3 carbon atoms, or a trifluoromethyl group.

In the formula, n1 indicates an integer of from 0 to 4. n1 is preferably an integer of from 1 to 3, more preferably 1 or 2. When n1 is 0, then L²² in formula (DI-R) directly bonds to any of H¹ to H³. When n1 is 2 or more, then (-L²¹-Fl)'s may be the same or different.

In the formula, L²² represents —O—, —O—CO—, —CO—, —O—CO—O—, —S—, —NH—, —SO₂—, —CH₂—, —CH═CH— or —C≡C—, preferably —O—, —O—CO—, —CO—O—, —O—CO—O—, —CH₂—, —CH═CH— or —C≡C—, more preferably —O—, —O—CO—, —CO—O—, —O—CO—O—, or —CH₂—.

When the above group has a hydrogen atom, then the hydrogen atom may be substituted with a substituent. Examples of the substituent are a halogen atom, a cyano group, a nitro group, an alkyl group having from 1 to 6 carbon atoms, a halogen atom-substituted alkyl group having from 1 to 6 carbon atoms, an alkoxy group having from 1 to 6 carbon atoms, an acyl group having from 2 to 6 carbon atoms, an alkylthio group having from 1 to 6 carbon atoms, an acyloxy group having from 2 to 6 carbon atoms, an alkoxycarbonyl group having from 2 to 6 carbon atoms, a carbamoyl group, an alkyl group-substituted carbamoyl group having from 2 to 6 carbon atoms, and an acylamino group having from 2 to 6 carbon atoms. Especially preferred are a halogen atom, and an alkyl group having from 1 to 6 carbon atoms.

In the formula, L²³ represents a bivalent linking group selected from —O—, —S—, —C(═O)—, —SO₂—, —NH—, —CH₂—, —CH═CH— and —C≡C—, and a group formed by linking two or more of these. The hydrogen atom in —NH—, —CH₂— and —CH═CH— may be substituted with any other substituent. Examples of the substituent are a halogen atom, a cyano group, a nitro group, an alkyl group having from 1 to 6 carbon atoms, a halogen atom-substituted alkyl group having from 1 to 6 carbon atoms, an alkoxy group having from 1 to 6 carbon atoms, an acyl group having from 2 to 6 carbon atoms, an alkylthio group having from 1 to 6 carbon atoms, an acyloxy group having from 2 to 6 carbon atoms, an alkoxycarbonyl group having from 2 to 6 carbon atoms, a carbamoyl group, an alkyl group-substituted carbamoyl group having from 2 to 6 carbon atoms, and an acylamino group having from 2 to 6 carbon atoms. Especially preferred are a halogen atom, and an alkyl group having from 1 to 6 carbon atoms. The group substituted with the substituent improves the solubility of the compound of formula (DI) in solvent, and therefore the composition of the invention containing the compound can be readily prepared as a coating liquid.

In the formula, L²³ is preferably a linking group selected from a group consisting of —O—, —C(═O)—, —CH₂—, —CH═CH— and —C≡C—, and a group formed by linking two or more of these. L²³ preferably has from 1 to 20 carbon atoms, more preferably from 2 to 14 carbon atoms. Preferably, L²³ has from 1 to 16 (—CH₂—)'s, more preferably from 2 to 12 (—CH₂—)'s.

In the formula, Q¹ represents a polymerizing group or a hydrogen atom. When the compound of formula (DI) is used in producing optical films of which the retardation is required not to change by heat, such as optical compensatory films, Q¹ is preferably a polymerizing group. The polymerization for the group is preferably addition polymerization (including ring-cleavage polymerization) or polycondensation. In other words, the polymerizing group preferably has a functional group that enables addition polymerization or polycondensation. Examples of the polymerizing group are shown below.

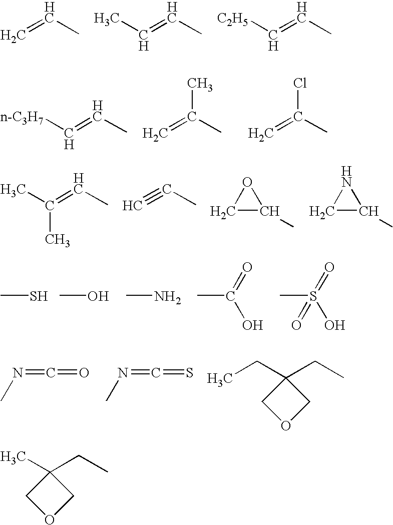

More preferably, the polymerizing group is addition-polymerizing functional group. The polymerizing group of the type is preferably a polymerizing ethylenic unsaturated group or a ring-cleavage polymerizing group.

Examples of the polymerizing ethylenic unsaturated group are the following (M-1) to (M-6):

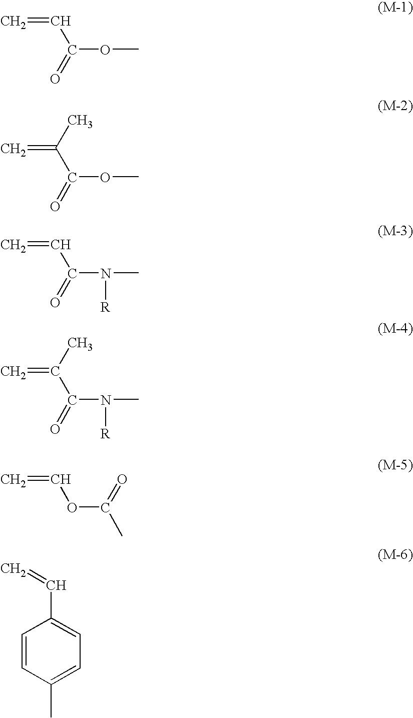

In formulae (M-3) and (M-4), R represents a hydrogen atom or an alkyl group. R is preferably a hydrogen atom or a methyl group. Of formulae (M-1) to (M-6), preferred are formulae (M-1) and (M-2), and more preferred is formula (M-1).

The ring-cleavage polymerizing group is preferably a cyclic ether group, more preferably an epoxy group or an oxetanyl group, most preferably an epoxy group.

And according to the first present invention, a liquid-crystal compound of the following formula (DII) or a liquid-crystal compound of the following formula (DIII) is more preferred.

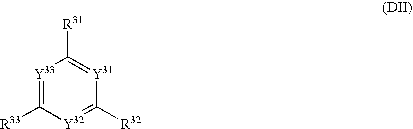

In formula (DII), Y³¹, Y³² and Y³³ each independently represent a methine group or a nitrogen atom. Y³¹, Y³² and Y³³ have the same meaning as that of Y¹¹, Y¹² and Y¹³ in formula (DI), and their preferred range is also the same as therein.

In the formula, R³¹, R³² and R³³ each independently represent the following formula (DII-R):

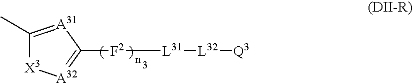

In formula (DII-R), A³¹ and A³² each independently represent a methine group or a nitrogen atom. Preferably, at least either of A³¹ and A³² is a nitrogen atom; most preferably the two are both nitrogen atoms.

In the formula, X³ represents an oxygen atom, a sulfur atom, a methylene group or an imino group. Preferably, X³ is an oxygen atom.

In formula (DII-R), F² represents a bivalent cyclic linking group having a 6-membered cyclic structure. The 6-membered ring in F² may be a condensed ring. However, a monocyclic ring is preferred to a condensed ring for it. The 6-membered ring in F² may be any of an aromatic ring, an aliphatic ring, or a hetero ring. Examples of the aromatic ring are a benzene ring, a naphthalene ring, an anthracene ring and a phenanthrene ring. An example of the aliphatic ring is a cyclohexane ring. Examples of the hetero ring are a pyridine ring and a pyrimidine ring.

Of the bivalent cyclic ring, the benzene ring-having cyclic group is preferably a 1,4-phenylene group or a 1,3-phenylene group. The naphthalene ring-having cyclic group is preferably a naphthalene-1,4-diyl group, a naphthalene-1,5-diyl group, a naphthalene-1,6-diyl group, a naphthalene-2,5-diyl group, a naphthalene-2,6-diyl group, or a naphthalene-2,7-diyl group. The cyclohexane ring-having cyclic group is preferably a 1,4-cyclohexylene group. The pyridine ring-having cyclic group is preferably a pyridine-2,5-diyl group. The pyrimidine ring-having cyclic group is preferably a pyrimidin-2,5-diyl group. More preferably, the bivalent cyclic group is a 1,4-phenylene group, a 1,3-phenylene group, a naphthalene-2,6-diyl group, or a 1,4-cyclohexylene group.

In the formula, F² may have at least one substituent. Examples of the substituent are a halogen atom (e.g., fluorine atom, chlorine atom, bromine atom, iodine atom), a cyano group, a nitro group, an alkyl group having from 1 to 16 carbon atoms, an alkenyl group having from 2 to 16 carbon atoms, an alkynyl group having from 2 to 16 carbon atoms, a halogen atom-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, an alkyl group-substituted carbamoyl group having from 2 to 16 carbon atoms, and an acylamino group having from 2 to 16 carbon atoms. The substituent of the bivalent cyclic group is preferably a halogen atom, a cyano group, an alkyl group having from 1 to 6 carbon atoms, a halogen atom-substituted alkyl group having from 1 to 6 carbon atoms, more preferably a halogen atom, an alkyl group having from 1 to 4 carbon atoms, a halogen atom-substituted alkyl group having from 1 to 4 carbon atoms, even more preferably a halogen atom, an alkyl group having from 1 to 3 carbon atoms, or a trifluoromethyl group.

In the formula, n3 indicates an integer of from 1 to 3. n3 is preferably 1 or 2. When n3 is 2 or more, then F²'s may be the same or different.

In the formula, L³¹ represents —O—, —O—CO—, —CO—O—, —O—CO—O—, —S—, —NH—, —SO₂—, —CH₂—, —CH═CH— or —C≡C—. When the above group has a hydrogen atom, then the hydrogen atom may be substituted with a substituent. The preferred range of L³¹ may be the same as that of L²² in formula (DI-R).

In the formula, L³² represents a bivalent linking group selected from —O—, —S—, —C(═O)—, —SO₂—, —NH—, —CH₂—, —CH═CH— and —C≡C—, and a group formed by linking two or more of these, and when the group has a hydrogen atom, the hydrogen atom may be substituted with a substituent. The preferred range of L³² may be the same as that of L²³ in formula (DI-R).

In the formula, Q³ represents a polymerizing group or a hydrogen atom, and its preferred range is the same as that of Q¹ in formula (DI-R).

Next, compounds of formula (DIII) will be described in detail.

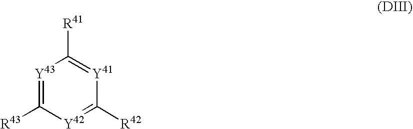

In formula (DIII), Y⁴¹, Y⁴² and Y⁴³ each independently represent a methine group or a nitrogen atom. When Y⁴¹, Y⁴² and Y⁴³ each are a methine group, the hydrogen atom of the methine group may be substituted with a substituent. Preferred examples of the substituent that the methine group may have are an alkyl group, an alkoxy group, an aryloxy group, an acyl group, an alkoxycarbonyl group, an acyloxy group, an acylamino group, an alkoxycarbonylamino group, an alkylthio group, an arylthio group, a halogen atom, and a cyano group. Of those, more preferred are an alkyl group, an alkoxy group, an alkoxycarbonyl group, an acyloxy group, a halogen atom and a cyano group; even more preferred are an alkyl group having from 1 to 12 carbon atoms, an alkoxy group having from 1 to 12 carbon atoms, an alkoxycarbonyl group having from 2 to 12 carbon atoms, an acyloxy group having from 2 to 12 carbon atoms, a halogen atom and a cyano group.

Preferably, Y⁴¹, Y⁴² and Y⁴³ are all methine groups, more preferably non-substituted methine groups.

In the formula, R⁴¹, R⁴² and R⁴³ each independently represent the following formula (DIII-A), (DIII-B) or (DIII-C).

When retardation plates and the like having a small wavelength dispersion are produced, the compound in which R⁴¹, R⁴² and R⁴³ are represented by formula (DIII-A) or (DIII-C), more preferably formula (DIII-A), is preferably used.

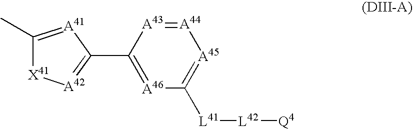

In formula (DIII-A), A⁴¹, A⁴², A⁴³, A⁴⁴, A⁴⁵ and A⁴⁶ each independently represent a methine group or a nitrogen atom. Preferably, at least with of A⁴¹ or A⁴² is a nitrogen atom; more preferably the two are both nitrogen atoms. Preferably, at least three of A⁴³, A⁴⁴, A⁴⁵ and A⁴⁶ are methine groups; more preferably, all of them are methine groups. When A⁴³, A⁴⁴, A⁴⁵ and A⁴⁶ are methine groups, the hydrogen atom of the methine group may be substituted with a substituent. Examples of the substituent that the methine group may have are a halogen atom (fluorine atom, chlorine atom, bromine atom, iodine atom), a cyano group, a nitro group, an alkyl group having from 1 to 16 carbon atoms, an alkenyl group having from 2 to 16 carbon atoms, an alkynyl group having from 2 to 16 carbon atoms, a halogen-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, an alkyl group-substituted carbamoyl group having from 2 to 16 carbon atoms, and an acylamino group having from 2 to 16 carbon atoms. Of those, preferred are a halogen atom, a cyano group, an alkyl group having from 1 to 6 carbon atoms, a halogen-substituted alkyl group having from 1 to 6 carbon atoms; more preferred are a halogen atom, an alkyl group having from 1 to 4 carbon atoms, a halogen-substituted alkyl group having from 1 to 4 carbon atoms; even more preferred are a halogen atom, an alkyl group having from 1 to 3 carbon atoms, a trifluoromethyl group.

In the formula, X⁴¹ represents an oxygen atom, a sulfur atom, a methylene group or an imino group, but is preferably an oxygen atom.

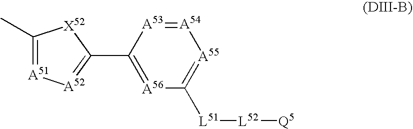

In formula (DIII-B), A⁵¹, A⁵², A⁵³, A⁵⁴, A⁵⁵ and A⁵⁶ each independently represent a methine group or a nitrogen atom. Preferably, at least either of A⁵¹ or A⁵² is a nitrogen atom; more preferably the two are both nitrogen atoms. Preferably, at least three of A⁵³, A⁵⁴, A⁵⁵ and A⁵⁶ are methine groups; more preferably, all of them are methine groups. When A⁵³, A⁵⁴, A⁵⁵ and A⁵⁶ are methine groups, the hydrogen atom of the methine group may be substituted with a substituent. Examples of the substituent that the methine group may have are a halogen atom (fluorine atom, chlorine atom, bromine atom, iodine atom), a cyano group, a nitro group, an alkyl group having from 1 to 16 carbon atoms, an alkenyl group having from 2 to 16 carbon atoms, an alkynyl group having from 2 to 16 carbon atoms, a halogen-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, an alkyl group-substituted carbamoyl group having from 2 to 16 carbon atoms, and an acylamino group having from 2 to 16 carbon atoms. Of those, preferred are a halogen atom, a cyano group, an alkyl group having from 1 to 6 carbon atoms, a halogen-substituted alkyl group having from 1 to 6 carbon atoms; more preferred are a halogen atom, an alkyl group having from 1 to 4 carbon atoms, a halogen-substituted alkyl group having from 1 to 4 carbon atoms; even more preferred are a halogen atom, an alkyl group having from 1 to 3 carbon atoms, a trifluoromethyl group.

In the formula, X⁵² represents an oxygen atom, a sulfur atom, a methylene group or an imino group, but is preferably an oxygen atom.

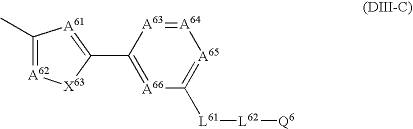

In formula (DIII-C), A⁶¹, A⁶², A⁶³, A⁶⁴, A⁶⁵ and A⁶⁶ each independently represent a methine group or a nitrogen atom. Preferably, at least either of A⁶¹ or A⁶² is a nitrogen atom; more preferably the two are both nitrogen atoms. Preferably, at least three of A⁶³, A⁶⁴, A⁶⁵ and A⁶⁶ are methine groups; more preferably, all of them are methine groups. When A⁶³, A⁶⁴, A⁶⁵ and A⁶⁶ are methine groups, the hydrogen atom of the methine group may be substituted with a substituent. Examples of the substituent that the methine group may have are a halogen atom (fluorine atom, chlorine atom, bromine atom, iodine atom), a cyano group, a nitro group, an alkyl group having from 1 to 16 carbon atoms, an alkenyl group having from 2 to 16 carbon atoms, an alkynyl group having from 2 to 16 carbon atoms, a halogen-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, an alkyl group-substituted carbamoyl group having from 2 to 16 carbon atoms, and an acylamino group having from 2 to 16 carbon atoms. Of those, preferred are a halogen atom, a cyano group, an alkyl group having from 1 to 6 carbon atoms, a halogen-substituted alkyl group having from 1 to 6 carbon atoms; more preferred are a halogen atom, an alkyl group having from 1 to 4 carbon atoms, a halogen-substituted alkyl group having from 1 to 4 carbon atoms; even more preferred are a halogen atom, an alkyl group having from 1 to 3 carbon atoms, a trifluoromethyl group.

In the formula, X⁶³ represents an oxygen atom, a sulfur atom, a methylene group or an imino group, but is preferably an oxygen atom.

L⁴¹ in formula (DIII-A), L⁵¹ in formula (DIII-B) and L⁶¹ in formula (DIII-C) each independently represent —O—, —O—CO—, —CO—O—, —O—CO—O—, —S—, —NH—, —SO₂—, —CH₂—, —CH═CH— or —C≡C—; preferably —O—, —O—CO—, —CO—O—, —O—CO—O—, —CH₂—, —CH═CH— or —C≡C—; more preferably —O—, —O—CO—, —CO—O—, —O—CO—O— or —CH₂—. When above group has a hydrogen atom, then the hydrogen atom may be substituted with a substituent.

Preferred examples of the substituent are a halogen atom, a cyano group, a nitro group, an alkyl group having from 1 to 6 carbon atoms, a halogen atom-substituted alkyl group having from 1 to 6 carbon atoms, an alkoxy group having from 1 to 6 carbon atoms, an acyl group having from 2 to 6 carbon atoms, an alkylthio group having from 1 to 6 carbon atoms, an acyloxy group having from 2 to 6 carbon atoms, an alkoxycarbonyl group having from 2 to 6 carbon atoms, a carbamoyl group, an alkyl group-substituted carbamoyl group having from 2 to 6 carbon atoms, and an acylamino group having from 2 to 6 carbon atoms. Especially preferred are a halogen atom, and an alkyl group having from 1 to 6 carbon atoms.

L⁴² in formula (DIII-A), L⁵² in formula (DIII-B) and L 2 in formula (DIII-C) each independently represent a bivalent linking group selected from —O—, —S—, —C(═O)—, —SO₂—, —NH—, —CH₂—, —CH═CH— and —C≡C—, and a group formed by linking two or more of these. The hydrogen atom in —NH—, —CH₂— and —CH═CH— may be substituted with a substituent. Preferred examples of the substituent are a halogen atom, a cyano group, a nitro group, an alkyl group having from 1 to 6 carbon atoms, a halogen atom-substituted alkyl group having from 1 to 6 carbon atoms, an alkoxy group having from 1 to 6 carbon atoms, an acyl group having from 2 to 6 carbon atoms, an alkylthio group having from 1 to 6 carbon atoms, an acyloxy group having from 2 to 6 carbon atoms, an alkoxycarbonyl group having from 2 to 6 carbon atoms, a carbamoyl group, an alkyl group-substituted carbamoyl group having from 2 to 6 carbon atoms, and an acylamino group having from 2 to 6 carbon atoms. Especially preferred are a halogen atom, and an alkyl group having from 1 to 6 carbon atoms.

Preferably, L 42, L⁵² and L⁶² each independently represent a bivalent linking group selected from —O—, —C(═O)—, —CH₂—, —CH═CH— and —C≡C—, and a group formed by linking two or more of these. Preferably, L⁴², L⁵² and L⁶² each independently have from 1 to 20 carbon atoms, more preferably from 2 to 14 carbon atoms. Preferably, L 42, L⁵² and L⁶² each independently have from 1 to 16 (—CH₂—)'s, more preferably from 2 to 12 (—CH₂—)'s.

Q⁴ in formula (DIII-A), Q⁵ in formula (DIII-B) and Q⁶ in formula (DIII-C) each independently represent a polymerizing group or a hydrogen atom. Their preferred ranges are the same as that of Q¹ in formula (DI-R).

Specific examples of the compounds of formulae (DI), (DII) and (DIII) include, but are not limited to, those shown below.

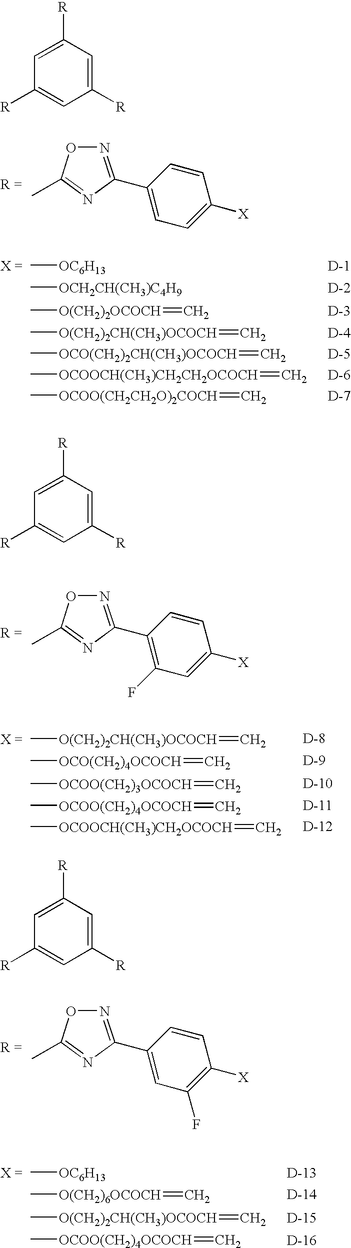

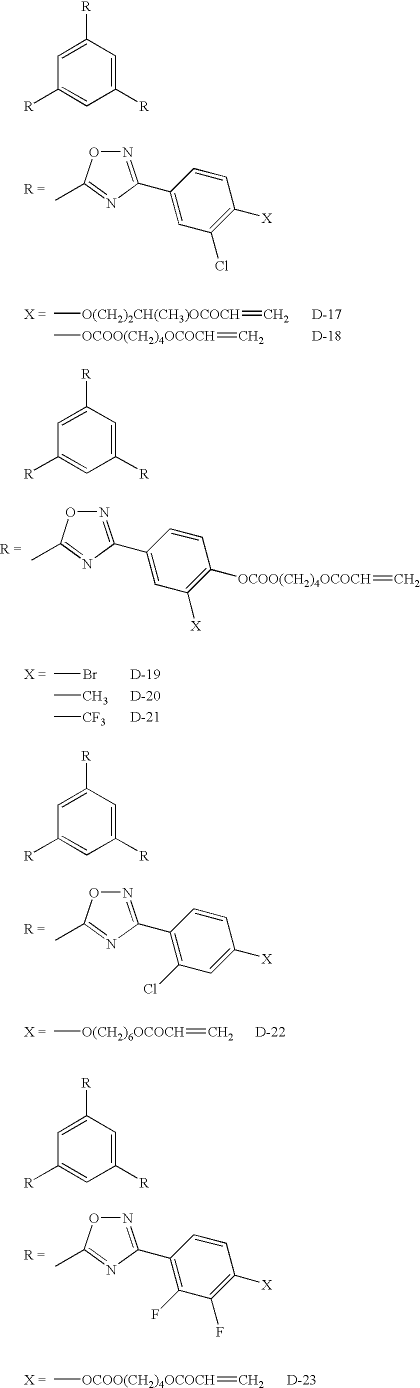

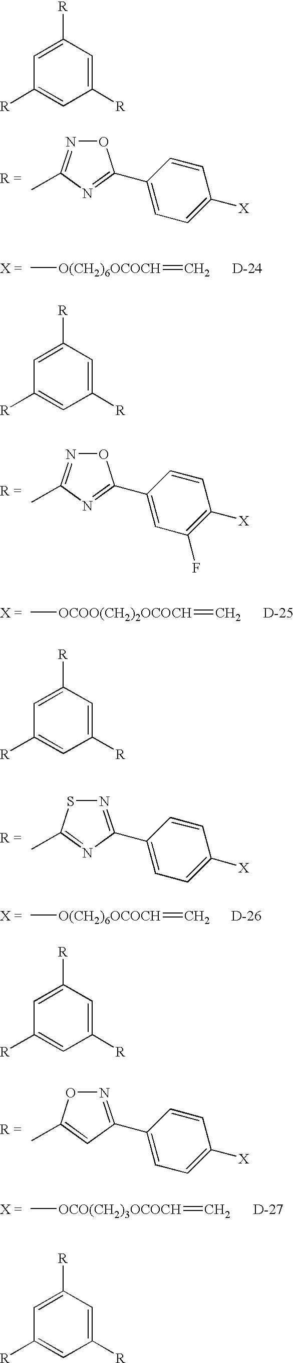

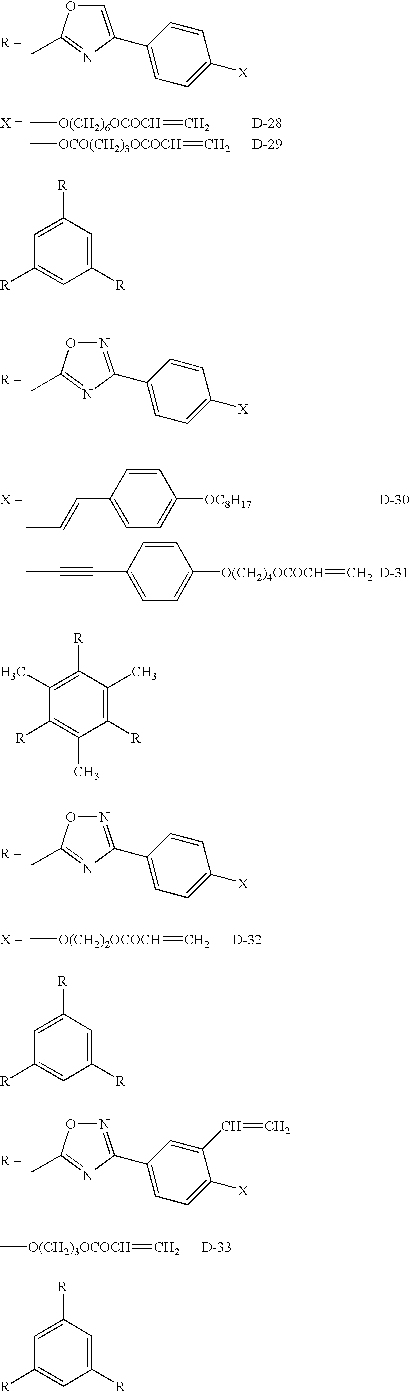

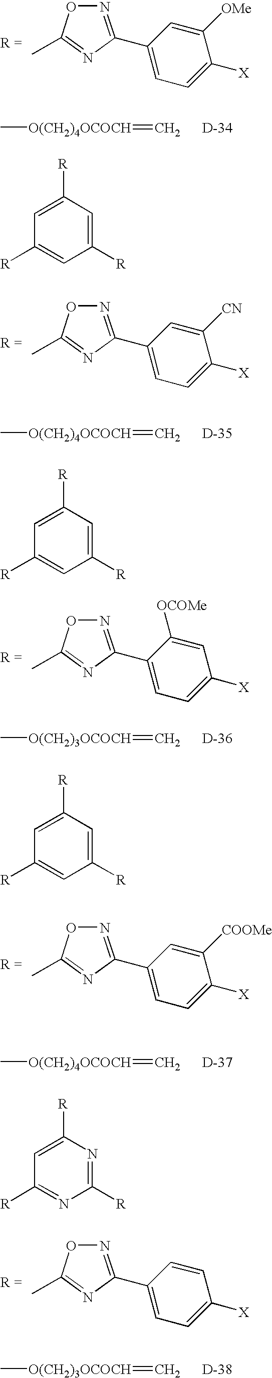

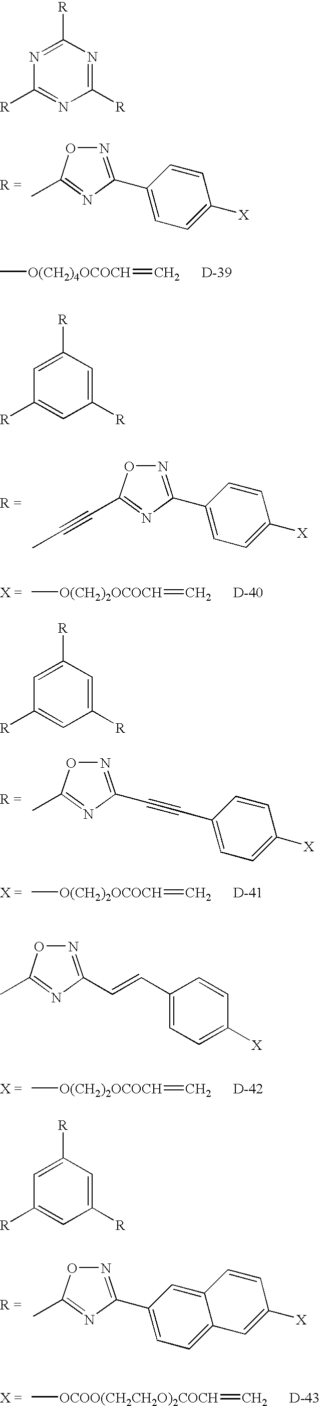

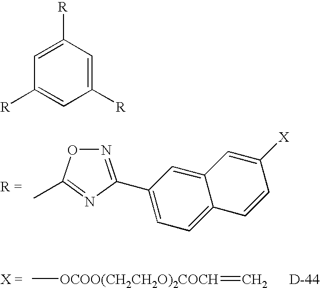

Examples of the compound represented by formula (DIII) include, but are not limited to, those shown below.

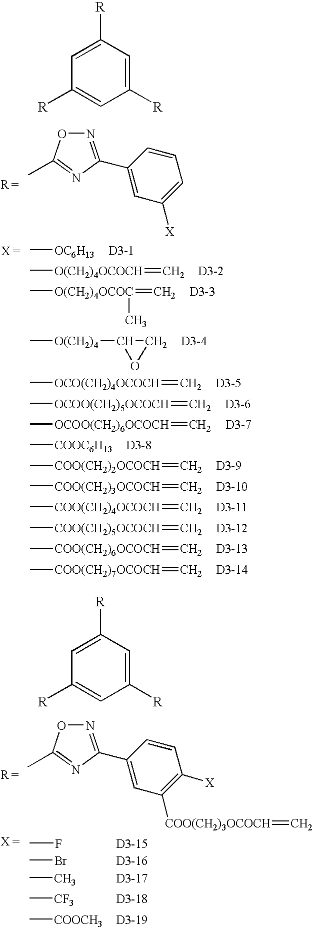

The compounds of the formulae (DI), (DII) and (DII) for used in the invention may be produced according to any method.

According to the first present invention, as discotic liquid crystal, single or plural types of the compounds represented by the formula (DI), (DII) or (DIII) may be used.

Preferred examples of the discotic liquid crystal compound also include those described in JPA No. 2005301206.

Preferably, the optically-anisotropic layer is formed by disposing the compound containing at least one liquid-crystal compound on a surface (for example, on the surface of an alignment film), then aligning the molecules of the liquid-crystal compound in a desired alignment state, polymerizing and curing them, and fixing their alignment state. Preferred embodiments of the alignment state to be fixed vary depending on the type of the liquid-crystal compound used and the mode of the intended liquid-crystal display device. Preferably, using a rod-like liquid-crystal compound in preparing the optical film to be used for optical compensation of TN-mode liquid-crystal display devices, it is desirable that molecules of the rod-like liquid-crystal compound are fixed in a hybrid alignment state. More preferably, the mean refractive index of the first optical anisotropic layer satisfies the following numerical relation (2)

nx≧nz>ny (2)

in which nx and ny each are in-plane refractive indexes, and nz is a thickness-direction refractive index.

On the other hand, using a discotic liquid-crystal compound in preparing the optical film to be used for optical compensation of TN-mode liquid-crystal display devices, it is desirable that molecules of the discotic liquid-crystal compound are fixed in a hybrid alignment state; or, using a discotic liquid-crystal compound in preparing the optical film to be used for optical compensation of ECB-mode liquid-crystal display devices, it is desirable that molecules of the discotic liquid-crystal compound are fixed in a hybrid alignment state.

Preferably, the hybrid alignment state is fixed to form the first optically-anisotropic layer. The hybrid alignment means an alignment state where the director direction of liquid-crystal molecules continuously change in the thickness direction of the layer. For rod-like molecules, the director is in the long axis direction; and for discotic molecules, the director is a direction normal to the discotic face.

For promoting alignment of liquid crystal molecules or improving the coating- or curing-ability, the composition may contain one or more types of the additives.

For promoting hybrid alignment of liquid crystal molecules (especially rod-like liquid crystal molecules), the composition may contain an additive capable of controlling their alignment at the air-interface, referred to as “agent for controlling air-interface alignment”. Examples of the agent include low- or high-molecular weight compounds having a fluorine alkyl group(s) and a hydrophilic group(s) such as sulfonyl. Specific examples of the agent for controlling air-interface alignment include, but are not limited to, those described in JPA No. 2006-267171.

The composition may be prepared as a coating liquid, and surfactant may be added to such a composition for improving the coating-ability. Fluorosurfactants are preferred, and specific examples thereof include the compounds described in the paragraphs of [0028] to [0056] in JPA No. 2001-330725. Commercially available surfactants such as “MEGAFACE F780” (produced by DIC Corporation) may be used.

Preferably, the composition comprises a polymerization initiator(s). Examples of the polymerization initiator include thermal polymerization initiators and photopolymerization initiators. Of those, preferred are photopolymerization initiators. Preferred examples of the polymerization initiator that generates radicals by the action of light given thereto are α-carbonyl compounds (as in U.S. Pat. Nos. 2,367,661, 2,367,670), acyloin ethers (as in U.S. Pat. No. 2,448,828,) α-hydrocarbon-substituted aromatic acyloin compounds (as in U.S. Pat. No. 2,722,512), polycyclic quinone compounds (as in U.S. Pat. Nos. 3,046,127, 2,951,758), combination of triarylimidazole dimer and p-aminophenyl ketone (as in U.S. Pat. No. 3,549,367), acridine and phenazine compounds (as in JP-A60-105667, U.S. Pat. No. 4,239,850) and oxadiazole compounds (as in U.S. Pat. No. 4,212,970), acetophenone compounds, benzoin ether compounds, benzyl compounds, benzophenone compounds, thioxanthone compounds. Examples of the acetophenone compound include, for example, 2,2-diethoxyacetophenone, 2-hydroxymethyl-1-phenylpropan-1-one, 4′-isopropyl-2-hydroxy-2-methyl-propiophenone, 2-hydroxy-2-methyl-propiophenone, p-dimethylaminoacetone, p-tert-butyldichloroacetophenone, p-tert-butyltrichloroacetopheone, p-azidobenzalacetophenone. Examples of the benzyl compound include, for example, benzyl, benzyl dimethyl ketal, benzyl β-methoxyethyl acetal, 1-hydroxycyclohexyl phenyl ketone. The benzoin ether compounds include, for example, benzoin, benzoinmethyl ether, benzomethyl ether, benzoin n-propyl ether, benzoin isopropyl ether, benzoin n-butyl ether, and benzoin isobutyl ether. Examples of the benzophenone compound include benzophenone, methyl o-benzoylbenzoate, Michler's ketone, 4,4′-bisdiethylaminobenzophenone, 4,4′-dichlorobenzophenone. Examples of the thioxanthone compound include thioxanthone, 2-methylthioxanthone, 2-ethylthioxanthone, 2-isopropylthioxanthone, 4-isopropylthioxanthone, 2-chlorothioxanthone, and 2,4-diethylthioxanthone. Of those aromatic ketones serving as a light-sensitive radical polymerization initiator, more preferred are acetophenone compounds and benzyl compounds in point of their curing capability, storage stability and odorlessness. One or more such aromatic ketones may be used herein as a light-sensitive radical polymerization initiator, either singly or as combined depending on the desired performance of the initiator.

For the purpose of increasing the sensitivity thereof, a sensitizer maybe added to the polymerization initiator. Examples of the sensitizer are n-butylamine, triethylamine, tri-n-butyl phosphine, and thioxanthone.

Plural types of the photopolymerization initiators may be combined and used herein, and the amount thereof is preferably from 0.01 to 20% by mass of the solid content of the coating liquid, more preferably from 0.5 to 5% by mass. For light irradiation for polymerization of the liquid-crystal compound, preferably used are UV rays.

The composition may comprise a polymerizable non-liquid crystal monomer(s) along with the polymerizable liquid crystal compound. Examples of the polymerizable monomer include compounds having a vinyl, vinyloxy, acryloyl or methacryloyl. For improving the durability, polyfunctional monomars, having two or more polymerizable groups, such as ethyleneoxide-modified trimethylolpropane acrylates maybe used.

The amount of the polymerizable non-liquid crystal monomer is preferably equal to or less than 15 mass % and more preferably from 0 to 10 mass % with respect to the amount of the liquid crystal compound.

The optically anisotropic layer may be produced according to a method comprising applying a coating liquid, which is the composition, to a surface of an alignment layer, drying it to remove solvent from it and align liquid crystal molecules, and then curing it via polymerization.

The coating method may be any known method of curtain-coating, dipping, spin-coating, printing, spraying, slot-coating, roll-coating, slide-coating, blade-coating, gravure-coating or wire bar-coating.

Drying the coating layer may be carried out under heat. During drying it, while solvent is removed from it, liquid crystal molecules therein are aligned in a preferred state.

Next, the layer is irradiated with UV light to carry out polymerization reaction, and then the alignment state is immobilized to form an optically anisotropic layer.

The irradiation energy is preferably from 20 mJ/cm² to 50 J/cm², more preferably from 100 mJ/cm² to 800 mJ/cm². For promoting the optical polymerization, the light irradiation may be attained under heat.

The thickness of the optically anisotropic layer may be from 0.1 to 10 μm or from 0.5 to 5 μm.

The optically anisotropic layer may be prepared by using an alignment layer, and examples of the alignment layer include polyvinyl alcohol layers and polyimide layers.

### 1.-1-2 Transparent Support:

According to the first invention, the transparent support comprises at least one selected from cycloolefin-base homopolymers and copolymers, preferably as the main ingredient thereof (in an amount of at least 50% by mass of all ingredients). The optical film of the first invention may be used as an optical compensation film of a TN-mode liquid-crystal display device, and in such an embodiment, the transparent support preferably satisfies the following numerical relation (3); or the optical film of the first invention may be used as an optical compensation film of an ECB-mode (especially OCB-mode) liquid-crystal display device, and in such an embodiment, the transparent support preferably satisfies the following numerical relation (4):

0.5<Rth(550)/Re(550)<1.5, (3)

4<Rth(550)/Re(550)<12. (4)

Examples of cycloolefin-base homopolymers and copolymers usable in production of the transparent support include ring-opened polymers of polycyclic monomers, etc. Specific examples of polycyclic monomers are the following compounds, to which, however, the invention should not be limited.
bicyclo[2.2.1]hept-2-ene,
tricyclo[4.3.0.1^{2,5})-8-decene,
tricyclo[4.4.0.1^{2,5})-3-undecene,
tetracyclo[4.4.0.1^{2,5}.1^{7,10}]-3-dodecene,
pentacyclo[6.5.1.1^{3,6}.0^{2,7}.0^{9,13}]-4-pentadecene,
5-methylbicyclo[2.2.1]hept-2-ene,
5-ethylbicyclo[2.2.1]hept-2-ene,
5-methoxycarbonylbicyclo[2.2.1]hept-2-ene,
5-methyl-5-methoxycarbonylbicyclo[2.2.1]hept-2-ene,
5-cyanobicyclo[2.2.1]hept-2-ene,
8-methoxycarbonyltetracyclo[4.4.0.1^{2,5}.1^{7,10}]-3-dodecene,
8-ethoxycarbonyltetracyclo[4.4.0.1^{2,5}.1^{7,10}]-3-dodecene,
8-n-propoxycarbonyltetracyclo[4.4.0.1^{2,5}.1^{7,10}]-3-dodecene,
8-isopropoxycarbonyltetracyclo[4.4.0.1^{2,5}.1^{7,10}]-3-dodecene,
8-n-butoxycarbonyltetracyclo[4.4.0.1^{2,5}.1^{7,10}]-3-dodecene,
8-methyl-8-methoxycarbonyltetracyclo[4.4.0.1^{2,5}.1^{7,10}]-3-dodecene,
8-methyl-8-ethoxycarbonyltetracyclo[4.4.0.1^{2,5}.1^{7,10}]-3-dodecene
8-methyl-8-n-propoxycarbonyltetracyclo[4.4.0.1^{2,5}.1^{7,10}]-3-dodecene,
8-methyl-8-isopropoxycarbonyltetracyclo[4.4.0.1^{2,5}.1^{7,10}]-3-dodecene,
8-methyl-8-n-butoxycarbonyltetracyclo[4.4.0.1^{2,5}.1^{7,10}]-3-dodecene,
5-ethylidenebicyclo[2.2.1]hept-2-ene,
8-ethylidenetetracyclo[4.4.0.1^{2,5}.1^{7,10}]-3-dodecene,
5-phenylbicyclo[2.2.1]-hept-2-ene,
8-phenyltetracyclo[4.4.0.1^{2,5}.1^{7,10}]-3-dodecene,
5-fluorobicyclo[2.2.1]hept-2-ene,
5-fluoromethylbicyclo[2.2.1]hept-2-ene,
5-trifluoromethylbicyclo[2.2.1]hept-2-ene,
5-pentafluoroethylbicyclo[2.2.1]hept-2-ene,
5,5-difluorobicyclo[2.2.1]hept-2-ene,
5,6-difluorobicyclo[2.2.1]hept-2-ene,
5,5-bis(trifluoromethyl)bicyclo[2.2.1]hept-2-ene,
5,6-bis(trifluoromethyl)bicyclo[2.2.1]hept-2-ene,
5-methyl-5-trifluoromethylbicyclo[2.2.1]hept-2-ene,
5,5,6-trifluorobicyclo[2.2.1]hept-2-ene,
5,5,6-tris(fluoromethyl)bicyclo[2.2.1]hept-2-ene,
5,5,6,6-tetrafluorobicyclo[2.2.1]hept-2-ene,
5,5,6,6-tetrakis(trifluoromethyl)bicyclo[2.2.1]hept-2-ene,
5,5-difluoro-6,6-bis(trifluoromethyl)bicyclo[2.2.1]hept-2-ene,
5,6-difluoro-5,6-bis(trifluoromethyl)bicyclo[2.2.1]hept-2-ene
5,5,6-trifluoro-5-trifluoromethylbicyclo[2.2.1]hept-2-ene,
5-fluoro-5-pentafluoroethyl-6,6-bis(trifluoromethyl)bicyclo[2.2.1]hept-2-ene,
5,6-difluoro-5-heptafluoro-iso-propyl-6-trifluoromethylbicyclo[2.2.1]hept-2-ene,
5-chloro-5,6,6-trifluorobicyclo[2.2.1]hept-2-ene,
5,6-dichloro-5,6-bis(trifluoromethyl)bicyclo[2.2.1]hept-2-ene
5,5,6-trifluoro-6-trifluoromethoxybicyclo[2.2.1]hept-2-ene,
5,5,6-trifluoro-6-heptafluoropropoxybicyclo[2.2.1]hept-2-ene,
8-fluorotetracyclo[4.4.0.1^{2,5}.1^{7,10}]-3-dodecene,
8-fluoromethyltetracyclo[4.4.0.1^{2,5}.1^{7,10}]-3-dodecene,
8-difluoromethyltetracyclo[4.4.0.1^{2,5}.1^{7,10}]-3-dodecene,
8-trifluoromethyltetracyclo[4.4.0.1^{2,5}.1^{7,10}]-3-dodecene,
8-pentafluoroethyltetracyclo[4.4.0.1^{2,5}.1^{7,10}]-3-dodecene,
8,8-difluorotetracyclo[4.4.0.1^{2,5}.1^{7,10}]-3-dodecene,
8,9-difluorotetracyclo[4.4.0.1^{2,5}.1^{7,10}]-3-dodecene,
8,8-bis(trifluoromethyl)tetracyclo[4.4.0.1^{2,5}.1^{7,10}]-3-dodecene,
8,9-bis(trifluoromethyl)tetracyclo[4.4.0.1^{2,5}.1^{7,10}]-3-dodecene,
8-methyl-8-trifluoromethyltetracyclo[4.4.0.1^{2,5}.1^{7,10}]-3-dodecene,
8,8,9-trifluorotetracyclo[4.4.0.1^{2,5}.1^{7,10}]-3-dodecene,
8,8,9-tris(trifluoromethyl)tetracyclo[4.4.0.1^{2,5}.1^{7,10}]-3-dodecene,
8,8,9,9-tetrafluorotetracyclo[4.4.0.1^{2,5}.1^{7,10}]-3-dodecene,
8,8,9,9-tetrakis(trifluoromethyl)tetracyclo[4.4.0.1^{2,5}.1^{7,10}]-3-dodecene,
8,8-difluoro-9,9-his(trifluoromethyl)tetracyclo[4.4.0.1^{2,5}.1^{7,10}]-3-dodecene,
8,9-difluoro-8,9-bis(trifluoromethyl)tetracyclo[4.4.0.1^{2,5}.1^{7,10}]-3-dodecene,
8,8,9-trifluoro-9-trifluoromethyltetracyclo[4.4.0.1^{2,5}.1^{7,10}]3-dodecene,
8,8,9-trifluoro-9-trifluoromethoxytetracyclo[4.4.0.1^{2,5}.1^{7,10}]-3-dodecene,
8,8,9-trifluoro-9-pentafluoropropoxytetracyclo[4.4.0.1^{2,5}.1^{7,10}]-3-dodecene,
8-fluoro-8-pentafluoroethyl-9,9-bis(trifluoromethyl)tetracyclo[4.4.0.1^{2,5}.1^{7,10}]-3-dodecene,
8,9-difluoro-8-pentafluoro-isopropyl-9-trifluoromethyltetracyclo[4.4.0.1^{2,5}.1^{7,10}]-3-dodecene,
8-chloro-8,9,9-trifluorotetracyclo[4.4.0.1^{2,5}.1^{7,10}]-3--dodecene,
8,9-dichloro-8,9-bis(trifluoromethyl)tetracyclo[4.4.0.1^{2,5}.1^{7,10}]-3-dodecene,
8-(2,2,2-trifluoroethoxycarbonyl)tetracyclo[4.4.0.1^{2,5}.1^{7,10}]-3-dodecene,
8-methyl-8-(2,2,2-trifluoroethoxycarbonyl)tetracyclo[4.4.0.1^{2,5}.1^{7,10}]-3-dodecene.

One or more of these may be used, either singly or as combined.

Not specifically defined, the molecular weight of those compounds is, in general, preferably from 5000 to 500000, more preferably from 10000 to 100000. As commercially-available cycloolefin-base polymers, ARTON series (by JSR), ZEONOR series (by Nippon Zeon), ZEONEX series (by Nippon Zeon) and ESSINA (by Sekisui Chemical Industry) are usable. Commercially available polymer films may be used after they are subjected to a stretching treatment so as to have the optical characteristics satisfying the above-mentioned numerical relations. For example, when ZEONOR series polymer films are used, they may be stretched in the machine direction (in the lengthwise direction of films) and/or in the cross direction (in the widthwise direction of films), thereby to be polymer films capable of satisfying the optical characteristics required for the support. Preferably, the stretching ratio in machine-direction is from 1 to 150%, and the stretching ratio in cross-direction is from 2 to 200%.

Preferably, the transparent support is a polymer film containing a cycloolefin-base homopolymer or copolymer. The production method for the polymer films for the support is not specifically defined, and polymer films produced in various methods may be used. For example, the polymer films may be those produced by any method of melt casting or solution casting. Conditions in film formation are described in detail in JPA No. 2004-198952, and the description may be referred to in producing the films in the invention.

In order to obtain films having the optical characteristics that satisfy the above-mentioned numerical relations required for the transparent support, it is desirable that the films produced according to a solution casting method is stretched in the machine direction and the cross direction of the films. Preferably, the draw ratio is from 1 to 200%. The stretching in the machine direction may be attained by the difference in the rotation of rolls that support the film; and the stretching in the cross direction may be attained by the use of a tenter.

The polymer films for use as the transparent support may contain various additives in addition to the cycloolefin-base homopolymer or copolymer.

The polymer film may contain fine particles as a mat agent. Fine particles usable as a mat agent are, for example, those of silicon dioxide, titanium dioxide, aluminium oxide, zirconium oxide, calcium carbonate, calcium carbonate, talc, clay, calcined kaolin, calcined calcium silicate, calcium silicate hydrate, aluminium silicate, magnesium silicate and calcium phosphate. As the fine particles, preferred are those containing silicon as their turbidity is low; and more preferred is silicon dioxide. Fine particles of silicon dioxide are available as commercial products such as Aerosil R972, R972V, R974, R812, 200, 200V, 300, R202, OX50, TT600 (all by Nippon Aerosil). Also available are commercial products of Aerosil R976 and R811 (both by Nippon Aerosil). Any of these are usable herein as a mat agent.

The amount of the mat agent to be used is preferably from 0.01 to 0.3 parts by mass relative to 100 parts by mass of the polymer component that contains a cycloolefin-base homopolymer and/or copolymer.

The polymer film for use as the transparent support is preferably processed for surface treatment for the purpose of bettering the adhesiveness to the above-mentioned optically-anisotropic layer or a polarizing film. Concretely, the surface treatment includes corona discharge treatment, glow discharge treatment, flame treatment, acid treatment, alkali treatment or UV irradiation treatment. Preferably, an undercoat layer may be formed on the support film.

The optical film of the first invention is useful as an optical film for various modes of liquid-crystal display devices. Above all, it is useful for optical compensation for TN-mode or ECB-mode (especially OBC-mode) liquid-crystal display devices. In an embodiment of an optical compensation film for TN-mode liquid-crystal display devices, it is desirable that the transparent support satisfies the following numerical relation (3); and in an embodiment of an optical compensation film for OCB-mode liquid-crystal display devices, it is desirable that the transparent support satisfies the following numerical relation (4):

0.5<Rth(550)/Re(550)<1.5, (3)

4<Rth(550)/Re(550)<12. (4)

Regarding the combination of Rth(550) and Re(550) satisfying the above relation (3), Rth(550) preferably falls from 2.5 to 150 nm, and Re(550) from 5 to 100 nm. Regarding the combination of Rth(550) and Re(550) satisfying the above relation (4), Rth(550) preferably falls from 80 to 1200 nm, and Re(550) from 20 to 100 nm.

The optical film of the first invention is characterized in that its optical characteristics fluctuate small depending on the influence of the environmental humidity thereon. For example, based on Rth measured at an environmental humidity of 60% RH at 25° C., the absolute value of the difference between the base Rth and Rth measured in a low-humidity condition (25° C., 10% RH) or that measured in a high-humidity condition (25° C., 80% RH) is indicated by ΔRth (low humidity) or ΔRth (high humidity), respectively; and it is desirable that ΔRth (low humidity) and ΔRth (high humidity) are both at most 60 nm, more preferably at most 20 nm.

The optical film of the first invention may be incorporated in a liquid-crystal display device as an independent member; or it may be integrated with a linear polarizing film to form an elliptically-polarizing plate, and this may be incorporated in a liquid-crystal display device.

The polarizing plate of the first invention is described below.

### 1.-2 Polarizing Plate:

The first invention also relates to a polarizing plate that comprises at least the above-mentioned optical film and a polarizing film. When the polarizing plate of the first invention is incorporated in a liquid-crystal display device, it is desirable that the optical film is on the side of the liquid-crystal cell. Also preferably, the surface of the transparent support is stuck to the surface of the polarizing film. Preferably, a protective film such as a cellulose acylate film is stuck to the other face of the polarizing film.

### 1.-2-1 Polarizing Film:

Examples of a polarizing film include an iodine-base polarizing film, a dye-base polarizing film with a dichroic dye, and a polyene-base polarizing film, and any of these is usable in the invention. The iodine-base polarizing film and the dye-base polarizing film are produced generally by the use of polyvinyl alcohol films.

### 1.-2-3 Protective Film:

As the protective film to be stuck to the other surface of the polarizing film, preferably used is a transparent polymer film. “Transparent” means that the film has a light transmittance of at least 80%. As the protective film, preferred are cellulose acylate films and polyolefin films. Of cellulose acylate films, preferred are cellulose triacetate film. Of polyolefin films, preferred are cyclic polyolefin-containing polynorbornene films.

Preferably, the thickness of the protective film is from 20 to 500 μm, more preferably from 50 to 200 μm.

The polarizing plate of the first invention may be produced as a long continuous film. For example, using a long continuous cycloolefin-base polymer film as the transparent support, an alignment film-forming coating liquid is optionally applied onto its surface to form an alignment film thereon, and then an optically-anisotropic layer-forming coating liquid is continuously applied onto it and dried to form an optically-anisotropic layer in a desired alignment state, and thereafter this is irradiated with light to thereby fix the alignment state of the layer; and the thus-produced, long continuous optical film is wound up as a roll. Apart from it, a long continuous polarizing film, and a long continuous polymer film for a protective film are separately wound up each as a roll, and they are stuck together in a roll-to-roll mode to complete a long continuous polarizing plate. For example, after wound up as a roll, the long continuous polarizing plate may be transferred and stored in the form of the roll thereof; and before it is incorporated into a liquid-crystal display device, it may be cut into pieces having a desired size.

### 1.-3 Liquid-Crystal Display Device:

The optical film and the polarizing plate of the first invention may be used in various types of liquid-crystal display devices. In addition, they may also be used in any of transmission-type, reflection-type and semitransmission-type liquid-crystal display devices. Above all, they are favorable to TN-mode and ECB (electrically controlled birefringence)-mode liquid-crystal display devices. Of ECB-mode ones, they are more suitable for OBC-mode liquid-crystal display devices. One embodiment of the liquid-crystal display device of the first invention comprises a pair of the above-mentioned polarizing plates and a liquid-crystal cell disposed between them.

### 2. Second Invention:

### 2.-1 Optical Compensation Film:

The second invention relates to an optical compensation film comprising a transparent support, and an optically-anisotropic layer of a composition containing a liquid-crystal compound, in which the transparent support is formed of a film containing a polymer having at least either of a lactone ring unit or a glutaric anhydride unit. In the second invention, the transparent support is a film containing a polymer having at least either of a lactone ring unit or a glutaric anhydride unit, and this reduces the degree of extinction of the optical compensation film. The optical compensation film of the second invention may reduce to degree of extinction thereof to at most 0.0015. The degree of extinction is preferably smaller, but the allowable uppermost limit thereof may be determined in consideration of the other parameters (e.g., haze) that may vary depending on the degree of extinction. The degree of extinction is determined as a value obtained by dividing the light transmittance measured when a retardation film is disposed between two cross-Nicol polarizers in such a manner that the transmittance could be the minimum, by the light transmittance measured when two polarizing plates are disposed in para-Nicol with no optical compensation film therebetween.

### 2.-1-1 Transparent Support:

In the second invention, the transparent support is formed of a film containing a polymer having at least either of a lactone ring unit or a glutaric anhydride unit.

Polymer having at least one lactone ring unit (hereinafter this is referred to as “lactone ring-containing polymer”):

The lactone ring-containing polymer usable in the second invention is a polymer having a lactone ring structure, preferably having a lactone ring structure of the following formula (1):

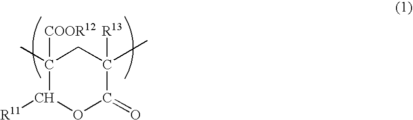

In the formula, R¹¹, R¹² and R¹³ each independently represent a hydrogen atom, or an organic residue having from 1 to 20 carbon atoms. The organic residue may contain an oxygen atom. The number of the carbon atoms constituting the organic residue is preferably from 1 to 15, more preferably from 1 to 12, even more preferably from 1 to 8, still more preferably from 1 to 5. The organic residue includes a substituted or unsubstituted alkyl group, a substituted or unsubstituted aryl group, a substituted or unsubstituted alkoxy group, and is preferably an alkyl group. The substituent includes an alkyl group, an aryl group, and an alkoxy group. More preferably, R¹¹, R¹² and R¹³ each are a hydrogen atom, a methyl group, an ethyl group or a propyl group, even more preferably a hydrogen atom, a methyl group or an ethyl group, still more preferably a hydrogen atom or a methyl group.

The content of the lactone ring structure of formula (1) in the lactone ring-containing polymer structure is preferably from 5 to 90% by mass, more preferably from 10 to 70% by mass, even more preferably from 10 to 60% by mass, still more preferably from 10 to 50% by mass. When the content of the lactone ring structure of formula (1) in the lactone ring-containing polymer structure is at least 5% by mass, then the film may have sufficient heat resistance, solvent resistance and surface hardness. When the content of the lactone ring structure of formula (1) in the lactone ring-containing polymer structure is at most 90% by mass, then the polymer may have better shapability and processability.

The lactone ring-containing polymer may have any other structure than the lactone ring structure of formula (1). Not specifically defined, the other structure than the lactone ring structure of formula (1) preferably includes polymer structure units (repetitive structure units) to be constructed by polymerization of at least one selected from (meth)acrylates, hydroxyl group-containing monomers, unsaturated carboxylic acids and monomers of the following formula (2a), as described hereinunder as the production method for lactone ring-containing polymer.

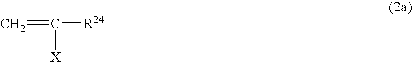

In the formula, R²⁴ represents a hydrogen atom or a methyl group; X represents a hydrogen atom, an alkyl group having from 1 to 20 carbon atoms, an aryl group, an acetate group, a cyano group, a group —CO—R²⁵ or a group CO—O—R²⁶; R²⁵ and R²⁶ each represent a hydrogen atom or an organic residue having from 1 to 20 carbon atoms. For the organic residue having from 1 to 20 carbon atoms, referred to is the description of the organic residue in formula (1) given hereinabove.

The content of the other structure than the lactone ring structure of formula (1) in the lactone ring-containing polymer structure is preferably from 10 to 95% by mass, more preferably from 10 to 90% by mass, even more preferably from 40 to 90% by mass, still more preferably from 50 to 90% by mass, when the other structure is a polymer structure unit(repetitive structure unit) constructed by polymerization of a (meth)acrylate; the content is preferably from 0 to 30% by mass, more preferably from 0 to 20% by mass, even more preferably from 0 to 15% by mass, still more preferably from 0 to 10% by mass, when the other structure is a polymer structure unit (repetitive structure unit) constructed by polymerization of a hydroxyl group-containing monomer. When the other structure is a polymer structure unit (repetitive structure unit) constructed by polymerization of an unsaturated carboxylic acid, its content is preferably from 0 to 30% by mass, more preferably from 0 to 20% by mass, even more preferably from 0 to 15% by mass, still more preferably from 0 to 10% by mass. When the other structure is a polymer structure unit (repetitive structure unit) constructed by polymerization of a monomer of formula (2a), its content is preferably from 0 to 30% by mass, more preferably from 0 to 20% by mass, even more preferably from 0 to 15% by mass, still more preferably from 0 to 10% by mass.

The production method for the lactone ring-containing polymer is not specifically defined. Preferred is a method comprising preparing a polymer (a) having a hydroxyl group and an ester group in the molecular chain in a polymerization step, and then thermally processing the obtained polymer (a) to thereby introducing a lactone ring structure into the polymer in a lactone ring-forming condensation step.

In the polymerization step, for example, a monomer composition containing a monomer of the following formula (1a) may be polymerized to give a polymer having a hydroxyl group and an ester group in the molecular chain.

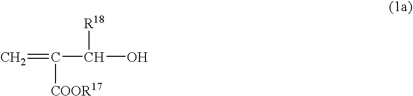

In the formula, R¹⁷ and R¹⁸ each independently represent a hydrogen atom or an organic residue having from 1 to 20 carbon atoms. For the organic residue having from 1 to 20 carbon atoms, referred to is the description of the organic residue in the above formula (1) given hereinabove.

The monomer of formula (1a) includes, for example, methyl 2-(hydroxymethyl)acrylate, ethyl 2-(hydroxymethyl)acrylate, isopropyl 2-(hydroxymethyl)acrylate, n-butyl 2-(hydroxymethyl)acrylate, tert-butyl 2-(hydroxymethyl)acrylate. Of those, preferred are methyl 2-(hydroxymethyl)acrylate and ethyl 2-(hydroxymethyl)acrylate in point of their effect of improving heat resistance; and more preferred is methyl 2-(hydroxymethyl)acrylate. One or more different types of the monomers of formula (1a) may be used either singly or as combined.

The content of the monomer of formula (1a) in the monomer composition to be polymerized in the polymerization step is preferably from 5 to 90% by mass, more preferably from 10 to 70% by mass, even more preferably from 10 to 60% by mass, still more preferably from 10 to 50% by mass. When the content of the monomer of formula (1a) in the monomer composition to be polymerized in the polymerization step is at least 5% by mass, then the film may have sufficient heat resistance, solvent resistance and surface hardness. When content of the monomer of formula (1a) in the monomer composition to be polymerized in the polymerization step is at most 90% by mass, then gellation may be prevented in lactone cyclization and a polymer having better shapability and processability may be obtained.

The monomer composition to be polymerized in the polymerization step may contain any other monomer than the monomer of formula (1a). Not specifically defined, preferred examples of the other monomer include, for example, (meth)acrylates, hydroxyl group-containing monomers, unsaturated carboxylic acids, and monomers of the above formula (2a). One or more such other monomers than the monomer of formula (1a) may be used herein either singly or as combined.

Not specifically defined, the (meth)acrylates may be any (meth)acrylates except the monomer of formula (1a), including, for example, acrylates such as methyl acrylate, ethyl acrylate, n-butyl acrylate, isobutyl acrylate, tert-butyl acrylate, cyclohexyl acrylate, benzyl acrylate; methacrylates such as methyl methacrylate, ethyl methacrylate, propyl methacrylate, n-butyl methacrylate, isobutyl methacrylate, tert-butyl methacrylate, cyclohexyl methacrylate, benzyl methacrylate. One or more of these may be used either singly or as combined. Of those, especially preferred is methyl methacrylate as the film may have excellent heat resistance and transparency.

In the embodiment where the other (meth)acrylate than the monomer of formula (1a) is used, its content in the monomer composition to be polymerized in the polymerization step is preferably from 10 to 95% by mass, more preferably from 10 to 90% by mass, even more preferably from 40 to 90% by mass, still more preferably from 50 to 90% by mass, for sufficiently exhibiting the effect of the invention.

Not specifically defined, the hydroxyl group-containing monomers may be any hydroxyl group-containing monomers except the monomer of formula (1a), including, for example, α-hydroxymethylstyrene, α-hydroxyethylstyrene; (2-hydroxyalkyl)acrylates such as methyl 2-(hydroxyethyl)acrylate; and 2-(hydroxyalkyl)acrylic acids such as 2-(hydroxyethyl)acrylic acid. One or more of these may be used either singly or as combined.

Where the hydroxyl group-containing monomer except the monomer of formula (1a) is used, its content in the monomer composition to be polymerized in the polymerization step is preferably from 0 to 30% by mass, more preferably from 0 to 20% by mass, even more preferably from 0 to 15% by mass, still more preferably from 0 to 10% by mass, for sufficiently exhibiting the effect of the invention.

The unsaturated carboxylic acids include, for example, acrylic acid, methacrylic acid, crotonic acid, α-substituted acrylic acids, α-substituted methacrylic acids. One or more of these may be used either singly or as combined. Of those, more preferred are acrylic acid and methacrylic acid as capable of sufficiently exhibiting the effect of the invention.

In the embodiment where unsaturated carboxylic acid is used, its content in the monomer composition to be polymerized in the polymerization step is preferably from 0 to 30% by mass, more preferably from 0 to 20% by mass, even more preferably from 0 to 15% by mass, still more preferably from 0 to 10% by mass, for sufficiently exhibiting the effect of the invention.

The monomers of formula (2a) include, for example, styrene, vinyltoluene, α-methylstyrene, acrylonitrile, methyl vinyl ketone, ethylene, propylene, vinyl acetate. One or more of these may be used either singly or as combined. Of those, more preferred are styrene and α-methylstyrene as capable of sufficiently exhibiting the effect of the invention.

In the embodiment where the monomer of formula (2a) is used, its content in the monomer composition to be polymerized in the polymerization step is preferably from 0 to 30% by mass, more preferably from 0 to 20% by mass, even more preferably from 0 to 15% by mass, still more preferably from 0 to 10% by mass, for sufficiently exhibiting the effect of the invention.

The polymerization temperature and the polymerization time vary depending on the type of the monomers used and the ratio thereof. Preferably, the polymerization temperature is from 0 to 150° C., and the polymerization time is from 0.5 to 20 hours; more preferably, the polymerization temperature is from 80 to 140° C., and the polymerization time is from 1 to 10 hours.

In the polymerization mode using a solvent, the polymerization solvent is not specifically defined. For example, it includes aromatic hydrocarbon solvents such as toluene, xylene, ethylbenzene; ketone solvents such as methyl ethyl ketone, methyl isobutyl ketone; ether solvents such as tetrahydrofuran. One or more of these may be used either singly or as combined. When the boiling point of the solvent used is too high, then the residual volatile fraction remaining in the finally obtained lactone ring-containing polymer may increase. Therefore, the boiling point of the solvent is preferably from 50 to 200° C.

In polymerization, a polymerization initiator may be added, if desired. Not specifically defined, the polymerization initiator includes, for example, organic peroxides such as cumene hydroperoxide, diisopropylbenzene hydroperoxide, di-tert-butyl peroxide, lauroyl peroxide, benzoyl peroxide, tert-butylperoxyisopropyl carbonate, tert-amylperoxy-2-ethyl hexanoate; and azo compounds such as 2,2′-azobis(isobutyronitrile), 1,1′-azobis(cyclohexanecarbonitrile), 2,2′-azobis (2,4-dimethylvaleronitrile). One or more of these may be used either singly or as combined. Not specifically defined, the amount of the polymerization initiator to be used may be suitably determined depending on the combination of the monomers to be used and the reaction condition.

In polymerization, it is desirable that the concentration of the polymer formed in the polymerization reaction mixture is controlled to be at most 50% by mass, for preventing the reaction liquid from gelling. Concretely, in the embodiment where the concentration of the polymer formed in the polymerization reaction mixture is more than 50% by mass, it is desirable that a polymerization solvent is suitably added to the polymerization reaction mixture so as to make the mixture have a polymer concentration of at most 50% by mass. The concentration of the polymer formed in the polymerization reaction mixture is more preferably at most 45% by mass, even more preferably at most 40% by mass. However, when the concentration of the polymer in the polymerization reaction mixture is too low, then the producibility may lower. Therefore, the concentration of the polymer in the polymerization reaction mixture is preferably at least 10% by mass, more preferably at least 20% by mass.

The mode of suitably adding the polymerization solvent to the polymerization reaction mixture is not specifically defined. The polymerization solvent may be continuously added, or may be added intermittently. Thus controlling the concentration of the polymer formed in the polymerization reaction mixture may more sufficiently prevent the reaction liquid from gelling, and in particular, even in a case where the proportion of the hydroxyl group and the ester group in the molecular chain is increased so as to increase the lactone ring content ratio to thereby enhance the heat resistance of the polymer, the gellation may be sufficiently prevented. The polymerization solvent to be added may be the same type as that of the solvent used in the initial stage of monomer feeding for polymerization, or may differ from the latter. Preferably, however, the polymerization solvent to be added is the same type as that of the solvent used in the initial stage of monomer feeding for polymerization. A single solvent or a mixed solvent of two or more different types of solvents may be used as the polymerization solvent to be added.

The polymerization reaction mixture obtained at the time at which the polymerization step as above has ended generally contains a solvent in addition to the formed polymer; however, it is unnecessary to completely remove the solvent to take out the polymer as a solid state, and it is desirable to introduce the polymer still containing the solvent to the subsequent lactone ring-forming condensation step. If desired, however, the polymer is once taken out as a solid state, and a suitable solvent may be newly added to the subsequent lactone ring-forming condensation step.

The polymer obtained in the polymerization step is a polymer (a) having a hydroxyl group and an ester group in the molecular chain, and the weight-average molecular weight of the polymer (a) is preferably from 1,000 to 2,000,000, more preferably from 5,000 to 1,000,000, even more preferably from 10,000 to 500,000, still more preferably from 50,000 to 500,000. The polymer (a) obtained in the polymerization step is heated in the subsequent lactone ring-forming condensation step, in which a lactone ring structure is introduced into the polymer to give a lactone ring-containing polymer.

The reaction of introducing a lactone ring structure into the polymer (a) comprises heating the polymer (a) for cyclization and condensation of the hydroxyl group and the ester group existing in the molecular chain of the polymer (a) to give a lactone ring structure, in which the cyclization and condensation gives an alcohol as a side product. The lactone ring structure formed in the molecular chain of the polymer (the main skeleton of the polymer) gives high heat resistance to the resulting polymer. When the reactivity of the cyclization condensation reaction to give the lactone ring structure is poor, then it is undesirable since the heat resistance could not be sufficiently enhanced or the polymer may be condensed during its shaping by the heat treatment in shaping it and the formed alcohol may remain in the shaped article as bubbles or silver streaks.

The lactone ring-containing polymer thus obtained in the lactone ring-forming condensation step preferably has the lactone ring structure of the above-mentioned formula (1).

The method of heat treatment of the polymer (a) is not specifically, for which, any known method is usable. For example, the solvent-containing polymerization reaction mixture obtained in the polymerization step may be directly heated as it is. In the presence of a solvent, it may be heated with a ring-closing catalyst. A heating furnace of a reaction device equipped with a vacuum unit or a degassing unit for removing a volatile ingredient, or an extruder equipped with a degassing unit may be used for the heat treatment.

In the cyclization condensation reaction, other thermoplastic resins may be coexisted with the polymer (a). Also in the cyclization condensation reaction, if desired, an ordinary esterification catalyst or transesterification catalyst such as p-toluenesulfonic acid may be used as a cyclization condensation catalyst; or an organic carboxylic acid such as acetic acid, propionic acid, benzoic acid, acrylic acid or methacrylic acid may be used as a catalyst. As described in JPA 61-254608 and 61-261303, a basic compound, an organic carboxylic acid salt and a carbonic acid salt may also be used.

In the cyclization condensation reaction, an organic phosphorus compound is preferably used as a catalyst, as shown in JPA 2001-151814. Using an organic phosphorus compound as a catalyst may increase the cyclization condensation reactivity and may greatly reduce the coloration of the formed lactone ring-containing polymer. Further, using an organic phosphorus compound as a catalyst may prevent the reduction in the molecular weight of the polymer that may occur in the degassing step optionally combined with the condensation step as mentioned below, thereby making the polymer have excellent mechanical strength.

The amount of the catalyst to be used in the cyclization condensation reaction is not specifically defined. Preferably, it may be from 0.001 to 5% by mass relative to the polymer (a), more preferably from 0.01 to 2.5% by mass, even more preferably from 0.01 to 1% by mass, still more preferably from 0.05 to 0.5% by mass. When the amount of the catalyst to be used is at least 0.001% by mass, then the reactivity of the cyclization condensation may be sufficiently high; and when it is at most 5% by mass, then the catalyst used may not cause coloration and crosslinking, and the polymer may have good melt shapability.

The time at which the catalyst is added is not specifically defined. The catalyst may be added in the initial stage of reaction, or during reaction, or both in the two.

Preferably, the cyclization condensation reaction is carried out in the presence of a solvent, and the cyclization condensation is combined with a degassing step. The cyclization condensation may be combined with a degassing step all the time during the reaction, and the cyclization condensation may not be combined with a degassing step all the time during the reaction but may be combined with it in a part of the reaction. In these embodiments, the alcohol formed as a side product during the cyclization condensation may be forcedly degassed, and therefore, the reaction equilibrium is advantageous for the product side.

The degassing step comprises removing the volatile fractions such as solvent and unreacted monomer, and the alcohol formed as a side product by the cyclization condensation for lactone ring structure formation, optionally under reduced pressure and under heat. When the removal is insufficient, then the amount of the remaining volatile fractions in the formed resin may increase, therefore causing various problems in that the shaped product of the resin may be colored owing to the discoloration of the volatile fractions during shaping or the shaped product may have shaping failures such as bubbles and silver streaks.

In the embodiment where the cyclization condensation is combined with a degassing step all the time during the reaction, the apparatus to be used is not specifically defined. Preferably used in the embodiment is a degassing unit comprising a heat exchanger and a degassing tank, or a vented extruder, or a combination of the degassing unit and the vented extruder connected in series. More preferred is a degassing unit comprising a heat exchanger and a degassing tank, or a vented extruder.

The reaction temperature in the embodiment where the above-mentioned degassing unit comprising a heat exchanger and a degassing tank is used is preferably within a range of from 150 to 350° C., more preferably from 200 to 300° C. When the reaction temperature is not lower than 150° C., then the cyclization condensation may go on sufficiently and the remaining volatile fractions may be reduced; and when it is not higher than 350° C., then the polymer may be prevented from being colored or decomposed.

The reaction pressure in the embodiment where the above-mentioned degassing unit comprising a heat exchanger and a degassing tank is used is preferably within a range of from 931 to 1.33 hPa (700 to 1 mmHg), more preferably from 798 to 66.5 hPa (600 to 50 mmHg). When the pressure is at most 931 hPa, then the volatile fractions including alcohol may be sufficiently prevented from remaining in the system; and when it is at least 1.33 hPa, the industrial performance of the method may be better.

When the above-mentioned vented extruder is used, the number of the vents may be one or more. Preferably, the extruder has plural vents.

In the embodiment where the vented extruder is used, the reaction temperature is preferably within a range of from 150 to 350° C., more preferably from 200 to 300° C. When the temperature is not lower than 150° C., the cyclization condensation may go on sufficiently and the remaining volatile fractions may be reduced; and when it is not higher than 350° C., then the polymer may be prevented from being colored or decomposed.

The reaction pressure in the embodiment where the above-mentioned vented extruder is used is preferably within a range of from 931 to 1.33 hPa (700 to 1 mmHg), more preferably from 798 to 13.3 hPa (600 to 10 mmHg). When the pressure is at most 931 hPa, then the volatile fractions including alcohol may be sufficiently prevented from remaining in the system; and when it is at least 1.33 hPa, the industrial performance of the method may be better.

In the embodiment where the cyclization condensation is combined with a degassing step all the time during the reaction, the physical properties of the obtained lactone ring-containing polymer may worsen under a severe heat treatment condition as described hereinunder; and therefore in the embodiment, it is desirable that the above-mentioned alcohol removal catalyst is used and the reaction is attained by the use of a vented extruder under a condition as mild as possible.

In the embodiment where the cyclization condensation is combined with a degassing step all the time during the reaction, it is desirable that the polymer (a) formed in the polymerization step is introduced into the cyclization condensation reactor system along with a solvent thereinto, but in this embodiment, if desired, the polymer may be once again led to pass through the above-mentioned reactor device such as a vented extruder.

In another embodiment, the cyclization condensation may be not combined with a degassing step all the time during the reaction but is combined with it in a part of the reaction. For example, the device in which the polymer (a) has been produced is further heated, and if desired, this is combined with a degassing step in which the cyclization condensation of the polymer is partly attained in some degree, and then the polymer is processed in the subsequent cyclization condensation step combined with a degassing step, in which the reaction of the polymer is thus completed.

In the above-mentioned embodiment where the cyclization condensation is combined with a degassing step all the time during the reaction, for example, the polymer (a) may be partly decomposed before the cyclization condensation owing to the difference in the heat history thereof in the high-temperature heat treatment at around 250° C. or higher in a double-screw extruder, and the physical properties of the obtained lactone ring-containing polymer may be thereby worsened. To solve the problem, prior to the cyclization condensation combined with the degassing step, the polymer is previously processed for cyclization condensation in some degree; and in that manner, the reaction condition in the latter step of subsequent cyclization condensation of the polymer may be relaxed in some degree and the physical properties of the obtained lactone ring-containing polymer may be prevented from being worsened. Accordingly, this embodiment is preferred. More preferably, the degassing step is started after a period of time from the start of the cyclization condensation, or that is, the polymer (a) produced in the polymerization step is processed for cyclization condensation of the hydroxyl group and the ester group existing in the molecular chain thereof so that the cyclization condensation degree of the polymer is increased in some degree, and then the polymer is again processed for cyclization condensation as combined with a degassing step. Concretely, for example, the polymer is processed in a pot-type reactor in the presence of a solvent therein for cyclization condensation in some degree, and then, this is transferred into a reactor equipped with a degassing unit, for example, into a degassing system comprising a heat exchanger and a degassing tank, or a vented extruder, in which the cyclization condensation of the polymer is completed. This is an example of the preferred embodiment. Especially in this embodiment, it is more desirable that a catalyst for cyclization condensation exists in the reaction system.

As described in the above, the method of cyclization condensation simultaneously combined with a degassing step, in which the hydroxyl group and the ester group existing in the molecular chain of the polymer (a) obtained in the polymerization step are previously processed for cyclization condensation to increase the cyclization condensation degree of the polymer in some degree, is a preferred embodiment for obtaining the lactone ring-containing polymer for use in the invention. According to this embodiment, a lactone ring-containing polymer having a higher glass transition temperature, having a higher degree of cyclization condensation and having more excellent heat resistance can be obtained. In this embodiment, regarding the intended degree of cyclization condensation, it is desirable that the mass reduction ratio in the range falling between 150° C. and 300° C. in the dynamic TG determination shown in Examples given hereinunder is at most 2%, more preferably at most 1.5%, even more preferably at most 1%.

The reactor employable for the previous cyclization condensation to be attained prior to the cyclization condensation simultaneously combined with a degassing step is not specifically defined. Preferably, the reactor is an autoclave, a pot-type reactor, or a degassing unit comprising a heat exchanger and a degassing tank. In addition, a vented extruder favorable for the cyclization condensation simultaneously combined with a degassing step is also favorably used. More preferred is an autoclave or a pot-type reactor. However, even when any other reactor such as a vented extruder is used, the cyclization condensation may be attained under the same reaction condition as that in an autoclave or a pot-type reactor, by controlling the venting condition to a more moderate one, or by not venting the extruder, or by controlling the temperature condition, the barrel condition, the screw form and the screw driving condition.

For the previous cyclization condensation to be attained prior to the cyclization condensation simultaneously combined with a degassing step, preferably employed is (i) a method of adding a catalyst to a mixture that contains the polymer (a) formed in the polymerization step and a solvent, and heating it, or (ii) a method of heating the mixture in the absence of a catalyst. The method (i) and (ii) may be attained under pressure.

The “mixture containing the polymer (a) and a solvent” to be introduced into the cyclization condensation system in the lactone ring-forming step may be the polymerization reaction mixture obtained in the polymerization step as it is; or the solvent may be once removed from the mixture, and a different solvent suitable for cyclization condensation may be newly added to it.

The solvent that may be added to the previous cyclization condensation to be attained prior to the cyclization condensation simultaneously combined with a degassing step is not specifically defined. For example, the solvent includes aromatic hydrocarbons such as toluene, xylene, ethylbenzene; ketones such as methyl ethyl ketone, methyl isobutyl ketone; and chloroform, DMSO, tetrahydrofuran. Preferably, the solvent is the same as that usable in the polymerization step.

The catalyst to be added in the above step (i) maybe ordinary esterification or interesterification catalysts such as p-toluenesulfonic acid, as well as basic compounds, organic carboxylic acid salts, carbonic acid salts. Preferred are the above-mentioned organic phosphorus compounds. The time when the catalyst is added is not specifically defined. The catalyst may be added in the initial stage of reaction, or during the reaction, or both in the two. The amount of the catalyst to be added is not also specifically defined. Preferably, it may be from 0.001 to 5% by mass of the polymer (a), more preferably from 0.01 to 2.5% by mass, even more preferably from 0.01 to 1% by mass, still more preferably from 0.05 to 0.5% by mass. The heating temperature and the heating time in the step (i) are not specifically defined. The heating temperature is preferably not lower than room temperature, more preferably not lower than 50° C.; and the heating time is preferably from 1 to 20 hours, more preferably from 2 to 10 hours. When the heating temperature is low, or when the heating time is short, then it is unfavorable since the conversion in cyclization condensation may lower. However, when the heating time is too long, then it is also unfavorable since the resin may color or decompose.

For the above method (ii), for example, employable is a method of heating the polymerization mixture obtained in the polymerization step, directly as it is, using a pressure-resistant pot reactor. The heating temperature is preferably not lower than 100° C., more preferably not lower than 150° C. The heating time is preferably from 1 to 20 hours, more preferably from 2 to 10 hours. When the heating temperature is low, or when the heating time is short, then it is unfavorable since the conversion in cyclization condensation may lower. However, when the heating time is too long, then it is also unfavorable since the resin may color or decompose.

The above methods (i) and (ii) may be attained under pressure with no problem, depending on the condition thereof.

During the previous cyclization condensation to be attained prior to the cyclization condensation simultaneously combined with a degassing step, a part of the solvent may spontaneously vaporize during the reaction with no problem.

At the end of the previous cyclization condensation to be attained prior to the cyclization condensation simultaneously combined with a degassing step, or that is, just before the start of the degassing step, the mass reduction ratio in the range falling between 150° C. and 300° C. in dynamic TG determination is preferably at most 2%, more preferably at most 1.5%, even more preferably at most 1%. When the mass reduction ratio is at most 2%, then the cyclization condensation reactivity may be increased up to a sufficiently high level during the successive cyclization condensation simultaneously combined with a degassing step, and the obtained lactone ring-containing polymer may therefore have better physical properties. During the cyclization condensation, any other thermoplastic resin may be added to the system in addition to the polymer (a).

In the embodiment where the hydroxyl group and the ester group existing in the molecular chain of the polymer (a) obtained in the polymerization step are previously cyclized and condensed so as to increase the conversion in cyclization condensation reaction in some degree and where the previous cyclization condensation is followed by the successive cyclization condensation simultaneously combined with a degassing step, the polymer obtained in the previous cyclization condensation step (in the polymer, the hydroxyl group and the ester group existing in the molecular chain are at least partly cyclized and condensed) and a solvent may be introduced into the subsequent process of cyclization condensation simultaneously combined with a degassing step directly as such; or if desired, the polymer (in the polymer, the hydroxyl group and the ester group existing in the molecular chain are at least partly cyclized and condensed) may be isolated and a solvent may be newly added thereto or the polymer may be processed for any other treatment, and thereafter it may be introduced into the subsequent cyclization condensation step simultaneously combined with a degassing step.

The degassing step is not always completed simultaneously with the cyclization condensation, but it may be completed after a while from the end of the cyclization condensation.

The lactone ring-containing polymer has a weight-average molecular weight of preferably from 1,000 to 2,000,000, more preferably from 5,000 to 1,000,000, even more preferably from 10,000 to 500,000, still more preferably from 50,000 to 500,000.

Preferably, the mass reduction ratio of the lactone ring-containing polymer, as measured within a range of from 150 to 300° C. through dynamic TG analysis, is at most 1%, more preferably at most 0.5%, even more preferably at most 0.3%.

As having a high conversion in cyclization condensation, the lactone ring-containing polymer is free from the drawbacks of bubbles or silver streaks to be in the shaped articles thereof. Further, owing to the high conversion in cyclization condensation thereof, the lactone ring structure may be sufficiently introduced into the polymer, and therefore, the obtained lactone ring-containing polymer may have sufficiently high heat resistance.

Preferably, the degree of coloration (YI) of the lactone ring-containing polymer, as measured in a 15 mas. % chloroform solution, is at most 6, more preferably at most 3, even more preferably at most 2, most preferably at most 1. When the degree of coloration (YI) is not higher than 6, then the polymer may be prevented from coloring and may have high transparency.

Preferably, the temperature for 5% mass reduction in thermal mass analysis (TG) of the lactone ring-containing polymer is not lower than 280° C., more preferably not lower than 290° C., even more preferably not lower than 300° C. The temperature for 5% mass reduction in thermal mass analysis (TG) is an index of thermal stability. When the temperature is not lower than 280° C., then the polymer may exhibit sufficient thermal stability.

Preferably, the lactone ring-containing polymer has a glass transition temperature (Tg) of not lower than 115° C., more preferably not lower than 125° C., even more preferably not lower than 130° C., still more preferably not lower than 135° C., most preferably not lower than 140° C.

Preferably, the total amount of the volatile residues in the lactone ring-containing polymer is at most 5000 ppm, more preferably at most 2000 ppm. When the total amount of the volatile residues is at most 5000 ppm, then the polymer may be effectively prevented from having shaping failures of coloration, bubbles or silver streaks to be caused by the deterioration of the polymer in shaping it.

Preferably, the whole light transmittance of the injection-molded article of the lactone ring-containing polymer, as measured according to the method of ASTM-D-1003, is at least 85%, more preferably at least 88%, even more preferably at least 90%. The whole light transmittance is an index of transparency. Polymer having glutaric anhydride unit (hereinafter this is referred to as “glutaric anhydride unit-containing polymer”):

The glutaric anhydride unit-containing polymer usable in the second invention is preferably a polymer having a unit of the following formula (3):

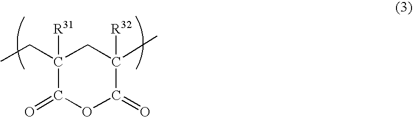

In formula (3), R³¹ and R³² each independently represent a hydrogen atom or an organic residue having from 1 to 20 carbon atoms. The organic residue may contain an oxygen atom. Especially preferably, R³¹ and R³² are the same or different, and each represents a hydrogen atom or an alkyl group having from 1 to 5 carbon atoms.

The glutaric anhydride unit-containing polymer for use in the second invention may contain any other unit than the glutaric anhydride unit. For example, it is preferably an acrylic copolymer containing an acrylic unit (unit derived from alkyl esters of unsaturated carboxylic acids or unsaturated carboxylic acids). The content of the glutaric anhydride unit in the acrylic copolymer is preferably from 5 to 50% by mass, more preferably from 10 to 45% by mass. When the content is at least 5% by mass, more preferably at least 10% by mass, then the polymer may have improved heat resistance and may have improved weather resistance. Preferably, the glutaric anhydride unit-containing polymer has a glass transition temperature (Tg) of not lower than 120° C., from the viewpoint of the heat resistance thereof.

Preferably, the glutaric anhydride unit-containing polymer contains, for example, a repetitive unit based on an alkyl ester of an unsaturated carboxylic acid. Preferably, the repetitive unit based on an alkyl ester of an unsaturated carboxylic acid is, for example, represented by the following formula (4):

—[CH₂—C(R⁴¹)(COOR⁴²)]—. (4)

In formula (4), R⁴¹ represents a hydrogen atom or an alkyl group having from 1 to 5 carbon atoms; R⁴² represents an aliphatic or alicyclic hydrocarbon group having from 1 to 6 carbon atoms, or an aliphatic or alicyclic hydrocarbon group having from 1 to 6 carbon atoms and substituted with from 1 to the number of the carbon atoms constituting it of a hydroxyl group or a halogen.

The monomer corresponding to the repetitive unit of formula (4) is represented by the following formula (5):

CH₂═C(R⁴¹)(COOR⁴²) (5)

Preferred examples of the monomer of the type include methyl (meth)acrylate, ethyl (meth)acrylate, n-propyl (meth)acrylate, n-butyl (meth)acrylate, t-butyl (meth)acrylate, n-hexyl (meth)acrylate, cyclohexyl (meth)acrylate, chloromethyl (meth)acrylate, 2-chloroethyl (meth)acrylate, 2-hydroxyethyl (meth)acrylate, 3-hydroxypropyl (meth)acrylate, 2,3,4,5,6-pentahydroxyhexyl (meth)acrylate, and 2,3,4,5-tetrahydroxypentyl (meth)acrylate. Of those, most preferred is methyl methacrylate. One or more of these maybe used either singly or as combined.

The content of the alkyl unsaturated carboxylate unit in the glutaric anhydride unit-containing polymer is preferably from 50 to 95% by mass, more preferably from 55 to 90% by mass. The acrylic thermoplastic copolymer containing a glutaric anhydride unit and an alkyl unsaturated carboxylate unit may be obtained, for example, by polymerization and cyclization of a copolymer having an alkyl unsaturated carboxylate unit and an unsaturated carboxylic acid unit.

The glutaric anhydride unit-containing polymer may contain an unsaturated carboxylic acid unit along with the above-mentioned alkyl unsaturated carboxylate unit or in place of it.

The unsaturated carboxylic acid unit is, for example, preferably one represented by the following formula (6):

—[CH₂—C(R⁵¹)(COOH)]— (6)

In this, R⁵¹ represents a hydrogen atom or an alkyl group having from 1 to 5 carbon atoms.

Preferred examples of the monomer that gives the above-mentioned unsaturated carboxylic acid unit include monomers corresponding to the repetitive unit of formula (6), or that is, compounds of the following formula (7), as well as maleic acid and hydrolyzate of maleic anhydride. Preferred are acrylic acid and methacrylic acid as the copolymers have excellent thermal stability; and more preferred is methacrylic acid.

CH₂═C(R⁵¹)(COOH) (7)

One or more of these may be used either singly or as combined. As described in the above, the acrylic thermoplastic copolymer having a glutaric anhydride unit and an alkyl unsaturated carboxylate unit may be obtained, for example, by polymerization and cyclization of a copolymer having an alkyl unsaturated carboxylate unit and an unsaturated carboxylic acid unit, and therefore, it may have an unsaturated carboxylic acid unit remaining in the constitutive unit thereof.

The content of the unsaturated carboxylic acid unit in the glutaric anhydride unit-containing polymer is preferably at most 10% by mass, more preferably at most 5% by mass. When the content is at most 10% by mass, the colorless transparency and the residence stability of the polymer may be prevented from worsening.

The glutaric anhydride unit-containing polymer may contain any other aromatic ring-free vinyl monomer unit not interfering with the effect of the invention. It may contain any other aromatic ring-free, vinylic polymerizing monomer-derived unit. In terms of the corresponding monomers thereof, specific examples of the other vinylic polymerizing monomer include vinyl cyanide monomers such as acrylonitrile, methacrylonitrile, ethacrylonitrile; allyl glycidyl ether; maleic anhydride, itaconic anhydride; N-methylmaleimide, N-ethylmaleimide, N-cyclohexylmaleimide, acrylamide, methacrylamide, N-methylacrylamide, butoxymethylacrylamide, N-propylmethacrylamide; aminomethyl acrylate, propylaminoethyl acrylate, dimethylaminoethyl methacrylate, ethylaminopropyl methacrylate, cyclohexylaminoethyl methacrylate; N-vinyldiethylamine, N-acetylvinylamine, allylamine, methallylamine, N-methylallylamine; 2-isopropenyl-oxazoline, 2-vinyl-oxazoline, 2-acryloyl-oxazoline. One or more of these may be used either singly or as combined.

In the glutaric anhydride unit-containing polymer, preferably, the content of the unit derived from the other vinylic polymerizing monomer (not having an aromatic ring) is at most 35% by mass.

The glutaric anhydride unit-containing polymer may contain a unit derived from an aromatic ring-containing vinylic polymerizing monomer, for example, N-phenylmaleimide, phenylaminoethyl methacrylate, p-glycidylstyrene, p-aminostyrene, 2-styryl-oxazoline; but since the unit may lower the scratch resistance and the weather resistance of the polymer, the content of the unit, if any, is preferably up to at most 1% by mass.

In the second invention, the film used as the transparent support may contain, if desired, any other material in addition to containing the above-mentioned lactone ring unit-containing polymer or glutaric anhydride unit-containing polymer as the main ingredient thereof.

### Other Thermoplastic Resin:

The film usable as the support in the second invention may contain one or more other thermoplastic resins than the above-mentioned lactone ring unit-containing polymer or glutaric anhydride unit-containing polymer. Examples of the other thermoplastic resins include olefinic polymers such as polyethylene, polypropylene, ethylene-propylene copolymer, poly(4-methyl-1-pentene); halogen-containing polymers such as vinyl chloride, vinyl chloride resin; acrylic polymers such as polymethyl methacrylate; styrenic polymers such as polystyrene, styrene-methyl methacrylate copolymer, styrene-acrylonitrile copolymer, acrylonitrile-butadiene-styrene block copolymer; polyesters such as polyethylene terephthalate, polybutylene terephthalate, polyethylene naphthalate; polyamides such as nylon 6, nylon 66, nylon 610; polyacetal; polycarbonate; polyphenylene oxide; polyphenylene sulfide; polyether ether ketone; polysulfone; polyether sulfone; polyoxybenzylene; polyamidimide; rubber polymers such as polybutadiene rubber, acrylic rubber-incorporated ABS resin, ASA resin. The rubber polymer preferably has, in its surface, a graft segment of a composition miscible with the above-mentioned lactone ring unit-containing polymer and others; and the mean particle size of the rubber polymer is preferably at most 100 nm, more preferably at most 70 nm from the viewpoint of improving the transparency of the films formed of the polymer.

As the thermoplastic resin thermodynamically miscible with the lactone ring unit-containing polymer, preferred is a copolymer containing a vinyl cyanide monomer unit and an aromatic vinyl monomer unit, concretely a polymer that contains an acrylonitrile-styrene copolymer, a polyvinyl chloride resin or an methacrylate in an amount of at least 50% by mass. Of those, when an acrylonitrile-styrene copolymer is used, then it is easy to obtain an optical film having a glass transition temperature of not lower than 120° C., Re of not more than 20 nm and a whole light transmittance of not lower than 85%. The thermodynamic miscibility of the lactone ring unit-containing polymer and the like with the other thermoplastic resin may be confirmed by mixing them and measuring the glass transition point of the resulting thermoplastic resin composition. Concretely, when the mixture of the lactone ring unit-containing polymer or the like and the other thermoplastic resin is analyzed with a differential scanning calorimeter and when the mixture gives only one glass transition point in the analysis, then it may be said that the two are thermodynamically miscible with each other.

When an acrylonitrile-styrene copolymer is used as the other thermoplastic resin, it may be produced according to an emulsion polymerization method, a suspension polymerization method, a solution polymerization method or a bulk polymerization method. However, from the viewpoint of the transparency and the optical properties of the obtained films, the copolymer is preferably prepared according to a solution polymerization method or a bulk polymerization method.

When the other thermoplastic resin is added to the lactone ring unit-containing polymer or the like, the ratio by mass of the lactone ring unit-containing polymer or the like (component (A)) relative to the other thermoplastic resin (component (B)), [(A)/{(A)+(B)}] is preferably from 60 to 99% by mass, more preferably from 70 to 97% by mass, even more preferably from 80 to 95% by mass. When the proportion of the component (A) in the support is smaller than 60% by mass, then the degree of extinction of the support could not be fully lowered. Combined with the component (B), the retardation of the film may be controlled.

### Retardation Enhancer:

The film for use as the transparent support in the second invention may contain a retardation enhancer along with the above-mentioned lactone ring unit-containing polymer or the like. “Retardation enhancer” means an agent having the property of such that, as compared with a sample not containing it, the sample containing it may have an increased absolute value of at least either of the in-plane retardation (Re) or the thickness-direction retardation (Rth). Preferably, the retardation enhancer is selected from compounds having at least two aromatic rings in one molecule. In the molecule of a compound having at least 2 aromatic rings in one molecule, the two aromatic rings generally form one and the same plane not interfering with the conformation of the two aromatic ring. According to the studies of the present inventors, it is important that the plural aromatic rings of the compound form one and the same plane in order that the compound could increase the retardation of the film that comprises a lactone ring unit or glutaric anhydride unit-containing polymer. Examples of the retardation enhancer of the type include rod-like compounds having a linear molecular structure substantially the same as that of the compounds described in JPA 2002-363343, paragraphs [0011] to [0031]; compounds having two aromatic rings in conformation with no steric hindrance, substantially the same as that of the compounds described in JPA 2000-111914, paragraphs [0011] to [0085]; 1,3,5-triazine compounds having at least one aromatic ring as the substituent; and porphyrin skeleton-having compounds described in JPA 2001-166144.

In particular, preferred are 1,3,5-triazine compounds having at least one aromatic group as the substituent. In this, the triazine ring is at least another one aromatic ring.

Concretely, the 1,3,5-triazine compounds of a formula (1) described in JPA 2001-166144, paragraph [0016] are preferred as the retardation enhancer.

Selecting the type and the amount of the compound used for the retardation enhancer makes it possible to produce a film having a desired retardation. The amount of the retardation enhancer to be in the film is preferably from 0 to 20% by mass (relative to the film), more preferably from 0 to 10% by mass (relative to the film).

### Other Additives:

The polymer film to be used as the support in the second invention may contain at least one selected from various additives.

Examples of the additives include hindered bisphenol-type, phosphorus-containing or sulfur-containing antioxidants; stabilizers such as light stabilizer, weather stabilizer, heat stabilizer; reinforcing materials such as glass fibers, carbon fibers; UV absorbents such as phenyl salicylate, (2,2′-hydroxy-5-methylphenyl)benzotriazole, 2-hydroxybenzophenone; near-IR absorbents; flame retardants such as tris(dibromopropyl) phosphate, triallyl phosphate, antimony oxide; antistatic agents such as anionic, cationic or nonionic surfactants; colorants such as inorganic pigments, organic pigments, dyes; organic fillers and inorganic fillers; resin modifiers; organic fillers and inorganic fillers; plasticizers; lubricants; antistatic agents; and flame retardants.

The content of the other additives in the polymer film is preferably from 0 to 5% by mass, more preferably from 0 to 2% by mass, even more preferably from 0 to 0.5% by mass.

### Production Method for Polymer Film:

In the second invention, the production method for the polymer film for use as the support is not specifically defined. For example, the above-mentioned lactone ring unit-containing polymer and the like, and optionally a retardation enhancer and other thermoplastic resin may be mixed in a known mixing method, and then the obtained polymer composition may be shaped into films. After thus formed, the films may be stretched to be stretched films.

For shaping the films, various film-shaping methods may be employed. For example, they include a solution casting method a melt extrusion method, a calendering method, a compression molding method, etc. Of those film-shaping methods, especially preferred are a solution casting method and a melt extrusion method.

The solvent to be used in the solution casting method includes, for example, chlorine-containing solvents such as chloroform, dichloromethane; aromatic solvents such as toluene, xylene, benzene; alcohol solvents such as methanol, ethanol, isopropanol, n-butanol, 2-butanol; and methyl cellosolve, ethyl cellosolve, butyl cellosolve, dimethylformamide, dimethyl sulfoxide, dioxane, cyclohexane, tetrahydrofuran, acetone, methyl ethyl ketone, ethyl acetate, diethyl ether. One or more these solvents may be used either singly or as combined.

The apparatus for the solution casting method includes, for example, a drum casting machine, a band casting machine, a spin coater.

The melt extrusion method includes a T-die method and an inflation method, in which the film-forming temperature is preferably from 150 to 350° C., more preferably from 200 to 300° C.

For stretching, various conventional stretching methods may be employed, for example, including monoaxial stretching, successive biaxial stretching, simultaneous biaxial stretching. Preferably, the stretching is effected at around the glass transition temperature of the polymer used as the film material. Concretely, the stretching temperature is preferably from (glass transition temperature−30° C.) to (glass transition temperature+100° C.), more preferably from (glass transition temperature−20° C.) to (glass transition temperature+80° C.). When the stretching temperature is not lower than the (glass transition temperature−30° C.), then the film maybe stretched at a sufficient draw ratio; and when the stretching temperature is not higher than the (glass transition temperature+100° C.), then the resin may well flow enough for stable stretching. The draw ratio in stretching by area is preferably from 1.1 to 25 times, more preferably from 1.3 to 10 times. When the draw ratio is at least 1.1 times, then the toughness of the stretched film may be increased; and on the contrary, when the draw ratio is at most 25 times, then the effect of stretching may increase in accordance with the increased draw ratio.

The stretching rate (in one direction) is preferably from 10 to 20,000%/min, more preferably from 100 to 10,000%/min. When the stretching rate is at least 10%/min, then the time for obtaining the sufficient draw ratio may be shortened and the production cost may be thereby reduced. On the contrary, when the stretching rate is at most 20,000%/min, then the film being stretched is prevented from being cut. For stabilizing the optical isotropy and the mechanical properties thereof, the stretched film may be annealed.

The thickness of the polymer film for use as the support in the second invention is preferably from 10 μm to 500 μm, more preferably from 20 μm to 300 μm. When the thickness is less than 10 μm, then it is difficult to produce uniform films; but when the thickness is more than 500 μm, then the surface film of display may be too thick and this is contrary to the current stream toward thinned and weight-reduced devices in the art.

The optical properties of the polymer film are not specifically defined. Depending on the modes of the liquid-crystal display devices in which the optical compensation film of the second invention is used, and in relation to the optical properties of the optically-anisotropic layer to be combined with the film, the preferred range of the in-plane retardation Re and that of the thickness-direction retardation Rth may be determined; and if desired, the above-mentioned retardation enhancer and other thermoplastic resin may be added to the film, thereby controlling the values to fall with the desired range.

For example, when the above mentioned 1,3,5-triazine compound is used as a retardation enhancer and when it is mixed with the above-mentioned lactone ring unit-containing polymer, then a polymer film may be produced having Re of from 0 to 200 nm or so and Rth of from 0 to 500 nm or so.

The polymer film is preferably processed for surface treatment for the purpose of improving the adhesiveness thereof to the layer to be formed adjacent to it (for example, optically-anisotropic layer, or alignment film to be used for forming it). The surface treatment is preferably corona discharge treatment or atmospheric plasma treatment. Corona discharge treatment may be within the range of atmospheric plasma treatment as the generic concept thereof. In this, however, a treatment of directly exposing a subject to a plasma region by direct corona discharging is referred to as corona discharge treatment; and a treatment of processing a subject with its surface kept away from a plasma region is referred to as atmospheric plasma treatment. Corona treatment has an advantage in that it has many industrial applications and is inexpensive, but on the contrary, its disadvantage is that the processed surface takes great physical damage. On the other hand, atmospheric plasma treatment has a relatively small number of industrial applications and is more expensive than corona treatment, but on the contrary, its advantage is that the processed surface takes little damage and the processing intensity may be relatively high. Accordingly, in consideration of the relationship between the damage to be given to the processed film and the improvement level of the adhesiveness of the processed film, a preferred one of the two surface-treatment methods may be selected.

The processed surface of the thus-processed polymer film is hydrophilicated. The level of hydrophilication may be determined based on the contact angle with water of the processed surface. Concretely, the contact angle with water of the processed surface is preferably at most 55°, more preferably at most 50°. When the contact angle with water of the processed surface falls within the above range, then the adhesiveness of the film to the alignment film adjacent thereto is enhanced and the film hardly has lamination failure such as delamination. The lowermost limit of the angle is not specifically defined, but is preferably so determined that the surface treatment does not give damage to the polymer film. The contact angle may be determined according to JIS R 3257 (1999). The condition of the corona discharge treatment and the atmospheric plasma treatment is so controlled that the contact angle of the surface processed by the treatment could fall within the above range. Examples of the variable condition in both methods include the voltage to be applied, the frequency, the type of the atmospheric vapor, and the treatment time.

The details of the treatment are described in Polymer Surface Modification (by Kindai Henshu-sha), p. 88 ff.; Basis and Application of Polymer Surface (last volume) (by Kagaku Dojin), p. 31 ff.; Principal/Characteristics of Atmospheric Plasma, and Surface Modification Technology for Polymer Films/Glass Substrates (by Technical Information Association), and the contents of these publications are referred to herein.

Preferably, the surface of the polymer film that has been processed for corona discharge treatment or atmospheric plasma treatment (hereinafter this may be referred to as “processed surface”) is purified for dust removal and then an alignment film is formed thereon. The purification method for dust removal is not specifically defined. Preferred is ultrasonic dust removal of using ultrasonic waves. The ultrasonic dust removal is described in detail in JPA No. hei 7-333613, and the description may be referred to herein.

The coating solvent in the coating composition for the layer to be formed adjacent to the polymer film may swell the polymer film in some degree, whereby the adhesiveness between the two layers may be thereby enhanced. Concretely, the coating composition is so controlled that the solvent therein is a mixed solvent comprising a solvent capable of swelling the polymer film and a solvent not swelling it in a predetermined ratio, whereby the adhesiveness of the coating layer may be favorably enhanced with no layer whitening.

### 2.-1-2 Optically Anisotropic Layer

The optical compensation film of the second present invention comprises at least one optically anisotropic layer. The liquid crystal composition to be used may be curable. The liquid crystal composition may contain at least one liquid crystal compound selected from rod-like or discotic liquid crystal compounds.

Examples of rod-like liquid crystal compound include azomethines, azoxys, cyanobiphenyls, cyanophenyl esters, benzoate esters, cyclohexane carboxylic acid phenyl esters, cyanophenyl cyclohexanes, cyano-substituted phenyl pyrimidines, alkoxy-substituted phenyl pyrimidines, phenyl dioxanes, tolans and alkenyl cyclohexyl benzonitriles.

For immobilizing rod-like molecules, polymerization or curing reaction of polymerizable groups introduced in the terminal portion of molecules may be employed. More specifically, JPA No. 2006-209073 discloses examples of immobilizing polymerizable nematic rod-like liquid crystal compounds with UV light. And it is also possible to use, as a rod-like liquid crystalline compound, liquid crystalline polymers comprising a repeating unit having a residue of a rod-like liquid crystalline compound. The optical compensation film produced by using liquid crystal polymer is disclosed in JPA No. hei 5-53016.

Examples of discotic liquid-crystalline compounds include benzene derivatives described in “Mol. Cryst.”, vol. 71, page 111 (1981), C. Destrade et al; truxane derivatives described in “Mol. Cryst.”, vol. 122, page 141 (1985), C. Destrade et al. and “Physics lett. A”, vol. 78, page 82 (1990); cyclohexane derivatives described in “Angew. Chem.”, vol. 96, page 70 (1984), B. Kohne et al.; and macrocycles based aza-crowns or phenyl acetylenes described in “J. Chem. Commun.”, page 1794 (1985), M. Lehn et al. and “J. Am. Chem. Soc.”, vol. 116, page 2,655 (1994), J. Zhang et al. The polymerization of discotic liquid-crystalline compounds is described in JPA No. hei 8-27284.

In order to immobilize discotic liquid crystalline molecules by a polymerization, a polymerizable group has to be bonded as a substituent group to a disk-shaped core of the discotic liquid crystalline molecule. In a preferred compound, the disk-shaped core and the polymerizable group are preferably bonded through a linking group, whereby the aligned state can be maintained in the polymerization reaction. Preferred examples of the discotic liquid crystalline compound having a polymerizable group include the group represented by a formula (A) below.

D(-L-P)ₙ (A)

In the formula, D is a disk-shaped core, L is a divalent liking group, P is a polymerizable group and n is an integer from 4 to 12.

Examples of the disk-shaped core D include, but are not limited to, those shown below. In each of the examples, LP or PL means the combination of the divalent linking group (L) and the polymerizable group (P).

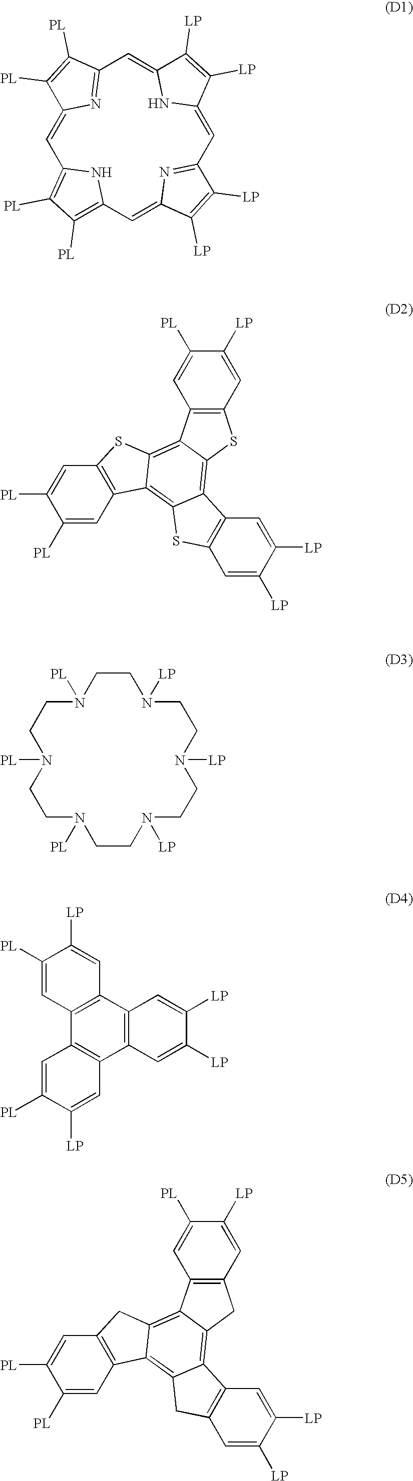

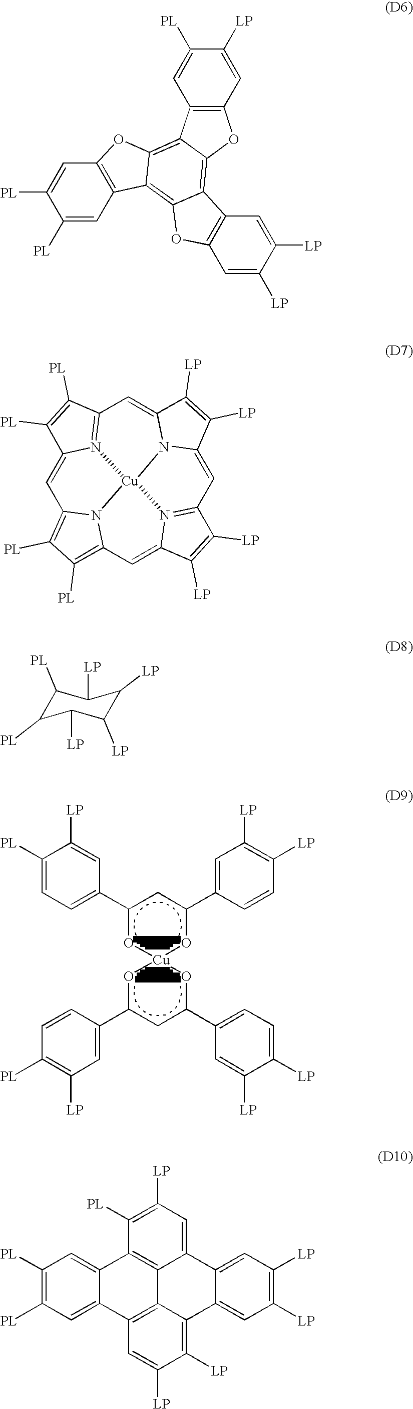

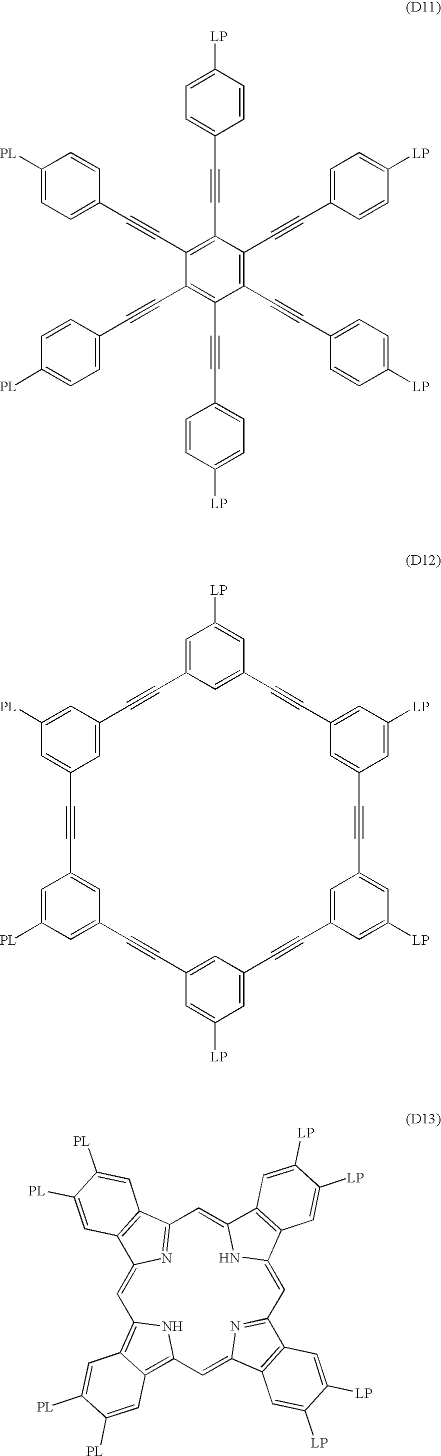

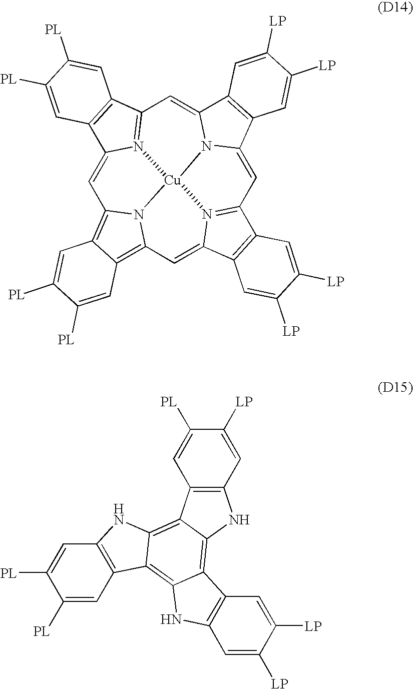

And compounds having a tri-substituted benzene skeleton described in JPA No. 2007-102205 are preferred since their birefringence exhibits a wavelength dependency similar to that of liquid crystal material to be usually used in a liquid crystal cell. Among those, the benzene skeleton shown below is preferred.

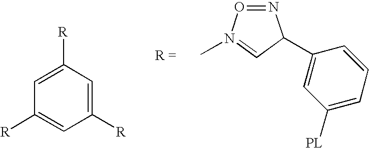

In the formula, preferably, the bivalent linking group L represents a bivalent linking group selected from the group consisting of alkylenes, alkenylenes, arylenes, —CO—, —NH—, —O—, —S— and any combinations thereof. More preferably, the bivalent linking group L represents a bivalent linking group selected from the group consisting of any combinations of two or more selected from alkylenes, arylenes, —CO—, —NH—, —O— and —S—. Even more preferably, the bivalent linking group (L) represents a bivalent linking group selected from the group consisting of any combinations of two or more selected from alkylenes, arylenes, —CO— and —O—. The carbon number of the alkylene may be from 1 to 12, the carbon number of the alkenylene may be from 1 to 12; and the carbon number of the arylene may be from 6 to 10.

Examples of the bivalent group (L) include those shown below. In the formulas, the left terminal portion binds to the discotic core (D) and the right terminal side binds to the polymerizable group (P). in the formulas, “AL” represents an alkylene or an alkenylene; and “AR” represents an arylene. The alkylene, alkenylene or arylene may have at least one substituent such as an alkyl group.

-AL-CO—O-AL- (L1)

-AL-CO—O-AL-O- (L2)

-AL-CO—O-AL-O-AL- (L3)

-AL-CO—O-AL-O—CO— (L4)

—CO-AR-O-AL- (L5)

—CO-AR-O-AL-O- (L6)

—CO-AR-O-AL-O—CO— (L7)

—CO—NH-AL- (L8)

—NH-AL-O- (L9)

—NH-AL-O—CO— (L10)

—O-AL- (L11)

—O-AL-O- (L12)

—O-AL-O—CO— (L13)

—O-AL-O—CO—NH-AL- (L14)

—O-AL-S-AL- (L15)

—O—CO-AR-O-AL-CO— (L16)

—O—CO-AR-O-AL-O—CO— (L17)

—O—CO-AR-O-AL-O-AL-O—CO— (L18)

—O—CO-AR-O-AL-O-AL-O-AL-O—CO— (L19)

—S-AL- (L20)

—S-AL-O- (L21)

—S-AL-O—CO— (L22)

—S-AL-S-AL- (L23)

—S-AR-AL- (L24)

In the formula (A), the polymerizable group (P) may be selected depending on the types of polymerization to be employed. Examples of the polymerizable group (P) include those shown below.

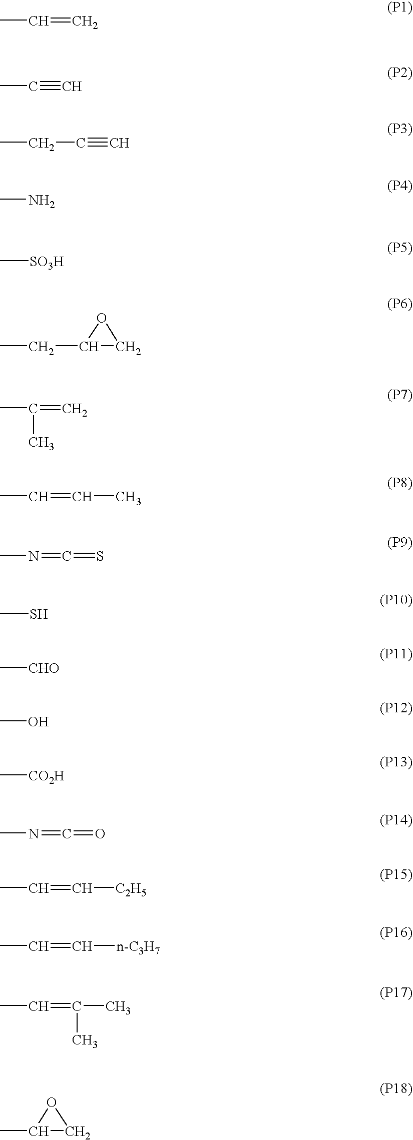

Preferably, the polymerizable group (P) is selected from unsaturated polymerizable groups, P1, P2, P3, P7, P8, P15, P16 and P17, or epoxy groups, P6 and P18. More preferably the polymerizable group is selected from the unsaturated polymerizable groups, and even more preferably it is selected from ethylenic unsaturated polymerizable groups, P1, P7, P8, P15, P16 and P17.

In the formula, n is an integer from 4 to 12, and n may be decided depending on types of discotic core (D) to be employed. In the formula, the plurality of the combination of L and P may be same or different from each other, and preferably the plurality of the combination is same.

The amount of the liquid crystal compound in the composition is preferably from 50 to 99.9 mass %, more preferably from 70 to 99.9 mass % and even more preferably from 80 to 99.5 mass % with respect to the total mass of the composition.

The liquid crystal composition may comprise at least one additive such as plasticizers, surfactants, polymerizable monomers along with the liquid crystal compound. Such additives may be employed for various purposes such as homogenizing the coating film, strengthening the film and improving orientation of liquid crystal molecules. Preferably, the additive to be employed is compatible with the liquid crystal compound and doesn't inhibit the orientation of liquid crystal molecules.

Examples of the polymerizable monomer to be used include radical-polymerizable or cation-polymerizable compounds. Polyfunctional radical-polymerizable monomers are preferred, and among those, the compounds which can co-polymerize with the liquid crystal compound having a polymerizable group(s). Examples of such a compound include those described in the paragraphs [0018] to [0020] of JPA No. 2002-296423. the amount of the compound is preferably from 1 to 50 mass % and more preferably from 5 to 30 mass % with respect to the amount of the liquid crystal compound.

The polymer to be used along with the liquid crystal compound may be selected from the polymers capable of increasing viscosity of coating liquid. Examples of such polymer include cellulose esters. Preferred examples of cellulose ester include those in the paragraph [0178] of JPA No. 2000-155216. Avoiding inhibition of orientation of liquid crystal molecules, preferably, the amount of the polymer is from 0.1 to 10 mass % and more preferably from 0.1 to 8 mass % with respect to the amount of the liquid crystal compound.

Various types of surfactants may be used in the invention, fluorosurfactants are preferred. More specifically, the compounds described in the paragraphs [0028] to [0056] of JAP No. 2001-330725, compounds described in the paragraphs [0069] to [0126] of JPA No. 2005-062673 may be used. Preferred examples of the surfactant to be used include the polymers having a fluoroaliphatic group(s) described in the paragraphs [0054] to [0109] of JPA No. 2005-292351.

The optically anisotropic layer may be prepared according to a method comprising applying the liquid crystal composition to a surface (for example rubbed surface), aligning liquid crystal molecules in it at a temperature equal to or less than the transition point between the liquid crystal and solid phases, and then irradiating it with UV light for carrying out polymerization of the molecules and for immobilizing them in the alignment state.

The coating method may be any known method of bar-coating, extrusion-coating, direct gravure-coating, reverse gravure-coating or die-coating. The transition point between the liquid crystal and the solid phases maybe from 70 to 300 degree C., or may be from 70 to 170 degree C. the polymerization of liquid crystal compound may be carried out according to a photo-polymerization process. The layer is irradiated with UV light to carry out polymerization reaction, and the irradiation energy is preferably from 20 mJ/cm² to 50 J/cm², more preferably from 100 mJ/cm² to 800 mJ/cm². For promoting the optical polymerization, the light irradiation may be attained tinder heat. Avoiding inhibition of orientation of the liquid crystal molecules, heat may be performed so as to be a temperature equal to or less than 120 degree C.

The thickness of the optically anisotropic layer may be from 0.5 to 100 μm or from 0.5 to 30 μm.

### Haze Value:

In this description, the haze value of the support film and the optical compensation film is determined according to JIS K-7136.

The optical compensation film of the second invention is characterized in that not only the transparent support itself has a small haze value but also the formation of an optically-anisotropic layer on the transparent support does not too much increase the haze value, and therefore the optical compensation film itself has a small haze value. The haze of the transparent support for use in the second invention is from 0 to 0.2 or so; and the optical compensation film of the invention fabricated by forming an optically-anisotropic layer on the support may have a reduced haze value of at most 0.3%. Preferably, the formation of the optically-anisotropic layer on the support increases the haze by at most 0.08%.

### 2.-2 Polarizing Plates:

The second invention also relates to a polarizing plates comprising at least a polarizing film and the optical compensation film of the second invention. One example of the polarizing plate of the second invention comprises a polarizing film and the above-mentioned optical compensation film formed on one surface of the polarizing film as a protective film thereon. When the optical compensation film is used as a protective film, it is desirable that the back side of the polymer film containing a lactone ring unit-containing copolymer or the like and serving as a support (the side not coated with an optically-anisotropic layer) is optionally processed for surface treatment for hydrophilication, and then this side of the film is stuck to the surface of a polarizing film.

### 2.-2-1 Polarizing Film

The polarization film to be used is not limited to any type. The polymerization film may be prepared according to a method comprising dyeing a polyvinyl alcohol film with iodine, and then stretching it.

### 2.-2-2 Protect Film

Preferably, the polarizing film may have a protective film on another surface thereof. Examples of the protective film include cellulose acylate films and cyclic polyolefin base films.

### 2.-3 Liquid-Crystal Display Device:

The optical compensation film and the polarizing plate of the second present invention may be used in various types of liquid crystal display devices such as liquid crystal display devices employing TN (Twisted Nematic), IPS (In-Plane Switching), FLC (Ferroelectric Liquid Crystal), OCB (Optically Compensatory Bend), STN (Supper Twisted Nematic), VA (Vertically Aligned) and HAN (Hybrid Aligned Nematic) modes.

While a liquid-crystal display device is driven for a long period of time, the inner temperature thereof may rise owing to the heat of the backlight therein. The liquid-crystal display device for notebook-size personal computers and mobile phones is used not only indoors but also outdoors. Accordingly, these liquid-crystal display devices are required not to suffer from much display characteristic fluctuation depending on the environmental humidity and temperature fluctuation. The liquid-crystal display device comprising the optical compensation film of the second invention, especially the liquid-crystal display device comprising the optical compensation film of the second invention as the protective film for the polarizing film therein is characterized in that the display characteristics thereof fluctuate little depending on the ambient temperature and humidity fluctuation, and therefore, it is useful in various applications. In particular, one characteristic feature of the liquid-crystal display device of the second invention is that the brightness fluctuation depending on the ambient temperature and humidity fluctuation is small. When the brightness in the black state fluctuates (increases) by 1 cd/cm² or more, then the visibility is thereby significantly worsened; however, according to the second invention, the brightness fluctuation in the black state may be suppressed to at most 0.5 cd/cm², and therefore the liquid-crystal display device of the second invention may keep its good display characteristics in any environmental conditions.

### EXAMPLES

The invention is described more concretely with reference to the following Examples, in which the material and the reagent used, their amount and the ratio, the details of the treatment and the treatment process may be suitably modified or changed not overstepping the spirit and the scope of the invention. Accordingly, the invention should not be limited by the Examples mentioned below.

### 1. Examples of the First Invention

### Example 1-1

### Preparation of Ring-Opening Polymerization Cyclic Polyolefin Dope

The following composition was put into a mixing tank and stirred to dissolve the components, and then filtered through a paper filter having a mean pore size of 34 μm and a sintered metal filter having a mean pore size of 10 μm.

Cyclic polyolefin solution A

| | |
|---|---|
| Arton G (by JSR) | 150 mas. pts. |
| Methylene chloride | 550 mas. pts. |
| Ethanol | 50 mas. pts. |

Next, the following composition containing the ring-opening polymerization cyclic polyolefin solution prepared according to the above-mentioned method was put into a disperser to prepare a mat agent dispersion.

Mat agent dispersion

| | |
|---|---|
| Silica particles having a mean particle size | 2 mas. pts. |
| of 16 nm (Aerosil R972 by Nippon Aerosil) | |
| Methylene chloride | 75 mas. pts. |
| Ethanol | 5 mas. pts. |
| Cyclic polyolefin solution A | 10 mas. pts. |

100 parts by mass of the above cyclic polyolefin solution and 1.1 parts by mass of the mat agent dispersion were mixed to prepare a dope for film formation.

### (Preparation of Transparent Support)

Using a band caster, the above-mentioned dope was cast. The film having a residual solvent content of about 22% by mass was peeled away from the band, and using a tenter, this was stretched in the cross section at a draw ratio of 50%. Then, this was changed from tenter transfer to roll transfer, and further dried at 120° C. to 140° C., and wound up. Thus formed, the cyclic polyolefin film had a thickness of 60 μm; and Re(550) thereof at 25° C. and 60% RH was 81 nm and Rth(550) was 60 nm. The film was processed for glow discharge treatment between upper and lower electrodes of brass (argon atmosphere). A high-frequency voltage of 3000 Hz and 4200 V was applied between the upper and lower electrodes for 20 seconds, and a ring-opening polymerization cyclic polyolefin film was thus fabricated. The contact angle with pure water of the film surface was from 36° to 41°. The contact angle was measured with Kyowa Kaimen Kagaku's Contact Angle Meter Model CA-A.

### (Preparation of Alignment Film)

Using a wire bar coater of #14, a coating liquid of the following composition was applied onto the cyclic polyolefin film in an amount of 24 mL/m². This was dried with hot air at 100° C. for 120 seconds. Next, the formed film was rubbed in the direction of 0° (this is the lengthwise direction, or that is, the machine direction of the cyclic polyolefin film).

(Composition of coating liquid for alignment film)

| | | |
|---|---|---|
| Modified polyvinyl alcohol mentioned below | 40 | mas. pts. |
| Water | 728 | mas. pts. |
| Methanol | 228 | mas. pts. |
| Glutaraldehyde (crosslinking agent) | 2 | mas. pts. |
| Citrate (AS3, by Sankyo Chemical) | 0.69 | mas. pts. |

Modified polyvinyl alcohol

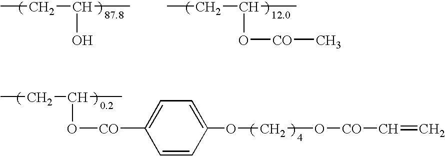

### (Preparation of Optically-Anisotropic Layer)

Using a wire bar of #3.4, a coating liquid for optically-anisotropic layer of the following composition was applied onto the alignment film. Concretely, the wire bar was rotated in the same direction as the machine direction of the film, at 781 rpm, and the roll film was conveyed at 20 m/min, and under the condition, the coating liquid was continuously applied onto the alignment film surface of the roll film. In a process of continuously heating the film from room temperature up to 100° C., the solvent was evaporated away, and then the film was heated in a drying zone at 135° C. for about 120 seconds whereby the discotic liquid-crystal compound was aligned. Next, this was transferred into a drying zone at 100° C., and irradiated with UV rays for 4 seconds at an illuminance of 600 mW from a UV radiation device (UV lamp: output 160 W/cm, light emission length 1.6 m) for crosslinking reaction, and the alignment state of the discotic liquid-crystal compound was thus fixed as such. Next, this was left cooled to room temperature, and wound up as a roll to obtain an optical compensation film roll.

Composition of coating liquid for optically-anisotropic layer

| | | |
|---|---|---|
| Discotic liquid-crystal compound (1) | 41 | mas. pts. |
| mentioned below | | |
| Ethylene oxide-modified trimethylolpropane | 4 | mas. pts. |
| triacrylate | | |
| (V#360, by Osaka Organic Chemical) | | |
| Cellulose acetate butyrate | 0.14 | mas. pts. |
| (CAB551-0.2, by Eastman Chemical) | | |
| Cellulose acetate butyrate | 0.22 | mas. pts. |
| (CAB531-1, by Eastman Chemical) | | |
| Fluoroaliphatic group-containing polymer | 0.45 | mas. pts. |
| (Megafac F780, by Dai-Nippon Ink) | | |
| Photopolymerization initiator | 1.35 | mas. pts. |
| (Irgacure 907, by Ciba-Geigy) | | |
| Sensitizer | 0.45 | mas. pts. |
| (Kayacure DETX, by Nippon Kayaku) | | |
| Methyl ethyl ketone | 200 | mas. pts. |

Discotic liquid-crystal compound (1)

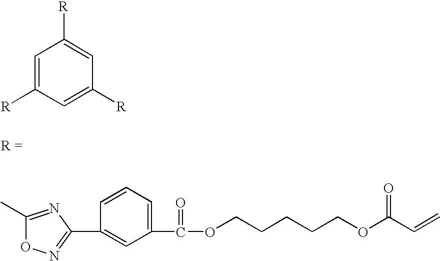

### (Determination of Optical Properties)

Thus formed, the optically-anisotropic layer was analyzed with KOBRA 21ADH for the retardation at a wavelength of 450 nm, 550 nm and 650 nm; and its Re(550) was 29 nm, and Re(450)/Re(650) was 1.15.

The retardation of the optical compensation film, a laminate of the optically-anisotropic layer and the transparent support was measured in a standard environment at 25° C. and 60% RH, and also in a low-humidity condition (25° C., 10% RH) and in a high-humidity condition (25° C., 80% RH). The absolute value of the difference between Rth in the standard environment and that in the low-humidity condition, ΔRth (low humidity) was 0.2 nm; and the absolute value of the difference between Rth in the standard environment and that in the high-humidity condition, ΔRth (high humidity) was 0.2 nm.

### (Fabrication of Polarizing Plate)

A polyvinyl alcohol (PVA) film having a thickness of 80 μm was dipped and dyed in an aqueous iodine solution having an iodine concentration of 0.05% by mass, at 30° C. for 60 seconds, and then dipped in an aqueous boric acid solution having a boric acid concentration of 4% by mass, for 60 seconds, and while dipped therein, this was stretched 5-fold in the machine direction. Next, this was dried at 50° C. for 4 minutes, and a polarizing film having a thickness of 20 μm was thus obtained.

The optical film was dipped in an aqueous sodium hydroxide solution of 1.5 mol/L at 55° C., and then sodium hydroxide was well washed away with water. Next, this was dipped in an aqueous diluted sulfuric acid solution of 0.005 mol/L at 35° C. for 1 minute, and then dipped in water to fully wash away the aqueous diluted sulfuric acid solution. Finally, the sample was fully dried at 120° C.

The optical film thus saponified in the manner as above was combined with a commercial-available cellulose acetate film saponified in the same manner, and these were stuck with the above-mentioned polarizing film sandwiched therebetween, using a polyvinyl alcohol adhesive to give a polarizing plate. The commercially-available cellulose acetate film was Fujitac TF80UL (by FUJIFILM). In this, the polarizing film and the protective film on both sides of the polarizing film were formed each as a roll, and therefore the machine direction of the individual roll films was in parallel to each other and the films were continuously stuck. Accordingly, the machine direction of the optical compensatory roll film (the casting direction of the film) was in parallel to the absorption axis of the polarizing element.

### (Construction and Evaluation of TN-Mode Liquid-Crystal Display Device)

A pair of polarizing plates originally in a liquid-crystal display device (AL2216W, by Nippon Acer) with a TN-mode liquid-crystal cell therein were peeled off, and in place of them, the polarizing plates fabricated in the above were incorporated into it. Briefly, on the viewers' side and on the backlight side of the device, each one polarizing plate was stuck via an adhesive in such a manner that the optical compensation film could face the liquid-crystal cell. In this, the two polarizing plates were so disposed that the transmission axis of the polarizing plate on the viewers' side could be perpendicular to the transmission axis of the polarizing plate on the backlight side.

Next, the brightness in the black state and in the white state (brightness in the normal direction) were measured at the center of the panel both in the same manner, and the contrast in the normal direction was calculated from the data.

Using a spectral brightness meter (TOPCON's SR-3), the color shift in the black state was determined. The evaluation results are shown in the following Table 1-1. In this, the color shift in the normal direction, in the tables referred to as “front color shift” is as follows: “A” means 0.4<v′; “B” means 0.35<v′<0.4; “C” means v′ 0.35. The color shift in the vertical direction, in the tables referred to as “vertical color shift”, and the color shift in the horizontal direction, referred to as “horizontal color shift”, are as follows: “A” means Δu′v′ (maximum color shift from the normal direction)<0.05; “B” means 0.05<Δu′v′<0.1; and “C” means 0.1<Δu′v′.

Using a contrast meter (EZ-CONTRAST), the contrast viewing angle (contrast viewing angle in the vertical direction, in the tables referred to as “vertical contrast viewing angle”, contrast viewing angle in the horizontal direction, in the tables referred to as “horizontal contrast viewing angle”) was measured. In this, the contrast viewing angle means an angle at which the ratio of the brightness in the white state to the brightness in the black state is at least 10.

The display environment humidity was changed from 10% RH to 80% RH at 25° C., and in those conditions, the fabricated liquid-crystal display device was analyzed and evaluated for the contrast viewing angle and the color shift thereof. The evaluation results are shown in Table 1-1. In this, the contrast viewing angle is as follows: “A” means that the contrast change at an angle at which the sample showed contrast 10 is less than 20%; “B” means that the contrast change is from 20 to 50%; “C” means that the contrast change is more than 50%. The color viewing angle is as follows: “A” means that the Δu′v′ change in the maximum color shift direction in the normal direction is less than 30%; “B” means that the change is from 30 to 60%; and “C” means that the change is more than 60%.

The results are shown in Table 1-1.

### Example 1-2

### Preparation of Transparent Support

Using a machine-direction monoaxial stretcher, “Zeonoa ZF-14” (by Nippon Zeon, thickness 100 μm) was stretched in the machine direction at a draw ratio of 15%, at an air supply temperature of 140° C. and a film surface temperature of 130° C. Next, using a tenter stretcher, this was stretched in the cross direction at a draw ratio of 35%, at an air supply temperature of 140° C. and a film surface temperature of 130° C., and this was wound up into a roll film. Thus, a biaxially-stretched film was produced. Thus obtained, the film had a thickness of 65 μl, and its Re(550) was 50 nm and its Rth(550) was 60 nm.

Then, the surface of the film was processed for glow discharge treatment in the same manner as in Example 1-1, an alignment film and an optically-anisotropic layer were formed in the same manner as in Example 1-1, and an optical compensation film was thus fabricated.

### (Determination of Optical Properties)

Thus formed, the optically-anisotropic layer was analyzed with KOBRA 21ADH for the retardation at a wavelength of 450 nm, 550 nm and 650 nm; and its Re(550) was 30 nm, and Re(450)/Re(650) was 1.15.

The retardation of the optical compensation film, a laminate of the optically-anisotropic layer and the transparent support was measured in a standard environment at 25° C. and 60% RH, and also in a low-humidity condition (25° C., 10% RH) and in a high-humidity condition (25° C., 80% RH). The absolute value of the difference between Rth in the standard environment and that in the low-humidity condition, ΔRth (low humidity) was 0.1 nm; and the absolute value of the difference between Rth in the standard environment and that in the high-humidity condition, ΔRth (high humidity) was 0.3 nm.

Also in the same manner as in Example 1-1, a polarizing plate was fabricated, and the polarizing plate was incorporated into a TN-mode liquid-crystal display device and evaluated in the same manner as in Example 1-1.

### Example 1-3

### Preparation of Transparent Support

The dope for formation of cyclic polyolefin prepared in Example 1-1 was cast on a band caster. The film having a residual solvent content of about 22% by mass was peeled away from the band, and using a tenter, this was stretched in the cross section at a draw ratio of 20%. Then, this was changed from tenter transfer to roll transfer, stretched in the machine direction by 25% at 120° C. to 140° C., dried and wound up. Thus formed, the cyclic polyolefin film had a thickness of 60 μm; and Re(550) thereof at 25° C. and 60% RH was 3 nm and Rth(550) was 92 nm.

The film was processed for glow discharge treatment and an alignment film was formed thereon, in the same manner as in Example 1-1.

### (Preparation of Optically-Anisotropic Layer)

Using a wire bar of #3.0, a coating liquid for optically-anisotropic layer of the following composition was applied onto the alignment film. Concretely, the wire bar was rotated in the same direction as the machine direction of the film, at 781 rpm, and the roll film was conveyed at 20 m/min, and under the condition, the coating liquid was continuously applied onto the alignment film surface of the roll film. In a process of continuously heating the film from room temperature up to 100° C., the solvent was evaporated away, and then the film was heated in a drying zone at 105° C. for about 120 seconds whereby the discotic liquid-crystal compound was aligned. Next, this was transferred into a drying zone at 80° C., and irradiated with UV rays for 4 seconds at an illuminance of 600 mW from a UV radiation device (UV lamp: output 160 W/cm, light emission length 1.6 m) for crosslinking reaction, and the alignment state of the discotic liquid-crystal compound was thus fixed as such. Next, this was left cooled to room temperature, and wound up as a roll to obtain an optical compensation film roll.

Composition of coating liquid for optically-anisotropic layer

| | | |
|---|---|---|
| Discotic liquid-crystal compound (2) | 41 | mas. pts. |
| mentioned below | | |
| Ethylene oxide-modified trimethylolpropane | 4 | mas. pts. |
| triacrylate | | |
| (V#360, by Osaka Organic Chemical) | | |
| Cellulose acetate butyrate | 0.14 | mas. pts. |
| (CA8551-0.2, by Eastman Chemical) | | |
| Cellulose acetate butyrate | 0.22 | mas. pts. |
| (CAB531-1, by Eastman Chemical) | | |
| Fluoroaliphatic group-containing polymer | 0.45 | mas. pts. |
| (Megafac F780, by Dai-Nippon Ink) | | |
| Photopolymerization initiator | 1.35 | mas. pts. |
| (Irgacure 907, by Ciba-Geigy) | | |
| Sensitizer (Kayacure DETX, by Nippon Kayaku) | 0.45 | mas. pts. |
| Methyl ethyl ketone | 150 | mas. pts. |

Discotic liquid-crystal compound (2)

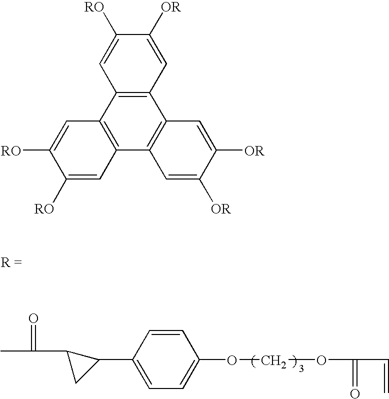

### (Determination of Optical Properties)

Thus formed, the optically-anisotropic layer was analyzed with KOBRA 21ADH for the retardation at a wavelength of 450 nm, 550 nm and 650 nm; and its Re(550) was 48 nm, and Re(450)/Re(650) was 1.20.

The retardation of the optical compensation film, a laminate of the optically-anisotropic layer and the transparent support was measured in a standard environment at 25° C. and 60% RH, and also in a low-humidity condition (25° C., 10% RH) and in a high-humidity condition (25° C., 80% RH). The absolute value of the difference between Rth in the standard environment and that in the low-humidity condition, ΔRth (low humidity) was 0.2 nm; and the absolute value of the difference between Rth in the standard environment and that in the high-humidity condition, ΔRth (high humidity) was 0.2 nm.

A polarizing plate was fabricated in the same manner as in Example 1-1, and the polarizing plate was incorporated in a TN-mode liquid-crystal display device and evaluated also in the same manner as in Example 1-1.

### Example 1-4

A polymer film for transparent support was prepared in the same manner as in Example 1-1, and the surface of the polymer film was processed for glow discharge treatment and an alignment film was formed thereon also in the same manner as in Example 1-1.

### (Preparation of Optically-Anisotropic Layer)

Using a wire bar of #3.0, a coating liquid for optically-anisotropic layer of the following composition was applied onto the alignment film. Concretely, the wire bar was rotated in the same direction as the machine direction of the film, at 781 rpm, and the roll film was conveyed at 20 m/min, and under the condition, the coating liquid was continuously applied onto the alignment film surface of the roll film. In a process of continuously heating the film from room temperature up to 70° C., the solvent was evaporated away, and then the film was heated in a drying zone at 80° C. for about 120 seconds whereby the rod-like liquid-crystal compound was aligned. Next, this was transferred into a drying zone at 50° C., and irradiated with UV rays for 4 seconds at an illuminance of 600 mW from a UV radiation device (UV lamp: output 160 W/cm, light emission length 1.6 m) for crosslinking reaction, and the alignment state of the rod-like liquid-crystal compound was thus fixed as such. Next, this was left cooled to room temperature, and wound up as a roll to obtain an optical compensation film roll.

Composition of coating liquid for optically-anisotropic layer

| | | |
|---|---|---|
| Rod-like liquid-crystal compound (1) mentioned below | 40 | mas. pts. |
| Rod-like liquid-crystal compound (2) mentioned below | 60 | mas. pts. |
| Air interface side alignment controlling agent mentioned below | 0.1 | mas. pts. |
| Photopolymerization initiator (Irgacure 907, by Ciba-Geigy) | 3.0 | mas. pts. |
| Sensitizer (Kayacure DETX, by Nippon Kayaku) | 1.0 | mas. pt. |
| Methyl ethyl ketone | 400 | mas. pts. |

Rodlike liquid-crystal compound (1)

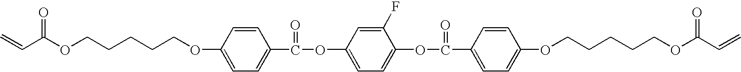

Rodlike liquid-crystal compound (2)

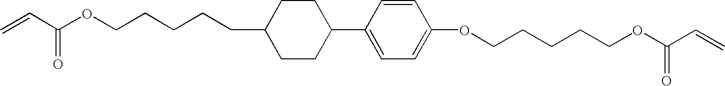

Air interface side alignment controlling agent

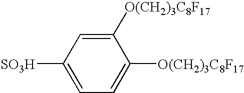

### (Determination of Optical Properties)

Thus formed, the optically-anisotropic layer was analyzed with KOBRA 21ADH for the retardation at a wavelength of 450 nm, 550 nm and 650 nm; and its Re(550) was 30 nm, and Re(450)/Re(650) was 1.10. The output data of KOBRA 21ADH, nx, ny and nz were in an order of nx>nz>ny.

The retardation of the optical compensation film, a laminate of the optically-anisotropic layer and the transparent support was measured in a standard environment at 25° C. and 60% RH, and also in a low-humidity condition (25° C., 10% RH) and in a high-humidity condition (25° C., 80% RH). The absolute value of the difference between Rth in the standard environment and that in the low-humidity condition, ΔRth (low humidity) was 0.2 nm; and the absolute value of the difference between Rth in the standard environment and that in the high-humidity condition, ΔRth (high humidity) was 0.2 nm.

A polarizing plate was fabricated in the same manner as in Example 1-1, and the polarizing plate was incorporated in a TN-mode liquid-crystal display device and evaluated also in the same manner as in Example 1-1.

### Example 1-5

In the same manner as in Example 1-3, a polymer film for transparent support was prepared in the same manner as in Example 1-1, and the surface of the polymer film was processed for glow discharge treatment and an alignment film was formed thereon.

### (Preparation of Optically-Anisotropic Layer)

Using a wire bar of #3.0, a coating liquid for optically-anisotropic layer of the following composition was applied onto the alignment film. Concretely, the wire bar was rotated in the same direction as the machine direction of the film, at 781 rpm, and the roll film was conveyed at 20 m/min, and under the condition, the coating liquid was continuously applied onto the alignment film surface of the roll film. In a process of continuously heating the film from room temperature up to 80° C., the solvent was evaporated away, and then the film was heated in a drying zone at 90° C. for about 120 seconds whereby the rod-like liquid-crystal compound was aligned. Next, this was transferred into a drying zone at 60° C., and irradiated with UV rays for 4 seconds at an illuminance of 600 mW from a UV radiation device (UV lamp: output 160 W/cm, light emission length 1.6 m) for crosslinking reaction, and the alignment state of the rod-like liquid-crystal compound was thus fixed as such. Next, this was left cooled to room temperature, and wound up as a roll to obtain an optical compensation film roll.

Composition of coating liquid for optically-anisotropic layer

| | | |
|---|---|---|
| Rod-like liquid-crystal compound (3) mentioned below | 80 | mas. pts. |
| Rod-like liquid-crystal compound (4) mentioned below | 20 | mas. pts. |
| Air interface side alignment controlling agent of Example 1-4 | 0.1 | mas. pts. |
| Photopolymerization initiator (Irgacure 907, by Ciba-Geigy) | 3.0 | mas. pts. |
| Sensitizer (Kayacure DETX, by Nippon Kayaku) | 1.0 | mas. pt. |
| Methyl ethyl ketone | 210 | mas. pts. |

Rod-like liquid-crystal compound (3)

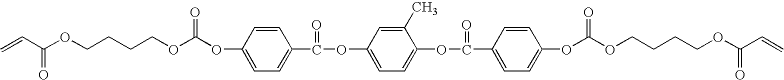

Rod-like liquid-crystal compound (4)

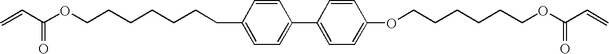

### (Determination of Optical Properties)

Thus formed, the optically-anisotropic layer was analyzed with KOBRA 21ADH for the retardation at a wavelength of 450 nm, 550 nm and 650 nm; and its Re(550) was 47 nm, and Re(450)/Re(650) was 1.21. The output data of KOBRA 21ADH, nx, ny and nz were in an order of nx>nz>ny.

The retardation of the optical compensation film, a laminate of the optically-anisotropic layer and the transparent support was measured in a standard environment at 25° C. and 60% RH, and also in a low-humidity condition (25° C., 10% RH) and in a high-humidity condition (25° C., 80% RH). The absolute value of the difference between Rth in the standard environment and that in the low-humidity condition, ΔRth (low humidity) was 0.2 nm; and the absolute value of the difference between Rth in the standard environment and that in the high-humidity condition, ΔRth (high humidity) was 0.2 nm.

A polarizing plate was fabricated in the same manner as in Example 1-1, and the polarizing plate was incorporated in a TN-mode liquid-crystal display device and evaluated also in the same manner as in Example 1-1.

### Example 1-6

### Preparation of Transparent Support

Using a band caster, the dope for formation of cyclic polyolefin prepared in Example 1-1 was cast. The film having a residual solvent content of about 22% by mass was peeled away from the band, and using a tenter, this was stretched in the cross section at a draw ratio of 40%. Then, this was changed from tenter transfer to roll transfer, stretched in the machine direction by 35% at 120° C. to 140° C., dried and wound up. Thus formed, the cyclic polyolefin film had a thickness of 52 μm; and Re(550) thereof at 25° C. and 60% RH was 40 nm and Rth(550) was 180 nm.

In the same manner as in Example 1-1, the cyclic polyolefin film was processed for glow discharge treatment and an alignment film was formed thereon, and this was rubbed in the direction clockwise shifted by 45° from the lengthwise direction (machine direction) of the film of 0° on the alignment film side.

### (Preparation of Optically-Anisotropic Layer)

An optically-anisotropic layer was formed in the same manner as in Example 1-1, for which, however, a wire bar of #4.7 was used.

### (Determination of Optical Properties)

Thus formed, the optically-anisotropic layer was analyzed with KOBRA 21ADH for the retardation at a wavelength of 450 nm, 550 nm and 650 nm; and its Re(550) was 40 nm, and Re(450)/Re(650) was 1.15.

The retardation of the optical compensation film, a laminate of the optically-anisotropic layer and the transparent support was measured in a standard environment at 25° C. and 60% RH, and also in a low-humidity condition (25° C., 10% RH) and in a high-humidity condition (25° C., 80% RH). The absolute value of the difference between Rth in the standard environment and that in the low-humidity condition, ΔRth (low humidity) was 0.3 nm; and the absolute value of the difference between Rth in the standard environment and that in the high-humidity condition, ΔRth (high humidity) was 0.3 nm.

A polarizing plate was fabricated in the same manner as in Example 1-1.

### (Fabrication of Bend Alignment-Mode Liquid-Crystal Cell)

A polyimide film serving as an alignment film was formed on an ITO electrode-having glass substrate, and the alignment film was rubbed. Thus obtained, two glass substrates were combined in such a manner that the rubbing direction of the two could be in parallel to each other, and the cell gap was 4.1 μm. A liquid-crystal compound (ZLI1132, by Merck) having Δn (550) of 0.1396 was injected into the cell gap, thereby fabricating a bend alignment-mode liquid-crystal cell.

### (Construction and Evaluation of Bend Alignment-Mode Liquid-Crystal Display Device)

The liquid-crystal cell and two polarizing plates fabricated in the above were combined to construct a liquid-crystal display device. The liquid-crystal cell and the two polarizing plates were disposed as follows: The optically-anisotropic layer of the polarizing plate and the substrate of the liquid-crystal cell face each other, and the rubbing direction of the liquid-crystal cell is antiparallel to the rubbing direction of the optically-anisotropic layer that faces the cell.

Thus constructed, the liquid-crystal display device was disposed on a backlight, and a voltage of 55 Hz square wave was applied to the bend alignment-mode liquid-crystal cell. With controlling the voltage and using a brightness meter (TOPCON's BM-5), the voltage at which the brightness in the black state (brightness in the normal direction) was the lowest was determined.

Next, in the same manner, the black brightness and the white brightness (brightness in the normal direction) were measured at the center of the panel, and the contrast in the normal direction was calculated from the data.

Using a spectral brightness meter (TOPCON's SR-3), the color shift in the black state was determined.

Using a contrast meter (EZ-CONTRAST), the contrast viewing angle (vertical contrast viewing angle, horizontal contrast viewing angle) was measured.

The thus-constructed liquid-crystal display device was analyzed and evaluated for the contrast viewing angle and the color shift thereof, and for the fluctuation in their characteristics under change in the environmental humidity in display expression. The results are shown in Table 1-1.

### Example 1-7

### Preparation of Transparent Film

Using a band caster, the dope for formation of cyclic polyolefin prepared in Example 1-1 was cast. The film having a residual solvent content of about 20% by mass was peeled away from the band, and using a tenter, this was stretched in the cross section at a draw ratio of 20%. Then, this was changed from tenter transfer to roll transfer, stretched in the machine direction by 35% at 120° C. to 140° C., dried and wound up. Thus formed, the cyclic polyolefin film had a thickness of 115 μm; and Re(550) thereof at 25° C. and 60% RH was 39 nm and Rth(550) was 415 nm.

In the same manner as in Example 1-1, the cyclic polyolefin film was processed for glow discharge treatment and an alignment film was formed thereon, and this was rubbed in the direction clockwise shifted by 45° from the lengthwise direction (machine direction) of the film of 0° on the alignment film side.

### (Preparation of Optically-Anisotropic Layer)

An optically-anisotropic layer was formed in the same manner as in Example 1-1, for which, however, a wire bar of #5.3 was used.

### (Determination of Optical Properties)

Thus formed, the optically-anisotropic layer was analyzed with KOBRA 21ADH for the retardation at a wavelength of 450 nm, 550 nm and 650 nm; and its Re(550) was 45 nm, and Re(450)/Re(650) was 1.15.

The retardation of the optical compensation film, a laminate of the optically-anisotropic layer and the transparent support was measured in a standard environment at 25° C. and 60% RH, and also in a low-humidity condition (25° C., 10% RH) and in a high-humidity condition (25° C., 80% RH). The absolute value of the difference between Rth in the standard environment and that in the low-humidity condition, ΔRth (low humidity) was 0.5 nm; and the absolute value of the difference between Rth in the standard environment and that in the high-humidity condition, ΔRth (high humidity) was 0.5 nm.

A polarizing plate was fabricated in the same manner as in Example 1-6, and the polarizing plate was incorporated into an OCB-mode liquid-crystal display device and evaluated, also in the same manner as in Example 1-6.

### Comparative Example 1-1

### Preparation of Cellulose Acetate Solution

A composition shown in the following Table was put into a mixing tank, and stirred under heat at 30° C. to dissolve the ingredients, thereby preparing a cellulose acetate solution (dope) for inner layer and outer layer.

| | inner layer | outer layer |
|---|---|---|
| Composition of Cellulose Acetate Dope | (mas. pts.) | (mas. pts.) |
| Cellulose acylate having a degree of | 100 | 100 |
| acetylation of 60.9% | | |
| Triphenyl phosphate (plasticizer) | 7.8 | 7.8 |
| Biphenyldiphenyl phosphate | 3.9 | 3.9 |
| (plasticizer) | | |
| Methylene chloride (1st solvent) | 293 | 314 |
| Methanol (2nd solvent) | 71 | 76 |
| 1-Butanol (3rd solvent) | 1.5 | 1.6 |
| Silica fine particles | 0 | 0.8 |
| (AEROSIL R972, by Nippon Aerosil) | | |
| Retardation enhancer of formula (A) | 1.7 | 0 |

Retardation enhancer (A)

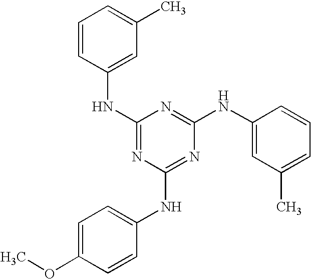

Thus obtained, the dope for inner layer and the dope for outer layer were cast onto a drum cooled at 0° C., using a three-layer co-casting die. The film having a residual solvent content of 70% by mass was peeled away from the drum. Both its sides were fixed with a pin tenter, the film was conveyed at a draw ratio of 110% in the machine direction, and dried at 80° C. When the residual solvent content thereof reached 10%, the film was dried at 110° C. Next, this was dried at 140° C. for 30 minutes to thereby prepare a cellulose acetate film having a residual solvent content of 0.3% by mass (outer layer: 3 μm, inner layer: 74 μm, outer layer: 3 μm).

Thus obtained, the cellulose acetate had a width of 1340 mm, and a thickness of 80 μm. Re(550) of the film, as measured at 25° C. and 60% RH with KOBRA 21ADH, was 4 nm; and Rth(550) thereof was 92 nm.

An isopropyl alcohol solution of potassium hydroxide (1.5 mol/L) was applied onto one surface of the thus-formed transparent support, in an amount of 25 mL/m², and left at 25° C. for 5 seconds, and then this was washed with running water for 10 seconds, and its surface was dried with an air blow at 25° C. In that manner, one surface alone of the transparent support was saponified.

### (Preparation of Alignment Film)

Using a wire bar coater of #14, the same coating liquid for alignment film as in Example 1-1 was applied to the saponified surface of the transparent support, in an amount of 24 mL/m². This was dried with hot air at 100° C. for 120 seconds. Next, the formed film was rubbed in the direction of 0° (this is the lengthwise direction, or that is, the machine direction of the cellulose acetate film), thereby forming an alignment film.

### (Preparation of Optically-Anisotropic Layer)

In the same manner as in Example 1-1, an optically-anisotropic layer was formed.

### (Determination of Optical Properties)

Thus formed, the optically-anisotropic layer was analyzed with KOBRA 21ADH for the retardation at a wavelength of 450 nm, 550 nm and 650 nm; and its Re(550) was 29 nm, and Re(450)/Re(650) was 1.15.

The retardation of the optical compensation film, a laminate of the optically-anisotropic layer and the transparent support was measured in a standard environment at 25° C. and 60% RH, and also in a low-humidity condition (25° C., 10% RH) and in a high-humidity condition (25° C., 80% RH). The absolute value of the difference between Rth in the standard environment and that in the low-humidity condition, ΔRth (low humidity) was 22 nm; and the absolute value of the difference between Rth in the standard environment and that in the high-humidity condition, ΔRth (high humidity) was 12 nm.

A polarizing plate was fabricated in the same manner as in Example 1-1, and the polarizing plate was incorporated into a TN-mode liquid-crystal display device and evaluated, also in the same manner as in Example 1-1.

### Comparative Example 1-2

In the same manner as in Example 1-3, a polymer film for transparent support was formed, and the polymer film was processed for glow discharge treatment, and an alignment film was formed thereon.

### (Preparation of Optically-Anisotropic Layer)

41.01 parts by mass of a discotic liquid-crystal compound (3) mentioned below, 4.06 parts by mass of ethylene oxide-modified trimethylolpropane triacrylate (V#360, by Osaka Organic Chemical), 0.35 parts by mass of cellulose acetate butyrate (CAB531-1, by Eastman Chemical), 1.35 parts by mass of a photopolymerization initiator (Irgacure 907, by Ciba-Geigy) and 0.45 parts by mass of a sensitizer (Kayacure DETX, by Nippon Kayaku) were dissolved in 102 parts by mass of methyl ethyl ketone to prepare a coating liquid, and 0.1 parts by mass of a fluoroaliphatic group-containing copolymer (Megafac F780, by Dai-Nippon Ink) was added thereto to prepare a coating liquid.

Using a wire bar of #3.0, the coating liquid for optically-anisotropic layer of the composition mentioned above was applied onto the alignment film. Concretely, the wire bar was rotated in the same direction as the machine direction of the film, at 781 rpm, and the roll film was conveyed at 20 m/min, and under the condition, the coating liquid was continuously applied onto the alignment film surface of the roll film. In a process of continuously heating the film from room temperature up to 100° C., the solvent was evaporated away, and then the film was heated in a drying zone at 125° C. for about 120 seconds whereby the discotic liquid-crystal compound was aligned. Next, this was transferred into a drying zone at 95° C., and irradiated with UV rays for 4 seconds at an illuminance of 600 mW from a UV radiation device (UV lamp: output 160 W/cm, light emission length 1.6 m) for crosslinking reaction, and the alignment state of the discotic liquid-crystal compound was thus fixed as such. Next, this was left cooled to room temperature, and wound up as a roll to obtain an optical compensation film roll.

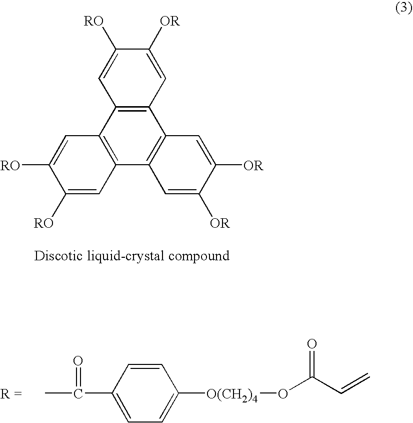

### (Determination of Optical Properties)

Thus formed, the optically-anisotropic layer was analyzed with KOBRA 21ADH for the retardation at a wavelength of 450 nm, 550 nm and 650 nm; and its Re(550) was 30 nm, and Re(450)/Re(650) was 1.27.

The retardation of the optical compensation film, a laminate of the optically-anisotropic layer and the transparent support was measured in a standard environment at 25° C. and 60% RH, and also in a low-humidity condition (25° C., 10% RH) and in a high-humidity condition (25° C., 80% RH). The absolute value of the difference between Rth in the standard environment and that in the low-humidity condition, ΔRth (low humidity) was 0.2 nm; and the absolute value of the difference between Rth in the standard environment and that in the high-humidity condition, ΔRth (high humidity) was 0.2 nm.

A polarizing plate was fabricated in the same manner as in Example 1-1, and the polarizing plate was incorporated into a TN-mode liquid-crystal display device and evaluated, also in the same manner as in Example 1-1.

### Comparative Example 1-3

### Preparation of Transparent Support

Using a machine-direction monoaxial stretcher, “Zeonoa ZF-14” (by Nippon Zeon, thickness 100 μm) was stretched in the machine direction at a draw ratio of 30%, at an air supply temperature of 140° C. and a film surface temperature of 130° C. Next, using a tenter stretcher, this was stretched in the cross direction at a draw ratio of 35%, at an air supply temperature of 140° C. and a film surface temperature of 130° C., and this was wound up into a roll film. Thus, a biaxially-stretched film was produced. Thus obtained, the film had a thickness of 60 μm, and its Re(550) was 1 nm and its Rth(550) was 90 nm.

The film was processed for glow discharge treatment and an alignment film was formed thereon, in the same manner as in Example 1-1.

Next, an optically-anisotropic layer was formed on it, in the same manner as in Comparative Example 1-2.

### (Determination of Optical Properties)

Thus formed, the optically-anisotropic layer was analyzed with KOBRA 21ADH for the retardation at a wavelength of 450 nm, 550 nm and 650 nm; and its Re(550) was 30 nm, and Re(450)/Re(650) was 1.27.

The retardation of the optical compensation film, a laminate of the optically-anisotropic layer and the transparent support was measured in a standard environment at 25° C. and 60% RH, and also in a low-humidity condition (25° C., 10% RH) and in a high-humidity condition (25° C., 80% RH). The absolute value of the difference between Rth in the standard environment and that in the low-humidity condition, ΔRth (low humidity) was 0.1 nm; and the absolute value of the difference between Rth in the standard environment and that in the high-humidity condition, ΔRth (high humidity) was 0.3 nm.

A polarizing plate was fabricated in the same manner as in Example 1-1, and the polarizing plate was incorporated into a TN-mode liquid-crystal display device and evaluated, also in the same manner as in Example 1-1.

### Comparative Example 1-4

In the same manner as in Comparative Example 1-1, a transparent support was prepared, saponified and an alignment film was formed thereon.

An optically-anisotropic layer was formed on it in the same manner as in Comparative Example 1-2, for which, however, a wire bar of #5.0 was used.

### (Determination of Optical Properties)

Thus formed, the optically-anisotropic layer was analyzed with KOBRA 21ADH for the retardation at a wavelength of 450 nm, 550 nm and 650 nm; and its Re(550) was 49 nm, and Re(450)/Re(650) was 1.27.

The retardation of the optical compensation film, a laminate of the optically-anisotropic layer and the transparent support was measured in a standard environment at 25° C. and 60% RH, and also in a low-humidity condition (25° C., 10% RH) and in a high-humidity condition (25° C., 80% RH). The absolute value of the difference between Rth in the standard environment and that in the low-humidity condition, ΔRth (low humidity) was 22 nm; and the absolute value of the difference between Rth in the standard environment and that in the high-humidity condition, ΔRth (high humidity) was 12 nm.

In the same manner as in Example 1-1, a polarizing plate was fabricated, and the polarizing plate was incorporated into a TN-mode liquid-crystal display device and evaluated.

### Comparative Example 1-5

In the same manner as in Comparative Example 1-1, a polymer film for transparent support was prepared, saponified and an alignment film was formed thereon.

### (Preparation of Optically-Anisotropic Layer)

Using a wire bar of #3.0, a coating liquid for optically-anisotropic layer of the following composition was applied onto the alignment film. Concretely, the wire bar was rotated in the same direction as the machine direction of the film, at 781 rpm, and the roll film was conveyed at 20 m/min, and under the condition, the coating liquid was continuously applied onto the alignment film surface of the roll film. In a process of continuously heating the film from room temperature up to 80° C., the solvent was evaporated away, and then the film was heated in a drying zone at 100° C. for about 120 seconds whereby the rod-like liquid-crystal compound was aligned. Next, this was transferred into a drying zone at 70° C., and irradiated with UV rays for 4 seconds at an illuminance of 600 mW from a UV radiation device (UV lamp: output 160 W/cm, light emission length 1.6 m) for crosslinking reaction, and the alignment state of the rod-like liquid-crystal compound was thus fixed as such. Next, this was left cooled to room temperature, and wound up as a roll to obtain an optical compensation film roll.

Composition of coating liquid for optically-anisotropic layer

| | | |
|---|---|---|
| Rod-like liquid-crystal compound (5) mentioned below | 100 | mas. pts. |
| Air interface side alignment controlling agent of Example 1-4 | 3.0 | mas. pts. |
| Photopolymerization initiator (Irgacure 907, by Ciba-Geigy) | 3.0 | mas. pts. |
| Sensitizer (Kayacure DETX, by Nippon Kayaku) | 1.0 | mas. pt. |
| Methyl ethyl ketone | 400 | mas. pts. |

Rod-like liquid-crystal compound (5)

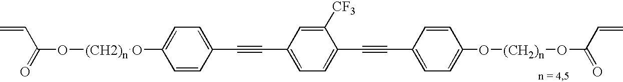

### (Determination of Optical Properties)

Thus formed, the optically-anisotropic layer was analyzed with KOBRA 21ADH for the retardation at a wavelength of 450 nm, 550 nm and 650 nm; and its Re(550) was 7 nm, and Re(450)/Re(650) was 1.28. The output data of KOBRA 21ADH, nx, ny and nz were in an order of nz>nx>ny.

The retardation of the optical compensation film, a laminate of the optically-anisotropic layer and the transparent support was measured in a standard environment at 25° C. and 60% RH, and also in a low-humidity condition (25° C., 10% RH) and in a high-humidity condition (25° C., 80% RH). The absolute value of the difference between Rth in the standard environment and that in the low-humidity condition, ΔRth (low humidity) was 22 nm; and the absolute value of the difference between Rth in the standard environment and that in the high-humidity condition, ΔRth (high humidity) was 12 nm.

In the same manner as in Example 1-1, a polarizing plate was fabricated, and the polarizing plate was incorporated in a TN-mode liquid-crystal display device and evaluated.

### Comparative Example 1-6

### Preparation of Transparent Support

### (Preparation of Cellulose Acetate Solution)

The following composition was put into a mixing tank, and stirred under heat to dissolve the ingredients, thereby preparing a cellulose acetate solution.

(Composition of cellulose acetate solution)

| | |
|---|---|
| Cellulose acetate having a degree of | 100 mas. pts. |
| acetylation of 60.9% | |
| Triphenyl phosphate | 7.8 mas. pts. |
| Biphenyldiphenyl phosphate | 3.9 mas. pts. |
| Methylene chloride | 300 mas. pts. |
| Methanol | 45 mas. pts. |

### (Preparation of Retardation Enhancer Solution)

4 parts by mass of cellulose acetate (linter) having a degree of acetylation of 60.9%, 25 parts by mass of a retardation enhancer mentioned below, 0.5 parts by mass of silica fine particles (mean particle size: 20 nm), 80 parts by mass of methylene chloride and 20 parts by mass of methanol were put into a different mixing tank, and stirred under heat to prepare a retardation enhancer solution.

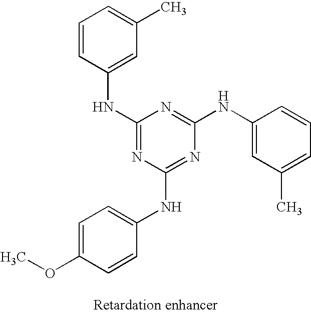

470 parts by mass of the cellulose acetate solution was mixed with 18.5 parts by mass of the retardation enhancer solution, and well stirred to prepare a dope. The ratio by mass of the retardation enhancer to cellulose acetate was 3.5% by mass.

Next, the film having a residual solvent content of 35% by mass was peeled away from the band, and using a film tenter, this was stretched at 140° C. in the cross direction at a draw ratio of 38%. Then, the clips were removed, and the film was dried at 130° C. for 45 seconds thereby preparing a cellulose acetate film serving as a second optically-anisotropic layer. Thus produced, the second optically-anisotropic layer had a residual solvent content of 0.2% by mass, and its thickness was 88 μm. Using KOBRA 21ADH, this was analyzed at 25° C. and 60% RH, and its Re(550) was 38 nm and its Rth(550) was 176 nm.

In the same manner as in Comparative Example 1-1, this was saponified and an alignment film was formed thereon, and then this was rubbed in the direction of 45° in the same manner as in Example 1-6.

In the same manner as in Comparative Example 1-2, an optically-anisotropic layer was formed, for which, however, a wire bar of #4.2 was used.

### (Determination of Optical Properties)

Thus formed, the optically-anisotropic layer was analyzed with KOBRA 21ADH for the retardation at a wavelength of 450 nm, 550 nm and 650 nm; and its Re(550) was 43 nm, and Re(450)/Re(650) was 1.27.

The retardation of the optical compensation film, a laminate of the optically-anisotropic layer and the transparent support was measured in a standard environment at 25° C. and 60% RH, and also in a low-humidity condition (25° C., 10% RH) and in a high-humidity condition (25° C., 80% RH). The absolute value of the difference between Rth in the standard environment and that in the low-humidity condition, ΔRth (low humidity) was 22 nm; and the absolute value of the difference between Rth in the standard environment and that in the high-humidity condition, ΔRth (high humidity) was 12 nm.

In the same manner as in Example 1-6, a polarizing plate was fabricated, and the polarizing plate was incorporated in an OCB-mode liquid-crystal display device and evaluated.

The evaluation results of TN-mode liquid-crystal display devices are shown in Table 1-1 and Table 1-2; and the evaluation results of the OCB-mode liquid-crystal display devices are in Table 1-3.

TABLE 1-1
Evaluation Results of TN-Mode Liquid-Crystal Display Devices
(Examples of the Invention)

| | | Example | | | | |
|---|---|---|---|---|---|---|
| | | 1-1 | 1-2 | 1-3 | 1-4 | 1-5 |
| Optically- | Formula | 1.15 | 1.15 | 1.2 | 1.1 | 1.21 |
| Anisotropic | (1) *1 | | | | | |
| Layer | Type of LC *2 | DLC | DLC | DLC | RLC | RLC |
| | Formula | — | — | — | satisfied | satisfied |
| | (2) *3 | | | | | |
| Transparent | Material *4 | ARTON | ZEONOR | ARTON | ARTON | ARTON |
| Support | Formula | 0.7 | 1.2 | 30.7 | 0.7 | 30.7 |
| | (3) *5 | | | | | |
| | Re (nm) | 81 | 50 | 3 | 81 | 3 |
| | Rth (nm) | 60 | 60 | 92 | 60 | 92 |
| Evaluation | Front CR | 820 | 800 | 800 | 810 | 800 |
| Results | Vertical CR | 160 | 160 | 150 | 160 | 150 |
| | Horizontal | 160 | 160 | 150 | 160 | 150 |
| | CR | | | | | |
| | Front Color | A | A | A | A | A |
| | Shift | | | | | |
| | Vertical | A | A | A | A | A |
| | Color Shift | | | | | |
| | Horizontal | A | A | B | A | B |
| | Color Shift | | | | | |
| | Humidity | A | A | A | A | A |
| | Dependence | | | | | |
| | of CR | | | | | |
| | Viewing | | | | | |
| | Angle | | | | | |
| | Humidity | A | A | A | A | A |
| | Dependence | | | | | |
| | of Color | | | | | |
| | Shift | | | | | |
| | Viewing | | | | | |
| | Angle | | | | | |

*1 Re(450)/Re(650)
*2 DLC: discotic liquid-crystal compound, RLC: rod-like liquid-crystal compound
*3 nx ≧ nz > ny
*4 ARTON and ZEONOR: trade names of cyclic polyolefin polymer TAC: cellulose triacetate
*5 Rth(550)/Re(550)

TABLE 1-2
Evaluation Results of TN-Mode Liquid-Crystal Display Devices
(Comparative Examples)

| | | Comparative Example | | | | |
|---|---|---|---|---|---|---|
| | | 1-1 | 1-2 | 1-3 | 1-4 | 1-5 |
| Optically- | Formula | 1.15 | 1.27 | 1.27 | 1.27 | 1.28 |
| Anisotropic Layer | (1) *1 | | | | | |
| | Type of | DLC | DLC | DLC | DLC | RLC |
| | LC *2 | | | | | |
| | Formula | — | — | — | — | not |
| | (2) *3 | | | | | satisfied |
| Transparent | Material *4 | TAC | ARTON | ZEONOR | TAC | TAC |
| Support | Formula | 23.0 | 30.7 | 90.0 | 23.0 | 23.0 |
| | (3) *5 | | | | | |
| | Re (nm) | 4 | 3 | 1 | 4 | 4 |
| | Rth (nm) | 92 | 92 | 90 | 92 | 92 |
| Evaluation Results | Front CR | 810 | 800 | 790 | 800 | 700 |
| | Vertical | 150 | 148 | 145 | 150 | 120 |
| | CR | | | | | |
| | Horizontal | 150 | 150 | 150 | 148 | 120 |
| | CR | | | | | |
| | Front | A | A | A | A | A |
| | Color | | | | | |
| | Shift | | | | | |
| | Vertical | A | C | C | C | C |
| | Color | | | | | |
| | Shift | | | | | |
| | Horizontal | B | B | B | B | B |
| | Color | | | | | |
| | Shift | | | | | |
| | Humidity | C | A | A | C | C |
| | Dependence | | | | | |
| | of CR | | | | | |
| | Viewing | | | | | |
| | Angle | | | | | |
| | Humidity | C | A | A | C | C |
| | Dependence | | | | | |
| | of Color | | | | | |
| | Shift | | | | | |
| | Viewing | | | | | |
| | Angle | | | | | |

*1 Re(450)/Re(650)
*2 DLC: discotic liquid-crystal compound, RLC: rod-like liquid-crystal compound
*3 nx ≧ nz > ny
*4 ARTON and ZEONOR: trade names of cyclic polyolefin polymer TAC: cellulose triacetate
*5 Rth(550)/Re(550)

TABLE 1-3
Evaluation Results of OCB-Mode Liquid-Crystal Display Devices

| | | Example | Example | Comparative |
|---|---|---|---|---|
| | | 1-6 | 1-7 | Example 1-6 |
| First | Formula (1) *1 | 1.15 | 1.15 | 1.27 |
| Optically- | Type of LC *2 | DLC | DLC | DLC |
| Anisotropic | Formula (2) *3 | — | — | — |
| Layer | | | | |
| Second | Material *4 | ARTON | ARTON | TAC |
| Optically- | Formula (4) *6 | 4.5 | 10.6 | 4.6 |
| Anisotropic | Re (nm) | 40 | 39 | 38 |
| Layer | Rth (nm) | 180 | 415 | 176 |
| Evaluation | Front CR | 510 | 500 | 420 |
| Results | Vertical CR | 160 | 158 | 150 |
| | Horizontal CR | 160 | 156 | 150 |
| | Front Color | A | A | C |
| | Shift | | | |
| | Vertical | A | A | B |
| | Color Shift | | | |
| | Horizontal | A | A | B |
| | Color Shift | | | |
| | Humidity | A | A | C |
| | Dependence of | | | |
| | CR Viewing | | | |
| | Angle | | | |
| | Humidity | A | A | C |
| | Dependence of | | | |
| | Color Shift | | | |
| | Viewing Angle | | | |

*1 Re(450)/Re(650)
*2 DLC: discotic liquid-crystal compound, RLC: rod-like liquid-crystal compound
*3 nx ≧ nz > ny
*4 ARTON and ZEONOR: trade names of cyclic polyolefin polymer TAC: cellulose triacetate
*6 Rth(550)/Re(550)

From the results shown in the above Tables, it is known that Examples 1-1 to 1-5 of TN-mode liquid-crystal display devices and Examples 1-6 and 1-7 of OCB-mode liquid-crystal display devices all had a high contrast in the normal direction and had a wide contrast viewing angle both in the horizontal direction and in the vertical direction. In addition, these had no or little viewing angle-dependent color shift. Further, it has been confirmed that all these display devices kept such their characteristics not influenced by the fluctuation of the environmental humidity.

In Examples 1-4 and 1-5 in which a rod-like liquid-crystal compound was used in forming the optically-anisotropic layer, the optically-anisotropic layer satisfies the numerical relation (2), and therefore the devices had a wide contrast viewing angle.

The transparent support satisfying the numerical relation (3) is a biaxial optically-anisotropic layer, and this differs from the optically-anisotropic layer of the optical compensation film heretofore used in conventional TN-mode liquid-crystal display devices. It is understood that the biaxial optically-anisotropic layer used as a transparent support reduces the horizontal color shift.

Heretofore, no one succeeded in obtaining an optical film that satisfies all the requirements of enlarging the contrast viewing angle, reducing the viewing angle-dependent color shift, and reducing the viewing angle characteristic fluctuation depending on the environmental humidity; however, when the optical compensation film of the above-mentioned Examples is used, then it may satisfy all these requirements.

On the other hand, it is understood that, in Comparative Examples 1-1 to 1-5 of TN-mode liquid-crystal display devices and Comparative Example 1-6 of OCB-mode liquid-crystal display devices, the optically-anisotropic layer does not satisfy the numerical relation (1), and/or the transparent support does not contain a cyclic polyolefin polymer, and therefore, these comparative display devices have poor viewing angle characteristics in point of the contrast and the color shift, and/or their characteristics fluctuate, as influenced by the environmental humidity.

### 2. Examples of the Second Invention

### Production of Ring-Containing Polymer

### Synthesis Example 1

### Production of Lactone Ring-Containing Polymer Pellets (P-1)

8000 g of methyl methacrylate (MMA), 2000 g of methyl 2-(hydroxymethyl)acrylate (MHMA), 10000 g of 4-methyl-2-pentanone (methyl isobutyl ketone, MIBK) and 5 g of n-dodecylmercaptan were put into a 30-L reactor equipped with a stirrer, a temperature sensor, a condenser tube and a nitrogen-introducing duct, and with nitrogen introduced thereinto, this was heated up to 105° C., and when this became refluxed, 5.0 g of an initiator, t-butylperoxyisopropyl carbonate (Kayaku Akzo's “Kayacarbon Bic-75” (trade name)) was added thereto, and at the same time, a solution of 10.0 g of t-butylperoxyisopropyl carbonate and 230 g of MIBK was dropwise added thereto, taking 2 hours, and under reflux in that condition (about 105 to 120° C.), this was polymerized in a mode of solution polymerization, and then further cured for 4 hours.

To the thus-obtained polymer solution, added was 30 g of a mixture of stearyl phosphate/distearyl phosphate (Sakai Chemical Industry's “Phoslex a-18” (trade name)), and under reflux (about 90 to 120° C.), this was reacted for cyclization condensation for 5 hours. Next, the polymer solution thus obtained through the cyclization condensation reaction was fed into a vent-type double-screw extruder (φ=29.75 mm, L/D=30) at a processing speed of 2.0 kg/hr in terms of the resin amount. The barrel temperature was 260° C., the revolution speed was 100 rpm, the vacuum degree was from 13.3 to 400 hPa (10 to 300 mmHg), the number of the rear vent of the extruder was 1, and the number of the fore vents thereof was 4. Thus fed, this was processed for cyclization condensation in the extruder with degassing, and then extruded out to give transparent pellets (P-1).

The obtained pellets (P-1) were analyzed for dynamic TG determination, in which mass reduction of 0.17% by mass was detected. The dealcoholation ratio derived from the mass reduction is 96.6%. The mass-average molecular weight of the pellets was 133,000, the melt flow rate thereof was 6.5 g/10 min, and the glass transition temperature thereof was 131° C.

### Synthesis Example 2

### Production of Glutaric Anhydride Unit-Containing Acrylic Thermoplastic Copolymer Pellets (P-2)

20 parts by mass of methyl methacrylate, 80 parts by mass of acrylamide, 0.3 parts by mass of potassium persulfate and 1500 parts by mass of ion-exchanged water were fed into a reactor, and the reactor was kept at 70° C. with purging with nitrogen gas until the monomer therein could be completely converted into a polymer, thereby preparing an aqueous suspension of methyl methacrylate/acrylamide copolymer.

0.05 parts by mass of the thus-obtained, aqueous suspension of methyl methacrylate/acrylamide copolymer was dissolved in 165 parts by mass of ion-exchanged water, and the resulting solution was fed into a stainless autoclave and stirred therein, and then the system was purged with nitrogen gas. Next, a monomer mixture mentioned below was added to the reaction system with stirring, and heated up to 70° C.

| | |
|---|---|
| Methacrylic acid (MAA) | 30 mas. pts. |
| Methyl methacrylate (MMA) | 70 mas. pts. |
| T-dodecylmercaptan | 0.6 mas. pts. |
| 2,2′-Azobisisobutyronitrile | 0.4 mas. pts. |

The time when the inner temperature reached 70° C. is the polymerization start time. From this, the system was kept as such for 180 minutes, and thus the polymerization was ended. After this, the reaction system was cooled, the polymer was separated, washed and dried according to an ordinary method, thereby producing a bead-like copolymer D. The conversion in polymerization in producing the copolymer D was 98%.

100 parts by mass of the bead-like copolymer D and 0.5 parts by mass of sodium methoxide were fed into a vented unidirectionally-rotating double-screw extruder via its hopper mouth, and melted and extruded at a resin temperature of 250° C., thereby producing pellets of glutaric anhydride unit-containing acrylic thermoplastic copolymer (P-2). Thus obtained, the acrylic thermoplastic copolymer was analyzed with an IR spectrophotometer, which gave absorption peaks at 1800 cm⁻¹ and 1760 cm⁻¹, and confirmed the formation of a glutaric anhydride unit in the copolymer. The acrylic thermoplastic copolymer was dissolved in heavy dimethylsulfoxide and subjected to ¹H-NMR at room temperature (23° C.) to determine the copolymer composition, which was comprised of 70% by mass of methyl methacrylate unit, 30% by mass of glutaric anhydride unit and 0% by mass of methacrylic acid unit. The glass transition temperature of the copolymer was 145° C.

### (Preparation of Transparent Support)

### Production Example 1

### Formation of Support (SP-1)

The above pellets (P-1) and acrylonitrile-styrene (AS) resin (Toyo Styrene's “Toyo AS AS20” (trade name)) were kneaded in a ratio by mass, P-1/AS resin=90/10, in a single-screw extruder (φ=30 mm) to produce transparent pellets. The glass transition temperature of the obtained pellets was 127° C. The pellets were dissolved in methyl ethyl ketone (MEK), and formed into a 60-μm film (SP-1) according to a solution casting method.

The obtained film was analyzed with KOBRA 21ADH for the optical properties at a wavelength of 550 nm. As a result, the in-plane retardation of the film Re was 0.5 nm, and the thickness-direction retardation thereof. Rth was −2.0 nm. The haze value of the film, as measured according to JIS K-7136, was 0.15%.

### Production Example 2

### Formation of Support (SP-2)

The film of the support (SP-1) obtained in Production Example 1 was monoaxially stretched by 1.5 times at 100° C. at a speed of 0.1 m/min to give a 50-μm stretched film (SP-2).

### Production Example 3

### Formation of Support (SP-3)

The pellets (P-2) obtained in Synthesis Example 2 were dissolved in MEK, and formed into a 60-μm film (SP-3) according to a solution casting method.

### Production Example 4

### Formation of Support (SP-4)

The above pellets (P-1) and acrylonitrile-styrene (AS) resin (Toyo Styrene's “Toyo AS AS20” (trade name)) were kneaded in a ratio by mass, P-1/AS resin=90/10, in a single-screw extruder (φ=30 mm) to produce transparent pellets. The glass transition temperature of the obtained pellets was 127° C. The pellets and a retardation enhancer 1 having the structure mentioned below were dissolved in methyl ethyl ketone (MEK) in a ratio by mass, pellets/retardation enhancer=100/3, and formed into a 80-μm film (SP-4) according to a solution casting method. The obtained film was analyzed with KOBRA 21ADH for the optical properties at a wavelength of 550 nm. As a result, the in-plane retardation of the film Re was 0.5 nm, and the thickness-direction retardation thereof. Rth was 92 nm.

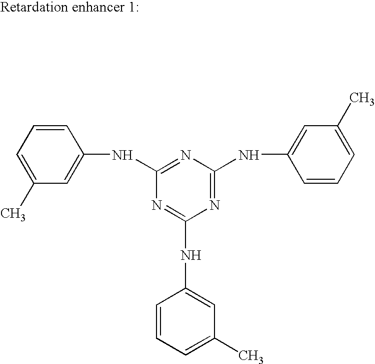

### Production Example 5

### Formation of Support (SP-5)

The above pellets (P-1) and acrylonitrile-styrene (AS) resin (Toyo Styrene's “Toyo AS AS20” (trade name)) were kneaded in a ratio by mass, P-1/AS resin=90/10, in a single-screw extruder (φ=30 mm) to produce transparent pellets. The glass transition temperature of the obtained pellets was 127° C. The pellets and a retardation enhancer 2 having the structure mentioned below were dissolved in methyl ethyl ketone (MEK) in a ratio by mass, pellets/retardation enhancer=100/5, and formed into a 85-μm film according to a solution casting method. Using a tenter, this was stretched by 1.25 times in the cross direction at 100° C. and at a speed of 0.1 m/min to give a 80-μm stretched film (SP-5). The obtained film was analyzed with KOBRA 21ADH for the optical properties at a wavelength of 550 nm. As a result, the in-plane retardation of the film Re was 3B nm (slow axis in the cross direction), and the thickness-direction retardation thereof. Rth was 180 nm. The haze of the film was 0.15%.

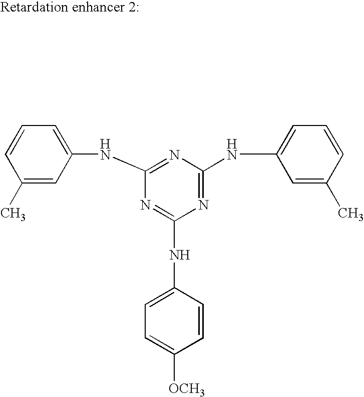

### Production Example 6

### Formation of Support (SP-6)

A 80-μm film (SP-6) was produced according to a solution casting method in the same manner as in Production Example 4, for which, however, the retardation enhancer 2 was substituted with a retardation enhancer 3 having the structure mentioned below. The obtained film was analyzed with KOBRA 21ADH for the optical properties at a wavelength of 550 nm. As a result, the in-plane retardation of the film Re was 0.5 nm, and the thickness-direction retardation thereof. Rth was 92 nm. The haze of the film was 0.15%.

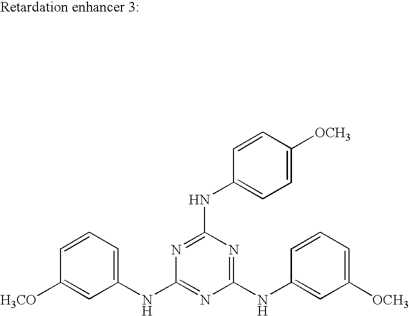

### Production Example 7

### Formation of Support (SP-7)

A 80-μm film (SP-7) was produced according to a solution casting method in the same manner as in Production Example 4, for which, however, the retardation enhancer 2 was substituted with a retardation enhancer 4 having the structure mentioned below. The obtained film was analyzed with KOBRA 21ADH for the optical properties at a wavelength of 550 nm. As a result, the in-plane retardation of the film Re was 0.5 nm, and the thickness-direction retardation thereof. Rth was 92 nm. The haze of the film was 0.15%.

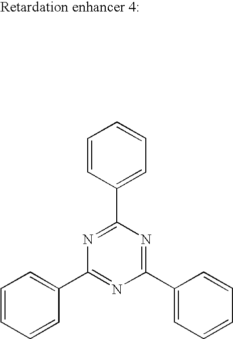

### Production Example 8

### Formation of Support (SP-8)

A 80-μm film (SP-8) was produced according to a solution casting method in the same manner as in Production Example 4, for which, however, the retardation enhancer 2 was substituted with a retardation enhancer 5 having the structure mentioned below. The obtained film was analyzed with KOBRA 21ADH for the optical properties at a wavelength of 550 nm. As a result, the in-plane retardation of the film Re was 0.5 nm, and the thickness-direction retardation thereof. Rth was 92 nm. The haze of the film was 0.15%.

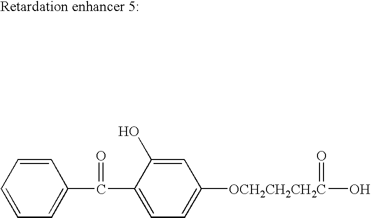

### Production Example 9

### Formation of Support (SP-9)

A 80-μm film (SP-9) was produced according to a solution casting method in the same manner as in Production Example 4, for which, however, the retardation enhancer 2 was substituted with a retardation enhancer 6 having the structure mentioned below. The obtained film was analyzed with KOBRA 21ADH for the optical properties at a wavelength of 550 nm. As a result, the in-plane retardation of the film Re was 0.5 nm, and the thickness-direction retardation thereof. Rth was 92 nm. The haze of the film was 0.15%.

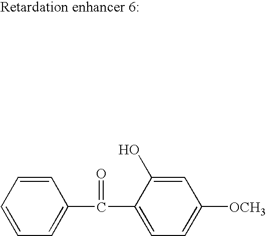

### Production Example 10

### Formation of Support (SP-10)

A 80-μm film (SP-10) was produced according to a solution casting method in the same manner as in Production Example 4, for which, however, the retardation enhancer 2 was substituted with a retardation enhancer 7 having the structure mentioned below. The obtained film was analyzed with KOBRA 21ADH for the optical properties at a wavelength of 550 nm. As a result, the in-plane retardation of the film Re was 0.5 nm, and the thickness-direction retardation thereof. Rth was 92 nm. The haze of the film was 0.15%.

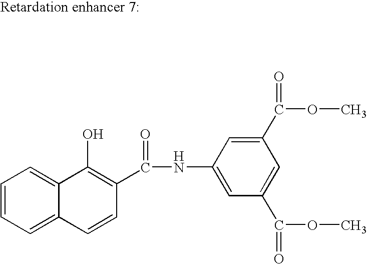

### Example 2-1

### Preparation of Alignment Film

One surface of the support (SP-4) produced in Production Example 4 was processed for atmospheric plasma treatment (electrode, produced by Sekisui Chemical Industry, condition: atmosphere oxygen concentration, 3% by volume (97% nitrogen), frequency, 30 Hz, film feeding speed, 1 m/min), whereby the surface was hydrophilicated. As a result of the hydrophilication, the contact angle with water of the surface was decreased from 90° to 28°, and the surface was fully hydrophilicated.

Onto the processed surface, applied was a curable composition for formation of alignment film mentioned below was applied in an amount of 24 mL/cm² as a wet coating amount thereof, using a wire bar of #24; and then this was dried at 100° C. for 2 minutes, and thereafter heated at 130° C. for 2.5 minutes ours to form a cured film. The thickness of the alignment film 1 was 1.0 μm.

Curable composition for formation of alignment film:

| | | |
|---|---|---|
| Modified polyvinyl alcohol having a formula | 40 | mas. pts. |
| mentioned below | | |
| Water | 728 | mas. pts. |
| Methanol | 228 | mas. pts. |
| Glutaraldehyde | 2 | mas. pts. |
| Citric acid | 0.08 | mas. pts. |
| Monoethyl citrate | 0.29 | mas. pts. |
| Diethyl citrate | 0.27 | mas. pts. |
| Trimethyl citrate | 0.05 | mas. pts. |

Modified polyvinyl alcohol:

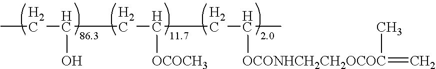

A coating liquid for a liquid-crystal composition 1 for formation of optically-anisotropic layer mentioned below was prepared.

Composition 1 for formation of optically-anisotropic layer:

| | | |
|---|---|---|
| Methyl ethyl ketone | 102.00 | mas. pts. |
| Discotic liquid-crystal compound 1 having | 41.01 | mas. pts. |
| the structure mentioned below | | |
| Ethylene oxide-modified trimethylolpropane | 4.06 | mas. pts. |
| acrylate (V360, by Osaka Organic Chemical) | | |
| Cellulose acetate butyrate | 0.11 | mas. pts. |
| (CAB531-1, by Eastman Chemical) | | |
| Cellulose acetate butyrate | 0.34 | mas. pts. |
| (CAB551-0.2, by Eastman Chemical) | | |
| Photopolymerization initiator | 1.35 | mas. pts. |
| (Irgacure 907, by Ciba-Geigy) | | |
| Sensitizer | 0.45 | mas. pts. |
| (Kayacure DETX, by Nippon Kayaku) | | |
| Fluoroaliphatic group-containing polymer 1 | 0.03 | mas. pts. |
| having the structure mentioned below | | |
| Fluoroaliphatic group-containing polymer 2 | 0.23 | mas. pts. |
| having the structure mentioned below | | |

Discotic liquid-crystal compound 1:

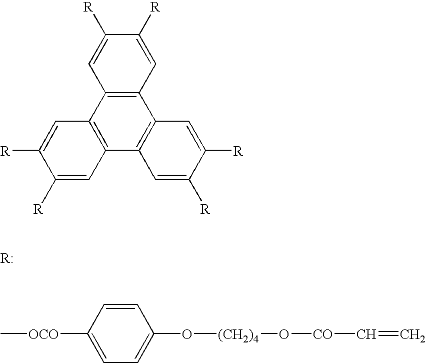

Fluoroaliphatic group-containing polymer 1 [a/b = 90/10, % by mass]:

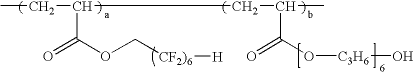

Fluoroaliphatic group-containing polymer 2 [a/b = 98/2, % by mass]:

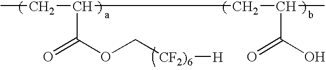

### (Preparation of Optically-Anisotropic Layer 1)

The alignment film-having roll film was unrolled and led into a rubbing unit disposed forward, in which the rubbing roll was made to rotate in reverse to the machine direction, and the surface of the alignment film was rubbed with it; and thereafter the rubbed surface of the film was ultrasonically purified for dust removal. After the dust removal, the coating liquid of the composition 1 for formation of optically-anisotropic layer mentioned above was applied onto the rubbed surface of the film, using a wire bar of #2, in an amount of 3.5 mL/cm² in terms of the wet coating amount thereof. Then, this was dried at 120° C. for 1.5 minutes for alignment, and thereafter while kept at 80° C., the film was irradiated with UV ray from a metal halide lamp of 120 W/cm at an irradiation dose of 200 mJ/cm² for polymerization to fix the alignment state, thereby forming an optically-anisotropic layer 1. In a winding zone, this was wound up as a roll film. The thickness of the optically-anisotropic layer 1 was 1.4 μm. Only the optically-anisotropic layer of the obtained film was transferred onto a glass plate, and using KOBRA 21ADH, it was analyzed for the optical properties at a wavelength of 550 nm. As a result, Re=50 nm, and Rth=86 nm. The haze of the film was 0.20%; the degree of extinction thereof was 0.0010. The constitution of the optical compensation film is shown in Table 2-1; and the evaluation results are in Table 2-2.

In the manner as above, an optical compensation film 1 was produced.

### (Fabrication of Polarize 1)

The stretched polyvinyl alcohol film was made to adsorb iodine to prepare a polarizing film.

Next, the back of the optical compensation film 1 produced in the above, on the side opposite to the side on which the optically-anisotropic layer 1 was formed was stuck to one surface of the above-mentioned polarizing film, using a polyvinyl alcohol adhesive; and on the other side of the polarizing film, a saponified, commercially-available cellulose triacetate film (Fujitac TD80UF, by FUJIFILM) was stuck thereto with a polyvinyl alcohol adhesive. In that manner, a polarizing plate 1 was fabricated.

### (Construction of TN-Mode Liquid-Crystal Display Device 1)

A pair of polarizing plates (upper polarizing plate and lower polarizing plate) originally in a 22-inch liquid-crystal display device (Acer's AL2216W) with a TN-mode liquid-crystal cell therein were peeled off, and in place of them, the polarizing plates 1 fabricated in the above were incorporated into it. Briefly, on the viewers' side and on the backlight side of the device, each one polarizing plate 1 was stuck via an adhesive in such a manner that the optically-anisotropic layer could face the liquid-crystal cell. In that manner, a TN-mode liquid-crystal display device 1 was constructed, having two polarizing plates 1. In this, the two polarizing plates 1 were so disposed that the transmission axis of the polarizing plate (upper polarizing plate) on the viewers' side could be perpendicular to the transmission axis of the polarizing plate (lower polarizing plate) on the backlight side.

### (Evaluation of Display Performance)

The liquid-crystal display device was left in a room at room temperature and ordinary humidity (25° C. 65% RH) for 1 week, and using a tester (EZ-Contrast 160D, by ELDIM), this was analyzed and evaluated for the contrast ratio in the panel normal direction (transmittance in the white state/transmittance in the black state), and for the horizontal/vertical contrast viewing angle (viewing angle for maintaining contrast of at least 10). The evaluation results are shown in Table 2-2.

### Comparative Example 2-1

An alignment film and an optically-anisotropic layer were formed in the same manner as in Example 2-1 to prepare an optical compensation film 2, for which, however, a support (SP-11) produced according to the production method mentioned below was used in place of the support (SP-4) produced in Production Example 4, and for the surface hydrophilication treatment, saponification was employed in place of the atmospheric plasma treatment. In the same manner as in Example 2-1, a polarizing plate 2 was fabricated, having the optical compensation film 2 on one side thereof; and also in the same manner as in Example 2-1, a TN-mode liquid-crystal display device 2 was constructed, using the polarizing plate 2, and evaluated. The constitution of the optical compensation film is shown in Table 2-1; and the evaluation results are in Table 2-2.

### Formation of Support (SP-11):

A composition mentioned below was put into a mixing tank, and stirred under heat at 30° C. to dissolve the ingredients, thereby preparing a cellulose acylate solution. The cellulose acylate used herein had a degree of acyl substitution of 2.83.

Dope composition for inner layer:

| | |
|---|---|
| Cellulose acylate having a degree of acetyl | 100 mas. pts. |
| substitution of 2.83 | |
| Triphenyl phosphate | 8 mas. pts. |
| Biphenyl phosphate | 4 mas. pts. |
| Methylene chloride | 293 mas. pts. |
| Methanol | 71 mas. pts. |
| 1-Butanol | 2 mas. pts. |

Dope composition for outer layer:

| | |
|---|---|
| Cellulose acylate having a degree of acetyl | 100 mas. pts. |
| substitution of 2.83 | |
| Triphenyl phosphate | 8 mas. pts. |
| Biphenyl phosphate | 4 mas. pts. |
| Methylene chloride | 314 mas. pts. |
| Methanol | 76 mas. pts. |
| 1-Butanol | 2 mas. pts. |
| Silica fine particles | 0.8 mas. pts. |
| (AEROSIL 972, by Nippon Aerosil) | |

Thus obtained, the dope for inner layer and the dope for outer layer were cast onto a drum cooled at 0° C., using a three-layer co-casting die. The film having a residual solvent content of 70% by mass was peeled away from the drum. Both its sides were fixed with a pin tenter, the film was conveyed at a draw ratio of 115% in the machine direction, and dried at 80° C. When the residual solvent content thereof reached 10%, the film was dried at 110° C. Next, this was dried at 155° C. for 20 minutes to thereby prepare a cellulose acetate film having a residual solvent content of 0.3% by mass (outer layer: 3 μm, inner layer: 74 μm, outer layer: 3 μm). In that manner, a support (SP-11) was produced. Thus obtained, the film was analyzed with KOBRA 21ADH for the optical characteristics at a wavelength of 550 nm; and as a result, the in-plane retardation of the film Re was 0.3 nm and the thickness-direction retardation thereof. Rth was 35 nm. The haze of the film was 0.20%.

A solution of 1.0 N potassium hydroxide (solvent: water/isopropyl alcohol/propylene glycol=69.2 mas.pts./15 mas.pts./15.8 mas.pts.) was applied onto one surface of the thus-formed transparent support, in an amount of 10 mL/m², and left at about 40° C. for 30 seconds, and then the alkali solution was scraped away and the film was washed with pure water. The water droplets were removed with an air knife, and then the film was dried at 100° C. for 15 seconds, whereby its one surface was saponified.

### Example 2-2

The support (SP-5) produced in Production Example 5 was used in place of the support (SP-4) produced in Production Example 4, and in the same manner as in Example 2-1, the support was saponified and an alignment film was formed thereon.

### (Preparation of Optically-Anisotropic Layer 2)

A coating liquid of liquid-crystal composition 2 for optically-anisotropic layer formation mentioned below was prepared.

Liquid-crystal composition 2 for optically-anisotropic layer
formation:

| | |
|---|---|
| Methyl ethyl ketone | 147.8 mas. pts. |
| Discotic liquid-crystal compound 1 mentioned | 41.01 mas. pts. |
| above | |
| Ethylene oxide-modified trimethylolpropane | 4.06 mas. pts. |
| acrylate (V360, by Osaka Organic Chemical) | |
| Cellulose acetate butyrate | 0.23 mas. pts. |
| (CAB531-1, Eastman Chemical) | |
| Photopolymerization initiator | 1.35 mas. pts. |
| (Irgacure 907, by Ciba-Geigy) | |
| Sensitizer (Kayacure DETX, by Nippon Kayaku) | 0.45 mas. pts. |
| Fluoroaliphatic group-containing polymer | 0.45 mas. pts. |
| (Megafac F780, by Dai-Nippon Ink Chemical | |
| Industry) | |

The film roll was unrolled and led into a rubbing unit, in which the rubbing roll was made to rotate in reverse to the machine direction as shifted by 45° from the machine direction, and the surface of the alignment film was rubbed with it; and thereafter the rubbed surface of the film was ultrasonically purified for dust removal. After the dust removal, the coating liquid of the composition 2 for formation of optically-anisotropic layer mentioned above was applied onto the rubbed surface of the film, using a wire bar of #2, in an amount of 3.5 mL/cm² in terms of the wet coating amount thereof. Then, this was dried at 120° C. for 1.5 minutes for alignment, and thereafter while kept at 80° C., the film was irradiated with UV ray from a metal halide lamp of 120 W/cm at an irradiation dose of 200 mJ/cm² polymerization to fix the alignment state, thereby forming an optically-anisotropic layer 2. In a winding zone, this was wound up as a roll film. The thickness of the optically-anisotropic layer 2 was 1.3 μm. Only the optically-anisotropic layer of the obtained film was transferred onto a glass plate, and using KOBRA 21ADH, it was analyzed for the optical properties at a wavelength of 550 nm. As a result, Re=30 nm, and Rth=90 nm. The haze of the film was 0.20%; the degree of extinction thereof was 0.0010. The above results are shown in Table 2-2.

In the manner as above, an optical compensation film 3 was produced.

### (Fabrication of Polarize 3)

A polarizing plate 3 was fabricated in the same manner as in Example 2-1, for which, however, the optical compensation film 3 was used in place of the optical compensation film 1.

### (Construction of OCB-Mode Liquid-Crystal Display Device 1)

### (Preparation of OCB-Mode Liquid-Crystal Cell)

A polyimide film serving as an alignment film was formed on an ITO electrode-having glass substrate, and the alignment film was rubbed. Thus obtained, two glass substrates were combined in such a manner that the rubbing direction of the two could be in parallel to each other, and the cell gap was 7.2 μm. A liquid-crystal compound (ZLI1132, by Merck) having Δn of 0.1396 was injected into the cell gap, thereby fabricating a bend alignment OCB-mode liquid-crystal cell.

### (Construction of Liquid-Crystal Display Device)

The above bend alignment liquid-crystal cell and the above one pair of polarizing plates 3 were combined to construct a liquid-crystal display device.

The bend alignment liquid-crystal cell and the pair of polarizing plates were disposed as follows: The optically-anisotropic layer of the polarizing plate and the substrate of the bend alignment liquid-crystal cell face each other, and the rubbing direction of the bend alignment liquid-crystal cell is antiparallel to the rubbing direction of the first optically-anisotropic layer that faces the cell.

With the bend alignment liquid-crystal cell sandwiched therebetween, the polarizing plates were stuck to other transparent substrates on the viewers' side and the backlight side thereof.

These were disposed as follows: The first optically-anisotropic layer of the polarizing plate faces the transparent substrate, and the rubbing direction of the bend alignment liquid-crystal cell is antiparallel to the rubbing direction of the first optically-anisotropic layer that faces the cell. In that manner, a liquid-crystal display device was constructed in which the size of the bend alignment liquid-crystal cell is 20 inches.

### (Evaluation of Display Performance)

In the same manner as in Example 2-1, the contrast ratio in the panel normal direction (transmittance in the white state/transmittance in the black state) was determined. The results are shown in Table 2-2.

### Comparative Example 2-2

In place of the support (SP-5) produced in Production Example 5, herein used was a support (SP-12) having a thickness of 88 μm, which was produced like the cellulose acylate film (CA-2) in Comparative Example 2-3 in JPA 2007-147966. Thus obtained, the film was analyzed for its optical characteristics, using KOBRA 21ADH, at a wavelength of 550 nm. Its in-plane retardation Re was 36 nm (slow axis in the cross direction), and its thickness-direction retardation Rth was 175 nm.

### Examples 2-3 to 2-8

An optical compensation film 5, a polarizing plate 5 and a TN-mode liquid-crystal display device 3 were produced in the same manner as in Example 2-1, for which, however, the support (SP-1) produced in Production Example 1 was used in place of the support (SP-4) produced in Production Example 4 (Example 2-3).

Similarly, an optical compensation film 6, a polarizing plate 6 and a TN-mode liquid-crystal display device 4 were produced in the same manner as in Example 2-1, for which, however, the support (SP-6) produced in Production Example 6 was used in place of the support (SP-4) produced in Production Example 4 (Example 2-4).

Similarly, an optical compensation film 7, a polarizing plate 7 and a TN-mode liquid-crystal display device 5 were produced in the same manner as in Example 2-1, for which, however, the support (SP-7) produced in Production Example 7 was used in place of the support (SP-4) produced in Production Example 4 (Example 2-5).

Similarly, an optical compensation film 8, a polarizing plate 8 and a TN-mode liquid-crystal display device 6 were produced in the same manner as in Example 2-1, for which, however, the support (SP-8) produced in Production Example 8 was used in place of the support (SP-4) produced in Production Example 4 (Example 2-6).

Similarly, an optical compensation film 9, a polarizing plate 9 and a TN-mode liquid-crystal display device 7 were produced in the same manner as in Example 2-1, for which, however, the support (SP-9) produced in Production Example 9 was used in place of the support (SP-4) produced in Production Example 4 (Example 2-7).

Similarly, an optical compensation film 10, a polarizing plate 10 and a TN-mode liquid-crystal display device 8 were produced in the same manner as in Example 2-1, for which, however, the support (SP-10) produced in Production Example 10 was used in place of the support (SP-4) produced in Production Example 4 (Example 2-8).

TABLE 2-1

| | Support | | | | | | | |
|---|---|---|---|---|---|---|---|---|
| | | | Second | Re | | | Surface | Optically-Anisotropic |
| | Film | Pellets | Resin* | Enhancer | Thickness | Stretching | Treatment | Layer |
| Example 2-1 | SP-4 | P-1 | AS | Re | 80 μm | no | atmospheric | optically-anisotropic |
| | | | | Enhancer 1 | | | plasma | layer 1 |
| Example 2-2 | SP-5 | P-1 | AS | Re | 80 μm | 25% | atmospheric | optically-anisotropic |
| | | | | Enhancer 2 | | | plasma | layer 2 |
| Example 2-3 | SP-1 | P-1 | AS | no | 80 μm | no | atmospheric | optically-anisotropic |
| | | | | | | | plasma | layer 1 |
| Example 2-4 | SP-6 | P-1 | AS | Re | 80 μm | no | atmospheric | optically-anisotropic |
| | | | | Enhancer 3 | | | plasma | layer 1 |
| Example 2-5 | SP-7 | P-1 | AS | Re | 80 μm | no | atmospheric | optically-anisotropic |
| | | | | Enhancer 4 | | | plasma | layer 1 |
| Example 2-6 | SP-8 | P-1 | AS | Re | 80 μm | no | atmospheric | optically-anisotropic |
| | | | | Enhancer 5 | | | plasma | layer 1 |
| Example 2-7 | SP-9 | P-1 | AS | Re | 80 μm | no | atmospheric | optically-anisotropic |
| | | | | Enhancer 6 | | | plasma | layer 1 |
| Example 2-8 | SP-10 | P-1 | AS | Re | 80 μm | no | atmospheric | optically-anisotropic |
| | | | | Enhancer 7 | | | plasma | layer 1 |
| Comparative | SP-11 | — | — | no | 80 μm | no | saponification | optically-anisotropic |
| Example 2-1 | | | | | | | | layer 1 |
| Comparative | SP-12 | — | — | no | 88 μm | 20% | saponification | optically-anisotropic |
| Example 2-2 | | | | | | | | layer 2 |

*AS: acrylonitrile/styrene resin

TABLE 2-2

| | | Optical compensation film | | Liquid-Crystal Display Device | | |
|---|---|---|---|---|---|---|
| | Support | | degree | | | horizontal |
| | haze | haze | of extinction | mode | front CR | CR viewing angle |
| Example 2-1 | 0.15% | 0.20% | 0.0010 | TN | 900 | 160 |
| Example 2-2 | 0.15% | 0.20% | 0.0010 | OCB | 900 | 160 |
| Example 2-3 | 0.15% | 0.20% | 0.0010 | TN | 900 | 130 |
| Example 2-4 | 0.15% | 0.20% | 0.0010 | TN | 900 | 160 |
| Example 2-5 | 0.15% | 0.20% | 0.0010 | TN | 900 | 160 |
| Example 2-6 | 0.15% | 0.20% | 0.0010 | TN | 900 | 160 |
| Example 2-7 | 0.15% | 0.20% | 0.0010 | TN | 900 | 160 |
| Example 2-8 | 0.15% | 0.20% | 0.0010 | TN | 900 | 160 |
| Comparative | 0.20% | 0.30% | 0.0015 | TN | 860 | 110 |
| Example 2-1 | | | | | | |
| Comparative | 0.70% | 0.80% | 0.0030 | OCB | 800 | 140 |
| Example 2-2 | | | | | | |

From the results in the above Table 2-2, it is understood that, in Examples 2-1 to 2-8, a film containing a lactone ring unit-containing copolymer or glutaric anhydride unit-containing copolymer film is used as the transparent support, and therefore in these, as compared with that in other examples where any other polymer film is used as the transparent support, the degree of extinction of the optical compensation film is low, and when a polarizing plate comprising the optical compensation film is incorporated in liquid-crystal display devices of TN-mode, IPS-mode or other modes, the contrast is increased.

### Production Example 13

### Production of Support (SP-13)

A 80-μm film (SP-13) was produced according to a solution casting method in the same manner as in Production Example 4, for which, however, the retardation enhancer 1 was replaced by the retardation enhancer 3. Using KOBRA 21ADH, the obtained film was analyzed for the optical characteristics at a wavelength of 550 nm. As a result, its in-plane retardation Re was 0.5 nm, and its thickness-direction retardation Rth was 92 nm. The haze of the film was 0.15%.

### Production Example 14

### Production of Support (SP-14)

A 80-μm film (SP-14) was produced according to a solution casting method in the same manner as in Production Example 4, for which, however, the retardation enhancer 1 was replaced by the retardation enhancer 4. Using KOBRA 21ADH, the obtained film was analyzed for the optical characteristics at a wavelength of 550 nm. As a result, its in-plane retardation Re was 0.5 nm, and its thickness-direction retardation Rth was 92 nm. The haze of the film was 0.15%.

### Production Example 15

### Production of Support (SP-15)

A 80-μm film (SP-15) was produced according to a solution casting method in the same manner as in Production Example 4, for which, however, the retardation enhancer 1 was replaced by the retardation enhancer 5. Using KOBRA 21ADH, the obtained film was analyzed for the optical characteristics at a wavelength of 550 nm. As a result, its in-plane retardation Re was 0.5 nm, and its thickness-direction retardation Rth was 92 nm. The haze of the film was 0.15%.

### Production Example 16

### Production of Support (SP-16)

A 80-μm film (SP-16) was produced according to a solution casting method in the same manner as in Production Example 4, for which, however, the retardation enhancer 1 was replaced by the retardation enhancer 6. Using KOBRA 21ADH, the obtained film was analyzed for the optical characteristics at a wavelength of 550 nm. As a result, its in-plane retardation Re was 0.5 nm, and its thickness-direction retardation Rth was 92 nm. The haze of the film was 0.15%.

### Production Example 17

### Production of Support (SP-17)

A 80-μm film (SP-17) was produced according to a solution casting method in the same manner as in Production Example 4, for which, however, the retardation enhancer 1 was replaced by the retardation enhancer 7. Using KOBRA 21ADH, the obtained film was analyzed for the optical characteristics at a wavelength of 550 nm. As a result, its in-plane retardation Re was 0.5 nm, and its thickness-direction retardation Rth was 92 nm. The haze of the film was 0.15%.

### Production Example 18

### Production of Support (SP-18)

The pellets (P-2) obtained in Synthesis Example 2 and the retardation enhancer 1 were dissolved in methyl ethyl ketone (MEK) in a ratio by mass of pellets/retardation enhancer=100/6, and this was formed into a 60-μm film (SP-18) according to a solution casting method. Using KOBRA 21ADH, the obtained film was analyzed for the optical characteristics at a wavelength of 550 nm. As a result, Re=2 nm and Rth=93 nm. The haze of the film was 0.16%.

### Production Example 19

### Production of Support (SP-19)

The pellets (P-2) obtained in Synthesis Example 2 and the retardation enhancer 1 were dissolved in methyl ethyl ketone (MEK) in a ratio by mass of pellets/retardation enhancer=100/3, and this was formed into a 60-μm film (SP-19) according to a solution casting method. Using a tenter, this was stretched in the cross direction by 1.17 times at 100° C. and at a speed of 0.1 m/min to give a 53-μm stretched film (SP-19). Using KOBRA 21ADH, the obtained film was analyzed for the optical characteristics at a wavelength of 550 nm. As a result, its in-plane retardation Re was 75 nm (slow axis in the cross direction), and its thickness direction retardation Rth was 62 nm. The haze of the film was 0.17%.

### Production Example 20

### Production of Support (SP-20)

Using a tenter, SP-18 obtained in Production Example 18 was stretched in the cross direction by 1.25 times at 100° C. and at a speed of 0.1 m/min to give a 50-μm stretched film (SP-20). Using KOBRA 21ADH, the obtained film was analyzed for the optical characteristics at a wavelength of 550 nm. As a result, its in-plane retardation Re was 40 nm (slow axis in the cross direction), and its thickness direction retardation Rth was 182 nm. The haze of the film was 0.17%.

### Examples 2-9 to 2-14

An optical compensation film 11, a polarizing plate 11 and a TN-mode liquid-crystal display device 9 were produced in the same manner as in Example 2-1, for which, however, the support (SP-13) produced in Production Example 13 was used in place of the support (SP-4) produced in Production Example 4 (Example 2-9).

Similarly, an optical compensation film 12, a polarizing plate 12 and a TN-mode liquid-crystal display device 10 were produced in the same manner as in Example 2-1, for which, however, the support (SP-14) produced in Production Example 14 was used in place of the support (SP-4) produced in Production Example 4 (Example 2-10).

Similarly, an optical compensation film 13, a polarizing plate 13 and a TN-mode liquid-crystal display device 11 were produced in the same manner as in Example 2-1, for which, however, the support (SP-15) produced in Production Example 15 was used in place of the support (SP-4) produced in Production Example 4 (Example 2-11).

Similarly, an optical compensation film 14, a polarizing plate 14 and a TN-mode liquid-crystal display device 12 were produced in the same manner as in Example 2-1, for which, however, the support (SP-16) produced in Production Example 16 was used in place of the support (SP-4) produced in Production Example 4 (Example 2-12).

Similarly, an optical compensation film 15, a polarizing plate 15 and a TN-mode liquid-crystal display device 13 were produced in the same manner as in Example 2-1, for which, however, the support (SP-17) produced in Production Example 17 was used in place of the support (SP-4) produced in Production Example 4 (Example 2-13).

Similarly, an optical compensation film 1.6, a polarizing plate 16 and a TN-mode liquid-crystal display device 14 were produced in the same manner as in Example 2-1, for which, however, the support (SP-2) produced in Production Example 2 was used in place of the support (SP-4) produced in Production Example 4 (Example 2-14).

### Example 2-15

Like in Example 2-1, one surface of the support (SP-4) produced in Production Example 4 was processed for atmospheric plasma treatment, and an alignment film was formed on the processed surface.

### (Preparation of Liquid-Crystal Composition 3 for Formation of Optically-Anisotropic Layer)

A coating liquid of liquid-crystal composition 3 for formation of optically-anisotropic layer mentioned below was prepared.

| | | |
|---|---|---|
| Methyl ethyl ketone | 270 | mas. pts. |
| Discotic liquid-crystal compound 1 | 10.0 | mas. pts. |
| Discotic liquid-crystal compound 2 having the | 90.0 | mas. pts. |
| structure shown below | | |
| Air interface alignment controlling agent 1 | 1.0 | mas. pt. |
| having the structure shown below | | |
| Photopolymerization initiator | 3.0 | mas. pts. |
| (Irgacure 907, by Ciba-Geigy) | | |
| Sensitizer (Kayacure DETX, by Nippon Kayaku) | 1.0 | mas. pt. |

Discotic liquid-crystal compound 2:

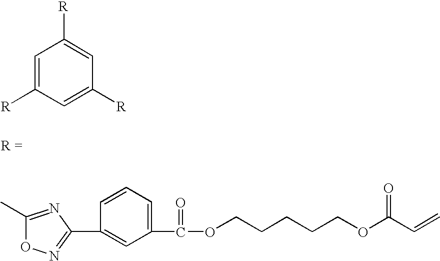

Air interface alignment controlling agent 1:

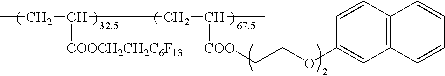

The alignment film-having roll film was unrolled and led into a rubbing unit disposed forward, in which the rubbing roll was made to rotate in reverse to the machine direction, and the surface of the alignment film was rubbed with it; and thereafter the rubbed surface of the film was ultrasonically purified for dust removal. After the dust removal, the coating liquid of the liquid-crystal composition 3 for formation of optically-anisotropic layer mentioned above was applied onto the rubbed surface of the film, using a wire bar of #1.6, in an amount of 2.8 mL/cm² in terms of the wet coating amount thereof. Then, this was dried at 115° C. for 1.5 minutes for alignment, and thereafter while kept at 80° C., the film was irradiated with UV ray from a metal halide lamp of 120 W/cm at an irradiation dose of 200 mJ/cm² for polymerization to fix the alignment state, thereby forming an optically-anisotropic layer 3. In a winding zone, this was wound up as a roll film. The thickness of the optically-anisotropic layer 3 was 0.9 μm. Only the optically-anisotropic layer of the obtained film was transferred onto a glass plate, and using KOBRA 21ADH, it was analyzed for the optical properties at a wavelength of 550 nm. As a result, Re=46 nm, and Rth=80 nm. The haze of the film was 0.18%; the degree of extinction thereof was 0.0008. In that manner, an optical compensation film 17 was produced.

Using the optical compensation film 17 and in the same manner as in Example 2-1, a polarizing plate 17 and a TN-mode liquid-crystal display device 15 were fabricated evaluated for their display performance.

### Example 2-16

In the same manner as in Example 2-1 but using the support (SP-5) produced in Example 5 in place of the support (SP-4) produced in Example 4, the surface of the support SP-5 was processed for atmospheric plasma treatment, and an alignment film was formed on the processed surface.

In the same manner as in Example 2-2, a coating liquid of liquid-crystal composition 2 for formation of optically-anisotropic layer was prepared, and this was applied onto the surface of the above alignment film, thereby producing an optical compensation film 18.

Using the optical compensation film 18 and in the same manner as in Example 2-2, a polarizing plate 18 and an OCB-mode liquid-crystal display device 3 were fabricated, and evaluated for their display performance.

### Example 2-17

In the same manner as in Example 2-1 but using the support (SP-3) produced in Example 3, the surface of the support SP-3 was processed for atmospheric plasma treatment, and an alignment film was formed on the processed surface.

In the same manner as in Example 2-15, a coating liquid of liquid-crystal composition 3 for formation of optically-anisotropic layer was prepared, and this was applied onto the surface of the above alignment film, thereby producing an optical compensation film 19. Using it, a polarizing plate 19 was fabricated.

### (Construction of TN-Mode Liquid-Crystal Display Device)

A pair of polarizing plates originally in a 26-inch liquid-crystal display device (LC-26HU25, by Xoceco) with a TN-mode liquid-crystal cell therein were peeled off, and in place of them, the polarizing plates 19 fabricated in the above were incorporated into it. Briefly, on the viewers' side and on the backlight side of the device, each one polarizing plate 19 was stuck via an adhesive in such a manner that the transmission axis of the polarizing plate on the viewers' side could be perpendicular to the transmission axis of the polarizing plate on the backlight side. In that manner, a TN-mode liquid-crystal display device 16 was constructed.

### (Evaluation of Display Performance)

In the same manner as in Example 2-1, the device 16 was evaluated for the contrast in the normal direction and the viewing angle thereof.

### (Evaluation of Brightness Change Caused by Temperature and Humidity Change)

The liquid-crystal display device 16 was tested as follows: Its power was turned off and kept “OFF” for at least 2 hours, then its power was turned on, and within 5 minutes with “ON”, the brightness was measured at the center of the four, top and bottom and right and left sides, and at a point nearer by 1 cm to the center from each side, using a brightness tester (TOPCON's BM-5) The average of the data was calculated, and was 0.3 cd/cm². Next, when 1 hour passed after the power was turned on, the device was tested and in the same manner as previously. As a result, its brightness was 0.5 cd/cm². This means that the brightness change caused by temperature change of the liquid-crystal display device 16 is 0.2 cd/cm².

The liquid-crystal display device 16 was left at 25° C. and 10% RH for 24 hours while its power was kept “OFF”. Immediately after the device was turned on, it was tested in the same manner. As a result, the brightness was 0.5 cd/cm². This means that the brightness change caused by humidity change of the liquid-crystal display device 16 is 0.2 cd/cm².

### Example 2-18

In the same manner as in Example 2-1 but using the support (SP-18) produced in Example 18, the surface of the support SP-18 was processed for atmospheric plasma treatment, and an alignment film was formed on the processed surface.

In the same manner as in Example 2-15, a coating liquid of liquid-crystal composition 3 for formation of optically-anisotropic layer was prepared, and this was applied onto the surface of the above alignment film, thereby producing an optical compensation film 20. Using this, a polarizing plate 20 was fabricated.

Using the polarizing plate 20 and in the same manner as in Example 2-17, a TN-mode liquid-crystal display device 17 was fabricated and evaluated for its display performance.

### Example 2-19

In the same manner as in Example 2-1 but using the support (SP-18) produced in Example 18, the surface of the support SP-18 was processed for atmospheric plasma treatment, and an alignment film was formed on the processed surface.

### (Preparation of Liquid-Crystal Composition 4 for Formation of Optically-Anisotropic Layer)

A coating liquid of liquid-crystal composition 4 for formation of optically-compensatory film mentioned below was prepared.

| | |
|---|---|
| Methyl ethyl ketone | 270 mas. pts. |
| Discotic liquid-crystal compound 2 | 100.0 mas. pts. |
| Air interface alignment controlling agent 1 | 1.0 mas. pt. |
| Photopolymerization initiator | 3.0 mas. pts. |
| (Irgacure 907, by Ciba-Geigy) | |
| Sensitizer (Kayacure DETX, by Nippon Kayaku) | 1.0 mas. pt. |

In the same manner as in Example 2-15 but using the coating liquid of liquid-crystal composition 4 for formation of optically-anisotropic layer in place of the coating liquid of liquid-crystal composition 3 for formation of optically-anisotropic layer, an optically-anisotropic layer 4 was formed, thereby fabricating an optical compensation film 21. Using this, a polarizing plate 21 was fabricated.

Using the polarizing plate 21 and in the same manner as in Example 2-17, a TN-mode liquid-crystal display device 18 was fabricated and evaluated for its display performance.

### Example 2-20

In the same manner as in Example 2-1 but using the support (SP-19) produced in Example 19, the surface of the support SP-19 was processed for atmospheric plasma treatment, and an alignment film was formed on the processed surface.

Next, the roll of the alignment film-having long film was unrolled and led into a rubbing unit disposed forward, in which the rubbing roll was made to rotate in reverse to the machine direction, and the surface of the alignment film was rubbed with it; and thereafter the rubbed surface of the film was ultrasonically purified for dust removal. After the dust removal, the coating liquid of the liquid-crystal composition 2 for formation of optically-anisotropic layer mentioned above was applied onto the rubbed surface of the film, using a wire bar of #2, in an amount of 3.5 mL/cm² in terms of the wet coating amount thereof. Then, this was dried at 120° C. for 1.5 minutes for liquid crystal alignment, and thereafter while kept at 80° C., the film was irradiated with UV ray from a metal halide lamp of 120 W/cm at an irradiation dose of 200 mJ/cm² for polymerization to fix the alignment state, thereby forming an optically-anisotropic layer 5. In a winding zone, this was wound up as a roll film. The thickness of the optically-anisotropic layer 5 was 1.4 μm. Only the optically-anisotropic layer 5 of the obtained film was transferred onto a glass plate, and using KOBRA 21ADH, it was analyzed for the optical properties at a wavelength of 550 nm. As a result, Re=32 nm, and Rth=90 nm. The haze of the film was 0.21%; the degree of extinction thereof was 0.0011. In that manner, an optical compensation film 22 was produced.

Using the optical compensation film 22 and in the same manner as in Example 2-17, a polarizing plate 22 and a TN-mode liquid-crystal display device 19 were fabricated evaluated for their display performance.

### Example 2-21

In the same manner as in Example 2-1 but using the support (SP-19) produced in Example 19, the surface of the support SP-19 was processed for atmospheric plasma treatment, and an alignment film was formed on the processed surface.

### (Preparation of Liquid-Crystal Composition 5 for Formation of Optically-Anisotropic Layer)

A coating liquid of liquid-crystal composition 5 for formation of optically-compensatory film mentioned below was prepared.

| | |
|---|---|
| Methyl ethyl ketone | 270 mas. pts. |
| Discotic liquid-crystal compound 1 | 10.0 mas. pts. |
| Discotic liquid-crystal compound 2 | 90.0 mas. pts. |
| Air interface alignment controlling agent 1 | 2.0 mas. pts. |
| Photopolymerization initiator | 3.0 mas. pts. |
| (Irgacure 907, by Ciba-Geigy) | |
| Sensitizer (Kayacure DETX, by Nippon Kayaku) | 1.0 mas. pt. |

In the same manner as in Example 2-15 but using the coating liquid of liquid-crystal composition 5 for formation of optically-anisotropic layer in place of the coating liquid of liquid-crystal composition 3 for formation of optically-anisotropic layer, an optical compensation film 23 was produced.

Using the optical compensation film 23 and in the same manner as in Example 2-17, a polarizing plate 23 and a TN-mode liquid-crystal display device 20 were fabricated, and evaluated for their display performance.

### Example 2-22

In the same manner as in Example 2-1 but using the support (SP-18) produced in Example 18, the surface of the support SP-18 was processed for atmospheric plasma treatment, and an alignment film was formed on the processed surface.

### (Preparation of Liquid-Crystal Composition 6 for Formation of Optically-Anisotropic Layer)

A coating liquid of liquid-crystal composition 6 for formation of optically-compensatory film mentioned below was prepared.

| | | |
|---|---|---|
| Methyl ethyl ketone | 300.0 | mas. pts. |
| Rod-like liquid-crystal compound 1 mentioned below | 87.0 | mas. pts. |
| Rod-like liquid-crystal compound 2 mentioned below | 13.0 | mas. pts. |
| Cellulose acetate butyrate (CAB551-0.2, by Eastman Chemical) | 0.4 | mas. pts. |
| Fluoroaliphatic group-containing polymer (Megafac F780, by Dai-Nippon Ink Chemical Industry) | 0.6 | mas. pts. |
| Photopolymerization initiator (Irgacure 907, by Ciba-Geigy) | 3.0 | mas. pts. |
| Sensitizer (Kayacure DETX, by Nippon Kayaku) | 1.0 | mas. pt. |

Rod-like liquid-crystal compound 1:

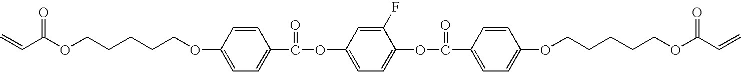

Rod-like liquid-crystal compound 2:

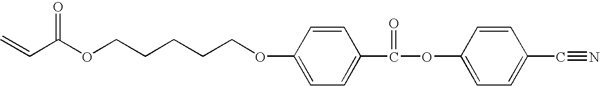

In the same manner as in Example 2-15 but using the coating liquid of liquid-crystal composition 6 for formation of optically-anisotropic layer in place of the coating liquid of liquid-crystal composition 3 for formation of optically-anisotropic layer, an optical compensation film 24 was produced.

Using the optical compensation film 24 and in the same manner as in Example 2-17, a polarizing plate 24 and a TN-mode liquid-crystal display device 21 were fabricated, and evaluated for their display performance.

### Example 2-23

In the same manner as in Example 2-1 but using the support (SP-20) produced in Example 20, the surface of the support SP-20 was processed for atmospheric plasma treatment, and an alignment film was formed on the processed surface.

In the same manner as in Example 2-2 but using the coating liquid of liquid-crystal composition 5 for formation of optically-anisotropic layer in place of the coating liquid of liquid-crystal composition 2 for formation of optically-anisotropic layer, an optical compensation film 25 was produced.

Using the optical compensation film 25 and in the same manner as in Example 2-2, a polarizing plate 25 and an OCB-mode liquid-crystal display device 4 were fabricated, and evaluated for their display performance.

In the same manner as in Example 2-17, the OCB-mode liquid-crystal display device 4 was tested for the brightness change caused by temperature and humidity change.

### Example 2-24

In the same manner as in Example 2-1 but using the support (SP-20) produced in Example 20, the surface of the support SP-20 was processed for atmospheric plasma treatment, and an alignment film was formed on the processed surface.

### (Preparation of Liquid-Crystal Composition 7 for Formation of Optically-Anisotropic Layer)

A coating liquid of liquid-crystal composition 7 for formation of optically-compensatory film mentioned below was prepared.

| | |
|---|---|
| Methyl ethyl ketone | 270 mas. pts. |
| Discotic liquid-crystal compound 2 | 100.0 mas. pts. |
| Air interface alignment controlling agent 1 | 2.0 mas. pts. |
| Photopolymerization initiator | 3.0 mas. pts. |
| (Irgacure 907, by Ciba-Geigy) | |
| Sensitizer (Kayacure DETX, by Nippon Kayaku) | 1.0 mas. pt. |

In the same manner as in Example 2-2 but using the coating liquid of liquid-crystal composition 7 for formation of optically-anisotropic layer in place of the coating liquid of liquid-crystal composition 2 for formation of optically-anisotropic layer, an optical compensation film 26 was produced.

Using the optical compensation film 26 and in the same manner as in Example 2-2, a polarizing plate 26 and an OCB-mode liquid-crystal display device 5 were fabricated, and evaluated for their display performance.

In the same manner as in Example 2-17, the OCB-mode liquid-crystal display device 5 was tested for the brightness change caused by temperature and humidity change.

### Example 2-25

### Preparation of Ring-Opening Polymerization Cyclic Polyolefin Dope

A composition mentioned below was put into a mixing tank and stirred to dissolve the ingredients, and then filtered through a paper filter having a mean pore size of 34 μm and a sintered metal filter having a mean pore size of 10 μm.

Cyclic polyolefin solution A

| | |
|---|---|
| Arton G (by JSR) | 150 mas. pts. |
| Methylene chloride | 550 mas. pts. |
| Ethanol | 50 mas. pts. |

Next, the following composition containing the ring-opening polymerization cyclic polyolefin solution prepared according to the above-mentioned method was put into a disperser to prepare a mat agent dispersion.

Mat agent dispersion

| | |
|---|---|
| Silica particles having a mean particle size | 2 mas. pts. |
| of 16 nm (Aerosil R972 by Nippon Aerosil) | |
| Methylene chloride | 75 mas. pts. |
| Ethanol | 5 mas. pts. |
| Cyclic polyolefin solution A | 10 mas. pts. |

100 parts by mass of the above cyclic polyolefin solution and 1.1 parts by mass of the mat agent dispersion were mixed to prepare a dope for film formation.

### (Preparation of Cyclic Polyolefin Film)

Using a band caster, the above-mentioned dope was cast. The film having a residual solvent content of about 22% by mass was peeled away from the band. Held by tenter clips, this was stretched in a transfer zone, and then dried at 130° C. and wound up. The thickness of the thus-produced cyclic polyolefin film was 30 μm. The film was processed for glow discharge treatment between upper and lower electrodes of brass (argon atmosphere). A high-frequency voltage of 3000 Hz and 4200 V was applied between the upper and lower electrodes for 20 seconds, and a ring-opening polymerization cyclic polyolefin film was thus fabricated.

In the same manner as in Example 2-1 but using the support (SP-18) produced in Production Example 18 was used, the surface of the support SP-18 was processed for atmospheric plasma treatment, and an alignment film was formed on the processed surface. Then, the cyclic polyolefin film was laminated on the surface of the support not having an alignment film and stuck together via an adhesive SK-1478 (by Soken Chemical).

Thus obtained, the laminate film was analyzed for its optical characteristics, using a KOBRA 21ADH at a wavelength of 550 nm. As a result, its in-plane retardation Re was 47 nm (slow axis in the cross direction) and its thickness-direction retardation Rth was 300 nm. The haze of the film was 0.18%.

In the same manner as in Example 2-2 but using the coating liquid of liquid-crystal composition 5 for formation of optically-anisotropic layer in place of the coating liquid of liquid-crystal composition 2 for formation of optically-anisotropic layer, an optical compensation film 27 was produced. Using this, a polarizing plate 27 and an OCB-mode liquid-crystal display device 6 were fabricated, and evaluated for their display performance.

In the same manner as in Example 2-17, the OCB-mode liquid-crystal display device 6 was tested for the brightness change caused by temperature and humidity change.

Also in the same manner as in Example 2-17, the liquid-crystal display devices of Comparative Examples 2-1 and 2-2 were tested for the brightness change caused by temperature and humidity change.

TABLE 2-3

| | Support | | | | | | | |
|---|---|---|---|---|---|---|---|---|
| | | | 2nd | Re | | | Surface | Optically-Anisotropic |
| | Film | Pellets | Resin | Enhancer | Thickness | Stretching | Treatment | Layer |
| Example | SP-13 | P-1 | AS | Re | 80 μm | no | atmospheric | Optically-anisotropic |
| 2-9 | | | | Enhancer 3 | | | plasma | layer 1 |
| Example | SP-14 | P-1 | AS | Re | 80 μm | no | atmospheric | Optically-anisotropic |
| 2-10 | | | | Enhancer 4 | | | plasma | layer 1 |
| Example | SP-15 | P-1 | AS | Re | 80 μm | no | atmospheric | Optically-anisotropic |
| 2-11 | | | | Enhancer 5 | | | plasma | layer 1 |
| Example | SP-16 | P-1 | AS | Re | 80 μm | no | atmospheric | Optically-anisotropic |
| 2-12 | | | | Enhancer 6 | | | plasma | layer 1 |
| Example | SP-17 | P-1 | AS | Re | 80 μm | no | atmospheric | Optically-anisotropic |
| 2-13 | | | | Enhancer 7 | | | plasma | layer 1 |
| Example | SP-2 | P-1 | AS | no | 50 μm | no | atmospheric | Optically-anisotropic |
| 2-14 | | | | | | | plasma | layer 1 |
| Example | SP-4 | P-1 | AS | Re | 80 μm | no | atmospheric | Optically-anisotropic |
| 2-15 | | | | Enhancer 1 | | | plasma | layer 3 |
| Example | SP-5 | P-1 | AS | Re | 80 μm | 25% | atmospheric | Optically-anisotropic |
| 2-16 | | | | Enhancer 2 | | | plasma | layer 2 |

TABLE 2-4

| | | Optical | | | | |
|---|---|---|---|---|---|---|
| | | compensation | | Liquid-Crystal | | |
| | | film | | Display Device | | |
| | Support | | degree of | | front | horizontal CR |
| | haze | haze | extinction | mode | CR | viewing angle |
| Example | 0.15% | 0.20% | 0.0010 | TN | 900 | 160 |
| 2-9 | | | | | | |
| Example | 0.15% | 0.20% | 0.0010 | TN | 900 | 160 |
| 2-10 | | | | | | |
| Example | 0.15% | 0.20% | 0.0010 | TN | 900 | 160 |
| 2-11 | | | | | | |
| Example | 0.15% | 0.20% | 0.0010 | TN | 900 | 160 |
| 2-12 | | | | | | |
| Example | 0.15% | 0.20% | 0.0010 | TN | 900 | 160 |
| 2-13 | | | | | | |
| Example | 0.15% | 0.20% | 0.0010 | TN | 900 | 130 |
| 2-14 | | | | | | |
| Example | 0.15% | 0.18% | 0.0008 | TN | 930 | 160 |
| 2-15 | | | | | | |
| Example | 0.15% | 0.20% | 0.0010 | OCB | 900 | 160 |
| 2-16 | | | | | | |

TABLE 2-5

| | Support | | | | | | | |
|---|---|---|---|---|---|---|---|---|
| | | | 2nd | Re | | | Surface | Optically-Anisotropic |
| | Film | Pellets | Resin | Enhancer | Thickness | Stretching | Treatment | Layer |
| Example | SP-3 | P-2 | — | no | 60 μm | no | atmospheric | Optically-anisotropic |
| 2-17 | | | | | | | plasma | layer 3 |
| Example | SP-18 | P-2 | — | Re | 60 μm | no | atmospheric | Optically-anisotropic |
| 2-18 | | | | Enhancer 1 | | | plasma | layer 3 |
| Example | SP-18 | P-2 | — | Re | 60 μm | no | atmospheric | Optically-anisotropic |
| 2-19 | | | | Enhancer 1 | | | plasma | layer 4 |
| Example | SP-19 | P-2 | — | Re | 53 μm | 17% | atmospheric | Optically-anisotropic |
| 2-20 | | | | Enhancer 1 | | | plasma | layer 5 |
| Example | SP-19 | P-2 | — | Re | 53 μm | 17% | atmospheric | Optically-anisotropic |
| 2-21 | | | | Enhancer 1 | | | plasma | layer 6 |
| Example | SP-18 | P-2 | — | Re | 60 μm | no | atmospheric | Optically-anisotropic |
| 2-22 | | | | Enhancer 1 | | | plasma | layer 7 |
| Example | SP-20 | P-2 | — | Re | 50 μm | 25% | atmospheric | Optically-anisotropic |
| 2-23 | | | | Enhancer 1 | | | plasma | layer 8 |
| Example | SP-20 | P-2 | — | Re | 50 μm | 25% | atmospheric | Optically-anisotropic |
| 2-24 | | | | Enhancer 1 | | | plasma | layer 9 |
| Example | SP-18 + | P-2 | — | Re | 90 μm | no | atmospheric | Optically-anisotropic |
| 2-25 | cyclic | | | Enhancer 1 | | | plasma | layer 6 |
| | olefin | | | | | | | |

TABLE 2-6

| | | Optical | | | | | | |
|---|---|---|---|---|---|---|---|---|
| | | compensation | | Liquid-Crystal | | | | |
| | | film | | Display Device | | | | |
| | Support | | degree of | | | horizontal CR | temperature | humidity |
| | haze | haze | extinction | mode | front CR | viewing angle | change | change |
| Example | 0.16% | 0.19% | 0.0009 | TN | 1020 | 130 | 0.2 | 0.2 |
| 2-17 | | | | | | | | |
| Example | 0.16% | 0.19% | 0.0009 | TN | 1020 | 160 | 0.2 | 0.2 |
| 2-18 | | | | | | | | |
| Example | 0.16% | 0.19% | 0.0009 | TN | 1020 | 155 | 0.3 | 0.2 |
| 2-19 | | | | | | | | |
| Example | 0.17% | 0.21% | 0.0011 | TN | 1050 | 165 | 0.3 | 0.2 |
| 2-20 | | | | | | | | |
| Example | 0.17% | 0.19% | 0.0009 | TN | 1100 | 170 | 0.2 | 0.2 |
| 2-21 | | | | | | | | |
| Example | 0.16% | 0.20% | 0.0010 | TN | 1000 | 155 | 0.4 | 0.2 |
| 2-22 | | | | | | | | |
| Example | 0.17% | 0.20% | 0.0011 | OCB | 920 | 160 | 0.2 | 0.2 |
| 2-23 | | | | | | | | |
| Example | 0.17% | 0.20% | 0.0011 | OCB | 900 | 155 | 0.3 | 0.2 |
| 2-24 | | | | | | | | |
| Example | 0.18% | 0.20% | 0.0011 | OCB | 900 | 150 | 0.2 | 0.2 |
| 2-25 | | | | | | | | |
| Comparative | 0.20% | 0.30% | 0.0015 | TN | 860 | 110 | 2.7 | 1.5 |
| Example 1 | | | | | | | | |
| Comparative | 0.70% | 0.80% | 0.0030 | OCB | 800 | 140 | 2.5 | 2.5 |
| Example 2 | | | | | | | | |

### INDUSTRIAL APPLICABILITY

According to the first invention, it is possible to provide a novel optical film that can contribute to optical compensation for liquid-crystal display devices. In particular, it is possible to provide a novel optical film that can contribute to reducing the coloration in oblique directions of liquid-crystal display devices and of which the optical compensatory capability does not fluctuate or fluctuates little, depending on the environmental humidity.

According to the first invention, it is also possible to provide a liquid-crystal display device which has been so improved that its coloration in oblique directions is reduced and its display characteristics do not fluctuate or fluctuate little, depending on the environmental humidity.

According to the second invention, it is possible to provide an optical compensation film that has a small degree of extinction and can contribute to improving contrast, and a polarizing plate comprising it.

According to the second invention, it is also possible to provide a liquid-crystal display device improved in the contrast in the front direction and in oblique directions.

What is claimed is:

1. An optical film comprising a transparent support and an optically-anisotropic layer formed of a composition comprising at least one liquid-crystal compound, wherein the transparent support comprises at least one selected from cycloolefin-base homopolymers and copolymers, and the optically-anisotropic layer satisfies the following relation (1):
Re(450)/Re(650)<1.25 (1)
wherein Re(λ) is in-plane retardation (unit: nm) of the layer at a wavelength λ (nm).

2. The optical film of claim 1, wherein said at least one liquid-crystal compound is a rod-like liquid-crystal compound, and in the optically-anisotropic layer, the molecules of the rod-like liquid-crystal compound are fixed in a hybrid alignment state, and the mean refractive index of the optically-anisotropic layer satisfies the following relation (2):
nx≧nz>ny (2)
wherein nx and ny each are in-plane refractive indexes of the layer, and nz is a refractive index in the thickness direction of the layer.

3. The optical film of claim 1, wherein said at least one liquid-crystal compound is a discotic liquid-crystal compound.

4. The optical film of claim 1, wherein the transparent support satisfies the following relation (3) or (4):
0.5<Rth(550)/Re(550)<1.5 (3)
4<Rth(550)/Re(550)<12 (4)
wherein Rth(λ) is thickness-direction retardation (unit: nm) of the layer at a wavelength λ (nm).

5. A polarizing plate comprising at least one optical film as set forth in claim 1 and a polarizing film.

6. A liquid-crystal display device comprising a liquid-crystal cell, a polarizing film, and an optical film as set forth in claim 1.

7. The liquid-crystal display device of claim 6, wherein the liquid-crystal cell employs a TN-mode.

8. The liquid-crystal display device of claim 6, wherein the liquid-crystal cell employs an ECB-mode.

9. An optical compensation film comprising a transparent support, and an optically-anisotropic layer formed of a composition comprising at least one liquid-crystal compound, wherein the transparent support comprises a polymer having at least either of lactone ring unit or glutaric anhydride unit.

10. The optical compensation film of claim 9, wherein the polymer has at least one unit of the following formula (1): 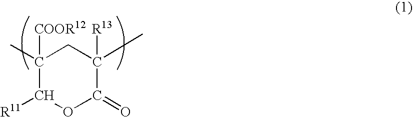
wherein R¹¹, R¹² and R¹³ each independently represent a hydrogen atom, or an organic residue having from 1 to 20 carbon atoms, and the organic residue may contain an oxygen atom.

11. The optical compensation film of claim 9, wherein the polymer has at least one unit of the following formula (3): 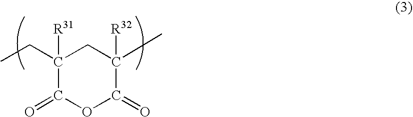
wherein R³¹ and R³² each independently represent a hydrogen atom or an organic residue having from 1 to 20 carbon atoms, and the organic residue may contain an oxygen atom.

12. The optical compensation film of claim 9, wherein the transparent support further comprises a copolymer having a vinyl cyanide monomer unit and an aromatic vinyl monomer unit.

13. The optical compensation film of claim 9, wherein the transparent support further comprises a retardation enhancer having at least two aromatic rings in one molecule.

14. The optical compensation film of claim 9, which has an alignment film disposed between the transparent support and the optically-anisotropic layer.

15. A polarizing plate comprising a polarizing element and an optical compensation film as set forth in claim 9.

16. A liquid-crystal display device comprising at least one polarizing plate as set forth in claim 15.
